(19) United States
(12) Patent Application Publication
(10) Pub. No.: US 2005/0108216 A1
(43) Pub. Date: May 19, 2005

(54) Computer assisted and /or implemented process and system for conducting searches in healthcare provider medical information portals

(75) Inventors: Susan Schramm-Apple, Hatfield, PA (US); Sean Dippold, Schwenksville, PA (US); Melanie Kittrell, Maple Glen, PA (US); Keith Bauer, Souderton, PA (US); Lori Moore, Lafayette Hill, PA (US)

Correspondence Address: WILMER CUTLER PICKERING HALE AND DORR LLP, 399 PARK AVENUE, NEW YORK, NY, 10022, US

(73) Assignee: Merck & Co., Inc., Rahway, NJ (US)

(21) Appl. No.: 10/923,008

(22) Filed: Aug. 23, 2004

Related U.S. Application Data
(63) Continuation-in-part of application No. 10/390,166, filed on Mar. 18, 2003.
(60) Provisional application No. 60/510,860, filed on Oct. 15, 2003.
(60) Provisional application No. 60/364,743, filed on Mar. 18, 2002.

(51) Int. Cl. G06F 17/30

(52) U.S. Cl. 707/3

(57) ABSTRACT

A method, system, and computer program device implements a search in, for example, a healthcare provider medical information portal. For example, instead of having to type or key a search item into an interface, the search may be conducted, automatically, for data records relevant to the item by executing a search query event. More particularly, the search query event identifies the item, which may be displayed in a user interface, to be searched. In addition to identifying the item, the search query event also initiates the search. In one example, the search query event includes positioning a cursor over a phrase, term or other item displayed on a webpage and clicking a mouse button. The present invention requires fewer interactions to execute a search. The search technique may be implemented with any type of portal.

### RELATED APPLICATIONS

This application is a continuation in part of U.S. patent application Ser. No. 10/390,166, filed Mar. 18, 2003, “Computer Assisted and/or Implemented Process and System for Managing and/or Providing a Medical Information Portal for Healthcare Providers,” which, in turn, claims priority to U.S. Patent Application No. 60/364,743, “Computer Implemented and/or Assisted Process and System for MerckMedicus” filed Mar. 18, 2002, both of which are assigned to the assignee of this application and are incorporated herein by reference.

In addition, this application is related to the following U.S. patent application Ser. No. 10/390,159, filed Mar. 18, 2003; Ser. No. 10/390,168, filed Mar. 18, 2003; Ser. No. 10/390,162, filed Mar. 18, 2003; Ser. No. 10/390,165, filed Mar. 18, 2003; and Ser. No. 10/390,539, filed Mar. 18, 2003, and all of which are assigned to the assignee of this application and are incorporated herein by reference.

### BACKGROUND OF THE INVENTION

1. Field of the Invention

The present invention is directed to computer related and/or assisted systems, methods, and computer program devices for conducting searches to allow unified access to professional resources in the medical field. More particularly, the present invention relates to methods and systems for conducting searches using a search query event, which reduces the number of interactions needed in order to conduct a search. The present invention thus facilitates access to professional healthcare resources for healthcare professional users, e.g., physicians and other healthcare providers.

2. Description of the Related Art

In the healthcare field, healthcare professionals conventionally may obtain information from medical publishers, with most of this information being just in print. On the other hand, academic institutions have considerable libraries, which unfortunately are not universally available to physicians. Hence, paper resources with healthcare information may be considerable but difficult to access.

In an attempt to provide information electronically, early websites with limited information were sponsored by a variety of commercial entities, academic institutions, or medical associations. There was, nevertheless, a lack of awareness among physicians of the web as a resource for providing information and/or other resources needed by physicians. Premium resources might be provided on some of these sites, nevertheless, there was limited exposure and/or access to these premium resources for physicians and other healthcare professionals.

These conventional means of providing information and other healthcare professional resources resulted in an uneven playing field for healthcare providers. In addition, there are a number of other hurdles facing office-based, rural and non-institutional healthcare professionals.

Physicians and other healthcare providers are presently adapted to the current situation. They are unlikely to change their current habits. Although there is a much greater degree of information available, unfortunately it will not find its way into the hands of physicians and healthcare providers, and ultimately will not result in improved healthcare. Nevertheless, the ability to save time and/or money is one of the primary motivators for physicians or healthcare professionals to change their habits.

Conventionally, the information and/or information gathering process is difficult and awkward for healthcare providers. The information might not be provided in one convenient place. Moreover, the information itself might be inconvenient. For example, if the information is provided by subscription, it is typically expensive to obtain multiple subscriptions. On the other hand information in textbooks might not be up-to-date. Further, textbooks, journals and libraries are not at all suited to physicians' nomadic working style, which typically includes travel between an office and a hospital. Information which might be provided over the web may be jumbled or confused, with multiple places, passwords, formats, browsers and search engines provided for a variety of information. Ultimately, physicians and other providers have entirely too many subscriptions, accounts, ID's and passwords, making the information awkward.

With regard to utilizing the Internet, the physicians might suspect the quality of information or services provided online. Moreover, such information and services might be biased, for example as a result of a sponsor of a particular product, unbeknownst to the users. Where information in sites is searchable, the search engines that are provided might not retrieve search results that are most relevant to the physicians' query.

In some situations, the access to information or services might be tied to a specific license or specialized access technology. For example, in order to obtain certain information or services, the physician might be required to use a specific computer or install certain technology.

In addition, sites that are provided by pharmaceutical companies do not tend to focus on physicians. These sites are product driven and patient oriented. They fail to provide for the needs of the physician as a customer. In short, it is difficult to obtain information or services via conventional methods.

One specific example of a website directed to physicians is Medscape/WebMD. Unbeknownst to physicians, however, Medscape/WebMD is commercially sponsored and exhibits a bias. As another example, this site gives physicians limited access to premium resources, such as the best journals and text, because there is no financial incentive to make this information available. Moreover, typical of these types of sites, Medscape/WebMD does not have access to the premium resources sufficient to place them online.

Meanwhile, physicians are facing an increasing number of pressures. These pressures on healthcare practitioners include an increase in time pressures, perhaps caused by busy practices and overwhelming paperwork. At the same time, healthcare practitioners face decreasing practice revenues. They also face information overload, with a decreasing amount of time to sort through the relevant information.

The inventors have determined that physicians or other healthcare professionals engage in a number of online activities, including literature searches, reading medical news in the professional press, reading professional journals, finding patient educational materials, using drug reference databases, researching upcoming meetings, engaging in online continuing medical education (CE), reading medical news in the lay press, communicating with colleagues, finding out about clinical trials, learning about medical devices, reading medical text, and/or participating in MD chat rooms. It is estimated by the inventors that online CE is engaged in by 58% and 51% of primary care providers and physician specialists, respectively.

The inventors have determined that physicians refer to medical information sites primarily to find news and reference materials. In one study by the inventors in responding to a question about the three most important factors a physician uses in determining which medical information sites to use, the following responses were provided:

| Description | Percent |
|---|---|
| Medline Literature Search | 64% |
| Medical News Updates and Alerts | 53% |
| Medical Journals | 47% |
| Drug Reference Database | 34% |
| Medical Textbooks | 30% |
| Continuing Education Online | 29% |
| Courses | |
| Patient Relationship Information | 20% |
| and Guides | |
| Clinical Trial Information and | 15% |
| Links | |
| Listing of Medical Organizations | 7% |
| and Meetings | |
| Financial and World News | 5% |
| Community and Messages Boards | 4% |

The inventors performed extensive research with physicians about website features and functionality, including advisory boards, one-on-ones and online user ability testing. The above table highlights the findings of the online usability test of 154 physician respondents.

According to the Online Physician Market Dynamics Study (ZIMENT), February/March 2001, (Q9), quality, credibility and ease of use are the most important features to physicians in an online service. The following are attributes that are important to specialists and primary care physicians:
Provides credible information
Provides quality information
Is easy to use*
Provides up-to-date health and medical information*
Enables effective research of usual cases or conditions
Is comprehensive
Offers premium medical resources not easily accessible elsewhere
Helps physicians communicate better with patients
Is available to doctors only and not general consumers
Offers ability to customize site based on preferences or specialty
Has a professional look and feel
Is unique from other sites
   (* These attributes are less important to specialists than primary care physicians.)

Certain aspects of conventional systems for providing healthcare information are illustrated by way of example in FIG. 1, also described in U.S. Pat. No. 6,482,156, Iliff, incorporated herein by reference. Iliff concerns a computerized medical diagnostic and treatment advice system including network access. FIG. 1 is a block diagram illustrating a conceptual view of the database files and processes according to Iliff. A patient login process 150 is used to identify previously registered patients. An assistant login process 172 is used to identify previously registered assistants. An assisted patient login process 176 is used to identify previously registered patients. A patient registration process 152 is used to register new or first-time patients, and an assistant registration process 174 is used to register new or first-time assistants. If the patient is not already registered, an assisted patient registration process 178 is used to register the patient. Once logged in or registered, the system provides an evaluation process 154 that performs a patient diagnosis, and/or a treatment table process 156 to obtain current treatment information for a disease or diagnosis. Associated with these processes are a patient and assistant enrollment database 160, a consultation history database 162, a patient response database 164, a medical history objects database 166, a patient medical history database 168, a pending database 169, and a patient medication database 170.

Other aspects of conventional systems are illustrated by way of example in FIG. 2, also described in U.S. Pat. No. 6,505,196, Drucker et al., incorporated herein by reference. Drucker discloses a method and apparatus for improving access to literature. FIG. 2 illustrates an example interface for querying the MEDLINE database. There are a row of action buttons 200-204, each action button performing a different function. Below the action buttons 200-204 is a section 210 for entering query terms, with three text boxes 211-213. Whatever is entered into the text boxes 211-213 may be used for searching using three methods. The method is selected using pull-down boxes 214-216. Box 214, for example, contains the options subject, author name, or title word. Once a query is entered, the search may be performed. Once a query is submitted all the records that match the parameters are retrieved. If the search results are excessive, section 220 may be utilized to limit the search, and contains a number of limit boxes 221-228 each allowing the user to place limits on the search. For example, limits are provided for begin date/end date, articles written in a particular language, articles containing human/animal result data, age group, gender, number of articles, journals, publication types, and/or type of articles.

Unfortunately, conventional systems including those referred to above failed to meet these needs of physicians. Moreover, none of these conventional systems specifically provide an online unified method for a professional, e.g., a physician, healthcare practitioner, or medical student, to access healthcare resources, e.g., information and/or services. Moreover, using conventional systems, it is not possible to rapidly search for and/or locate content which is relevant to the healthcare professional's practice, for example, diagnosing illnesses, learning and advancing professional development both formally and informally, accessing resources appropriate for patients, obtaining information on healthcare technology, reviewing medical news, and/or accessing an electronic library of basic medical resources. There remains a need for such assistance for physicians and other healthcare practitioners.

The above prior art references, however, fail to meet the needs of today's medical community. For example, we have determined that physicians and healthcare professionals would prefer a website with cutting edge tools and resources, available in a single portal, as a key to the medical Internet. We have determined that physicians and other healthcare providers would prefer that such a site is ethical, credible, insightful, unbranded and objective. We have further determined that such a site should be for physicians and healthcare professionals, and provide access to premium medical resources.

In addition, we have determined that the conventional methods for accessing information from these websites are time consuming and difficult to use. For example, to initiate a standard search using conventional methods, a healthcare professional typically types a key word (or words) into a search interface. In addition, the healthcare professional may be required to select a particular database or resource linked to the portal. Finally, if the healthcare professional desires searching a related subject uncovered in the initial search, he or she is generally required to repeat the entire process. When taken individually, these steps are not unduly time consuming. When taken together however, the above steps oftentimes require a significant amount of time to locate a relevant data resource. Thus, we have discovered that simplified techniques for searching websites and/or distributed portal networks, including those that reduce the number of interactions required to conduct a search, are needed. We have determined that physicians and other healthcare providers would prefer a search technique that is easy and quick to use for accessing unified medical resource portals.

### BRIEF SUMMARY OF THE INVENTION

The present invention alleviates the deficiencies of conventional techniques and systems described above. The invention enables information provision to physicians and other healthcare providers that is more targeted, more efficient and may be permission-based. The invention provides assistance to help physicians to obtain timely and appropriate information to help them practice better medicine. The system, according to one or more aspects of the invention, provides the right information in an appropriate format. It also provides for appropriate filtering of information. Another enduring value which the invention provides to physicians is an aggregation of resources in one place. The present invention provides a fairly easy way of distributing information targeted to certain physicians, and allowing those physicians to expose themselves more readily to new information. The present invention fosters the best practice of medicine, which creates simultaneous benefits for physicians, and patients.

In at least one embodiment, the present invention brings together a vast collection of resources available to physicians. The invention provides a content library unmatched in its breadth. It optionally provides a search engine appropriate for perusing, e.g., Harrison's Online, Cecil's Textbook of Medicine, Praxis.md, the Merck Manual and many others. In addition, it provides one or more links to searches such as MD Consult that offer their own extremely comprehensive library. All told, these many resources cover primary care and just about every specialty imaginable. Users may utilize a global view or personalize their experience by choosing a specialty view, each of which may be a portal in itself. An optional folder feature allows physicians to document their visits with extensive bookmarking to track their progress (e.g., previously conducted searches, research links). The invention includes a comprehensive professional development area with board review questions, a medical meeting calendar with unique content from many meetings and the ability to earn CME credit through a partner site. The patient resource area exceeds that of most physician web portals, and optionally includes access to an immense collection of patient handouts that physicians may easily print. Other resources may include coverage of what patients are seeing in the media, color illustrations and easy-to-read descriptions for numerous medical procedures, and resources to help locate clinical trials for patients. Clinical workflow tools optionally include clinical calculators, an ICD-9 search engine, drug interaction checking, and/or expert systems that assist with antibiotic choices (TheraDoc™) and difficult differential diagnoses (Dxplain™). Optionally, an electronic assistant provides quick links to relevant news and journals, career information and clinical decision support tools that may optionally be downloaded to a physician's handheld computer. A number of unique and powerful features may be provided, such as free access to subscription sites (e.g., Harrison's Online, Praxis.md, MD Consult). Another optional resource is a lectures and presentations builder, allowing users to prepare custom slides for incorporation into, e.g., PowerPoint documents, and including, e.g., public speaking advice.

Accordingly, one or more embodiments of the invention provides a system and/or method to permit rapidly searching for and/or locating content or services, such as in a unified user interface. Further, the present invention provides that the resources, e.g., content, information, and/or services, are correlated to the relevant segments of a healthcare professional's practice, for example, diagnosing illnesses, learning and advancing professional development both formally and informally, accessing resources appropriate for patients, obtaining information on healthcare technology, reviewing medical news, and/or accessing an electronic library of basic medical resources. Such a system and/or method facilitates a physician's nomadic working style and provides ready access to resources. Moreover, according to one or more embodiments of the present invention, access to certain premium resources is restricted, such as to users with professional licensure, medical students, and/or licensed physicians.

According to one or more embodiments of the present invention, there is provided a single online destination to provide a “front door” into online services for a physician or healthcare practitioner, to enhance customer convenience, improve efficiency of information delivery, and enhance data gathering and targeting. Further, one or more embodiments of the present invention provide a user with customizable, personalized healthcare information and state-of-the-art set of tools and resources, to help physicians or other healthcare providers efficiently practice medicine, integrate technology, and stay current. Content may include professional references, medical news, physician education, search engines, practice management information, and/or links to other resources. Resources may include disease education resources, professional development resources, practice management and technology, and patient resources. Other tools may be offered.

Accordingly, the present invention provides a method, system and computer program device for conducting a search in, for example, a healthcare provide medical information portal and the like. According to one or more embodiments of the present invention, the searching technique includes displaying in an interface a page comprising contents which may include one or more searchable items. The technique also includes monitoring for a search query event which identifies at least one of the searchable items from the page and initiates the search for that item(s). The technique also includes searching, in response to the search query event, a collection of data records for data records relevant to the search query. Finally, the technique includes displaying a link to each of the data records that are relevant to the search query.

Optionally, one or more embodiments of the present invention include using the activation of a button as the search query event.

Optionally, one or more embodiments of the present invention include using double-clicking a mouse button as the search query event.

Optionally, one or more embodiments of the present invention include positioning a cursor over the term or phrase and double-clicking a mouse button as the search query event.

Other optional embodiments of the present invention also provide a computer-based system, method, and computer program device for conducting a search. These embodiments include an interface for displaying a page comprising contents which may include one or more searchable items. They also include an input unit for monitoring for a search query event which identifies at least one item from the page and initiates the search for the at least one item. Further, these embodiments include a searching module for searching, in response to the search query event, a collection of data records for data records relevant to the search query. Once identified, the interface may be used to display a link to each of the data records that are relevant to the search query.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way. These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE SEVERAL VIEWS OF THE DRAWING(S)

The above-mentioned and other advantages and features of the present invention will be better understood from the following detailed description of the invention with reference to the accompanying drawings, in which:

FIG. 1 is a software conceptual diagram of a prior art diagnostic treatment and advice system.

FIG. 2 illustrates an example user search interface for a prior art medical publication search system.

FIG. 3 is a functional block diagram illustrating an example of a medical information portal for providing healthcare resources to users, according to one or more embodiments of the present invention.

FIG. 4 is a functional block diagram illustrating an example of diagnostic tools for one or more embodiments of the medical information portal of the present invention.

FIG. 5 is a functional block diagram illustrating an example of learning tools for one or more embodiments of the medical information portal of the present invention.

FIG. 6 is a functional block diagram illustrating an example of patient tools for one or more embodiments of the medical information portal of the present invention.

FIG. 7 is a functional block diagram illustrating an example of healthcare technology tools for one or more embodiments of the medical information portal of the present invention.

FIG. 8 is a functional block diagram illustrating an example of medical news tools for one or more embodiments of the medical information portal of the present invention.

FIG. 9 is a functional block diagram of the electronic assistants for one or more embodiments of the medical information portal of the present invention.

FIG. 10 is a functional block diagram of the tool bar for one or more embodiments of the medical information portal of the present invention.

FIG. 11 is an exemplary user interface illustrating a home page, including optional medical news tools, for one or more embodiments of the medical information portal of the present invention.

FIG. 12 is an exemplary user interface for current medical periodical literature, for one or more embodiments of the medical news tools.

FIG. 13 is an exemplary user interface for breaking news, for one or more embodiments of the medical news tools.

FIG. 14 is an exemplary user interface for medical news, for one or more embodiments of the medical news tools.

FIG. 15 is an exemplary user interface for specialized news, for one or more embodiments of the medical news tools.

FIG. 16 is an exemplary user interface for consumer news, for one or more embodiments of the medical news tools.

FIG. 17 is an exemplary user interface for diagnostic tools, for one or more embodiments of the medical information portal of the present invention.

FIG. 18 is an exemplary user interface for a medical reference for user in connection with the diagnostic tools of FIG. 17.

FIG. 19 is an exemplary user interface for a disease diagnosis service, for use in connection with the diagnostic tools of FIG. 17.

FIG. 20 is another page of the exemplary user interface for the disease diagnosis service of FIG. 19.

FIG. 21 is a further page of the exemplary user interface for the disease diagnosis service of FIG. 19.

FIG. 22 is an exemplary user interface for a clinical practice guidelines clearinghouse, for use in connection with the diagnostic tools of FIG. 17.

FIG. 23 is an exemplary user interface for another medical reference, for use in connection with the diagnostic tools of FIG. 17.

FIG. 24 is an exemplary user interface for a medical textbook, for use in connection with the diagnostic tools of FIG. 17.

FIG. 25 is an exemplary user interface for a disease module, for use in connection with the diagnostic tools of FIG. 17.

FIG. 26 is an exemplary user interface for a set of medical references, for use in connection with the diagnostic tools of FIG. 17.

FIG. 27 is an exemplary user interface for a library of medical websites, for use in connection with the medical references of FIG. 26.

FIG. 28 is an exemplary user interface for a medical database, for use in connection with the medical references of FIG. 26.

FIG. 29 is an exemplary user interface for learning tools, for one or more embodiments of the medical information portal of the present invention.

FIG. 30 is an exemplary user interface for a user profile, for use in connection with the learning tools of FIG. 29.

FIG. 31 is an exemplary user interface for lecture materials and presentations, for use in connection with the learning tools of FIG. 29.

FIG. 32 is an exemplary user interface for a standard reference of internal medicine slides and diagrams, for use in connection with the lecture materials and presentations of FIG. 31.

FIG. 33 is an exemplary user interface for a slide image bank, for use in connection with the lecture materials and presentations of FIG. 31.

FIG. 34 is an exemplary user interface for patient tools, for one or more embodiments of the medical information portal of the present invention.

FIG. 35 is an exemplary user interface for information on what patients are seeing in the media, for use in connection with the patient tools of FIG. 34.

FIG. 36 is an exemplary user interface for another example of information on what patients are seeing in the media, for use in connection with the patient tools of FIG. 34.

FIG. 37 is an exemplary user interface for patient handouts, for use in connection with the patient tools of FIG. 34.

FIG. 38 is an exemplary user interface for clinical trial information, for use in connection with the patient tools of FIG. 34.

FIG. 39 is an exemplary user interface for healthcare technology tools, for use in one or more embodiments of the medical information portal of the present invention.

FIG. 40 is an exemplary user interface for a healthcare technology query service, for use in connection with the technology tools of FIG. 39.

FIG. 41 is an exemplary user interface for a healthcare technology assessment service, for use in connection with the technology tools of FIG. 39.

FIG. 42 is an exemplary user interface for electronic assistant tools, for use in connection with one or more embodiments of the medical information portal of the present invention.

FIG. 43 is an exemplary user interface for access to online shopping for medical technology, for use in connection with the electronic assistant tools of FIG. 42.

FIG. 44 is an exemplary user interface for access to an online and/or PDA-enabled resource, for use in connection with the electronic assistant tools of FIG. 42.

FIG. 45 is an exemplary user interface for illustrative search results for a predetermined site search for use in connection with, e.g., a toolbar, of one or more embodiments of the present invention.

FIG. 46 is an exemplary user interface for illustrative search results for a user-defined search for use in connection with, e.g., a toolbar, of one or more embodiments of the present invention.

FIG. 47 is an exemplary user interface for clinical tools, for use in connection with, e.g., the toolbar of one or more embodiments of the medical information portal of the present invention.

FIG. 48 is an exemplary user interface for a decision support software clinical tool, for use in connection with the clinical tools of FIG. 47.

FIG. 49 is an exemplary user interface for an electronic consult service, for use in connection with the clinical tools of FIG. 47.

FIG. 50 is an exemplary user interface for use in connection with collection user registration and/or personal preference information, for use in connection with one or more embodiments of the medical information portal according to the present invention.

FIG. 51 is an exemplary user interface for use in connection with completing the user registration of FIG. 50.

FIG. 52 is an exemplary user interface for use in connection with unregistered users., according to one or more embodiments of the medical information portal of the present invention.

FIG. 53 is an exemplary block diagram of a network architecture for use in connection with one or more embodiments of the medical information portal of the present invention.

FIG. 54 is a flow chart illustrating an example flow of control generally for tool access, according to one or more embodiments of the medical information portal of the present invention.

FIG. 55 is a flow chart illustrating an example flow of control generally for tools display, according to one or more embodiments of the medical information portal of the present invention.

FIG. 56 is a flow chart illustrating an example flow of control for user registration, according to one or more embodiments of the medical information portal of the present invention.

FIG. 57 is a flow chart illustrating an example flow cascade for validating a registered user, according to one or more embodiments of the medical information portal of the present invention.

FIG. 58 is a flow chart illustrating an example flow cascade for a user attempting to access a restricted resource, according to one or more embodiments of the medical information portal of the present invention.

FIG. 59 depicts one example of a process utilizable for implementing a search technique, according to one or more embodiments of the medical information portal of the present invention.

FIG. 60 depicts one example of a process utilizable for displaying or linking to a search result, according to one or more embodiments of the medical information portal of the present invention.

FIG. 61 is an exemplary user interface for use in implementing the search process of FIG. 59, according to one or more embodiments of the medical information portal of the present invention.

FIG. 62 is an exemplary user interface for use in displaying the search results of the search process of FIG. 59, according to one or more embodiments of the medical information portal of the present invention.

FIG. 63 is a block diagram of a computer used for implementing one or more embodiments of the medical information portal system, in accordance with a computer implemented embodiment of the present invention.

FIG. 64 illustrates a block diagram of the internal hardware of the computer of FIG. 63.

FIG. 65 illustrates a block diagram of an alternative computer of a type suitable for carrying out the present invention.

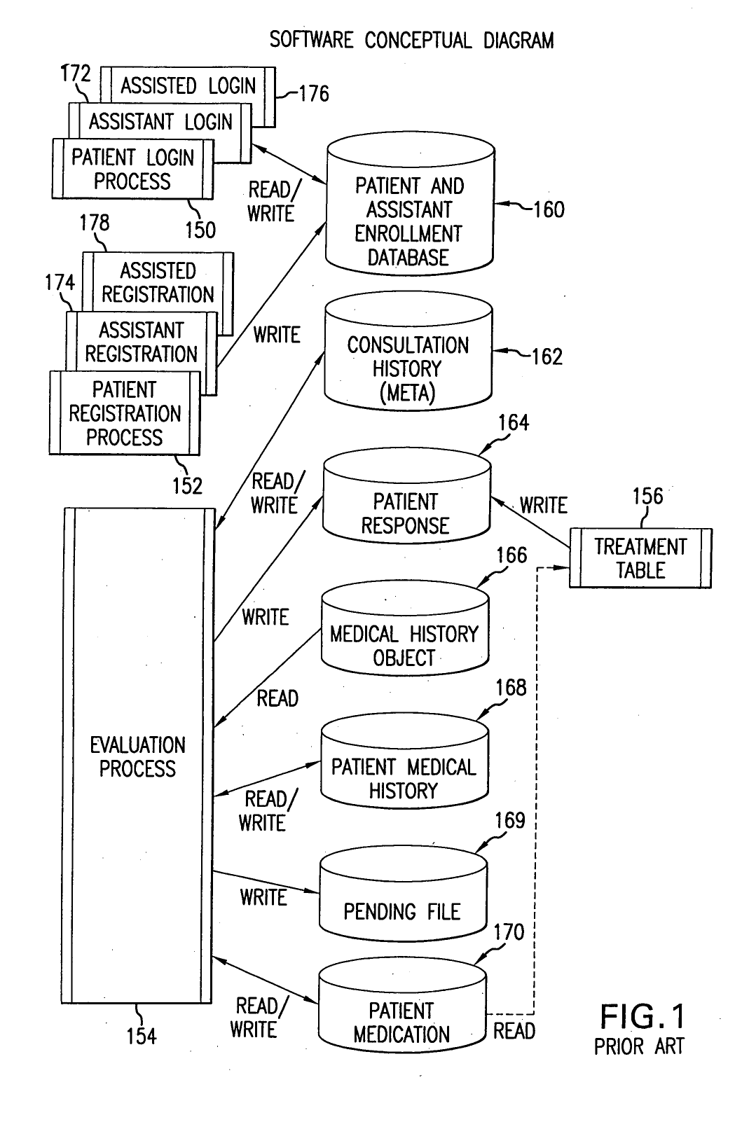

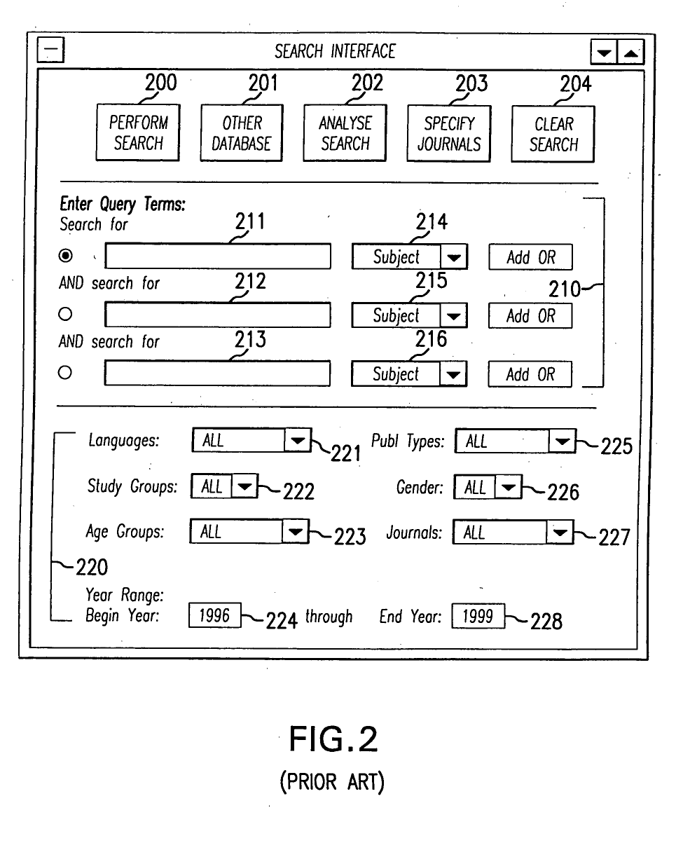

### DETAILED DESCRIPTION OF THE INVENTION

The following detailed description includes many specific details. The inclusion of such details is for the purpose of illustration only and should not be understood to limit the invention. Throughout this discussion, similar elements are referred to by similar numbers in the various figures for ease of reference. In addition, features in one embodiment may be combined with features in other embodiments of the invention.

The present invention provides for an online destination site from which a library of healthcare resources may be accessed in a manner that is interactive and convenient specifically for healthcare professionals. The content provided on the site in accordance with the invention is intended to be comprehensive. The site in accordance with one or more embodiments of the invention is intended to be robust, easier to use, and better aligned with the needs of physicians, other healthcare professionals, and professionals in training. The invention is intended to provide access to a broad and deep array of high quality and credible information tools and resources to assist with the practice of medicine. The site in accordance with one or more embodiments of the invention is intuitively organized, and may be free from visual clutter. Content accessed in connection with use of the invention may be made available from the site provider and/or from third party sources. Optionally, access to certain tools and/or customization features may be provided subsequent to appropriate user registration, and/or access to certain tools may be restricted.

The present invention may provide a system and method for bringing together the vast array of resources available to physicians. Hence, according to one or more embodiments, the invention provides a content library unmatched in its breadth. It optionally provides a search engine appropriate for perusing content, such as, Harrison's Online, Cecil's Textbook of Medicine, Praxis.md, the Merck Manual and many others. In addition, it provides one or more links to searches such as MD Consult that offer their own extremely comprehensive library. All told, these many resources made accessible via one or more embodiments of the invention may cover primary care and/or any specialty. Optionally, users may utilize a global view or personalize their experience by choosing a specialty view, each of which may appear to be a medical portal in itself. An optional folder feature may allow physicians to, for example, document their visits with extensive bookmarking to track their progress (e.g., previously conducted searches, research links). The invention optionally may include a comprehensive professional development area, e.g., with board review questions; an optional medical meeting calendar with access to content from many meetings; and optionally the ability to earn/access CME credit through a partner site. The optional patient resource area may exceed that of most physician web portals, and optionally may include access to an immense collection of patient handouts that physicians may easily print.

Other resources may include coverage of what patients are seeing in the media, color illustrations and easy-to-read descriptions for numerous medical procedures, and resources to help locate clinical trials for patients. Clinical workflow tools optionally may include clinical calculators, an ICD-9 search engine, drug interaction checking, and one or more expert systems that assist with antibiotic choices (TheraDoc™) and difficult differential diagnoses (Dxplain™). Optionally, an electronic assistant provides quick links to relevant news and journals, career information and clinical decision support tools that may optionally be downloaded to a physician's handheld computer or PDA. A number of unique and powerful features may be provided, such as free access to subscription sites (e.g., Harrison's Online, Praxis.md, MD Consult). Another option is a lectures and presentations builder, allowing users to prepare custom slides for incorporation into, e.g., PowerPoint documents, and including, e.g., public speaking advice.

One or more aspects of the invention provide access to healthcare and medical resources. The term “resources” used herein is intended to encompass, e.g., information, services, content, applications, and anything else available electronically. Accordingly, in one or more embodiments of the present invention, medical information resources include, for example, one or more of reference books and/or databases; several outstanding and/or definitive medical information resources may be accessed electronically, including:
National Library of Medicine databases: MEDLINE, AIDSLINE, Bioethics Line, CANCERLIT,
Harrison's Principles of Medicine,
Dorland's Medical Dictionary,
Physicians' Desk Reference (PDR) and PDR Drug Interaction Database,
Mosby's GenRx, Patient GenRx and Drug Master Plus (drug interaction database),
Merck Manual Online,
Merck Manual Home Edition,
Cecil Textbook of Medicine, and/or
Best Practice of Medicine by PraxisMD

Optionally, the present invention may provide users with the ability to search some of these resources individually or user a search engine to retrieve relevant content from the collection of resources. Simple and/or advanced search capabilities may be provided.

Another medical information resource is MD Consult, a collection of medical information resources serving the clinical content needs of physicians and other healthcare providers. This is an example of a resource normally available to physicians by subscription only, but may be provided to registered users of the present invention.

According to one or more embodiments of the present invention, resources may include news, such as available from headlines, abstracts, full journal articles from medical journals, e.g., JAMA, NEJM, Lancet, Annals of Internal Medicine, and BMJ. Other news resources may be provided from a newswire service of breaking news stories about medicine, e.g., those that could impact a physician's practice. Resources may also include medial, specialty and/or consumer news. Such articles cover the business of healthcare, consumer medical news, and other health-related news items, and may be obtained from professional and/or lay press resources, e.g., Reuters, FaxWatch, and NewsRX. Optionally, the news directed to the user may be restricted to items of interest to the user, such as matching user registration information.

Another example of medical information resources includes professional development resources and tools, e.g., continuing medical education (CME) information, online CME, a medical meeting calendar with a list of at least major professional conferences, information and/or review modules regarding board review for various therapeutic areas for Board certification and re-certification, links to professional societies, links to government web sites, links to medical schools, and/or access to clinical trials information.

Another type of resource relates to patients, e.g., patient education materials such as leaflets, optionally editable/customizable; patient sheets, e.g., printable articles intended for patients to help them better understand their disease and treatment; patient health news, e.g., an archive of health-related news articles in the popular lay press (off line, online, and/or in print); clinical trial information, e.g., a searchable database of clinical trials such as sponsored by NIH and/or industry; links to support groups serving patients, such as in various disease states; and/or a best health guide, having patient education materials and consumer medical news, that may be customizable, printable, and/or e-mailable.

Yet another type of resource relates to practice technology, including for example, health technology news, including news articles and features about technology issues affecting the practice of medicine; evaluations of health technology vendors, e.g., review/comparison of the latest office technology for physician practices, such as billing and scheduling systems and electronic medical records management; interactive technology services, e.g., e-mail questions and answers, as well as FAQs, from a healthcare technology professor; a technology glossary, e.g., a searchable list of technology terms; and/or a practice technology assessment services, to assess a level of technological sophistication in a doctor's practice.

A further type of resource relates to diagnostic assistance, including for example, disease explanations, to help doctors correctly diagnose, based on physician input of clinical information, and providing possible diagnoses, justifications, suggestions for additional clinical information to obtain, and/or list of specific signs/symptoms for a specific disease; practice guidelines providing evidence-based clinical practice guidelines; and/or disease modules, providing overviews of many diseases, e.g., major and/or common disease, including e.g., epidemiology, pathophysiology, diagnosis, and treatment.

Optionally, an electronic folder may be provided for each user, in which the user may organize and store articles, patient materials, and/or links for their convenience and future reference.

Other types of resources include hospital offerings that address the needs of hospital-based audiences (residents, house staff, hospital physicians). Such resources may include, e.g., medical calculators/information, including medical and non-medical information, calculators and content from various sources that are targeted to the needs of residents and medical students; an organizer for medical content and tables on a PDA to assist users while they work with quick, problem-based solutions to medical questions/clinical issues. Resources intended for hospital physicians include, e.g., reference texts, e.g., culled from core site content as most appropriate for hospital physicians, PDA-downloadable content culled from the core site and customizable by the user; a programmable medical calculator for important clinical calculations.

Other resources include, for example, clinical support tools that provide evidence based therapies and treatments, dosage recommendations, based on patient-specific data; an online ICD-9 Code reference for patient education; PDA software; a web-enabled version of well-respected texts, e.g., Brunwald's Atlas of Internal Medicine, including disease images, charts, and tables, which are optionally downloadable for incorporation into, e.g., medical lectures; and a meeting reporter having news, analysis, posters, and lecture summaries from major medical meetings.

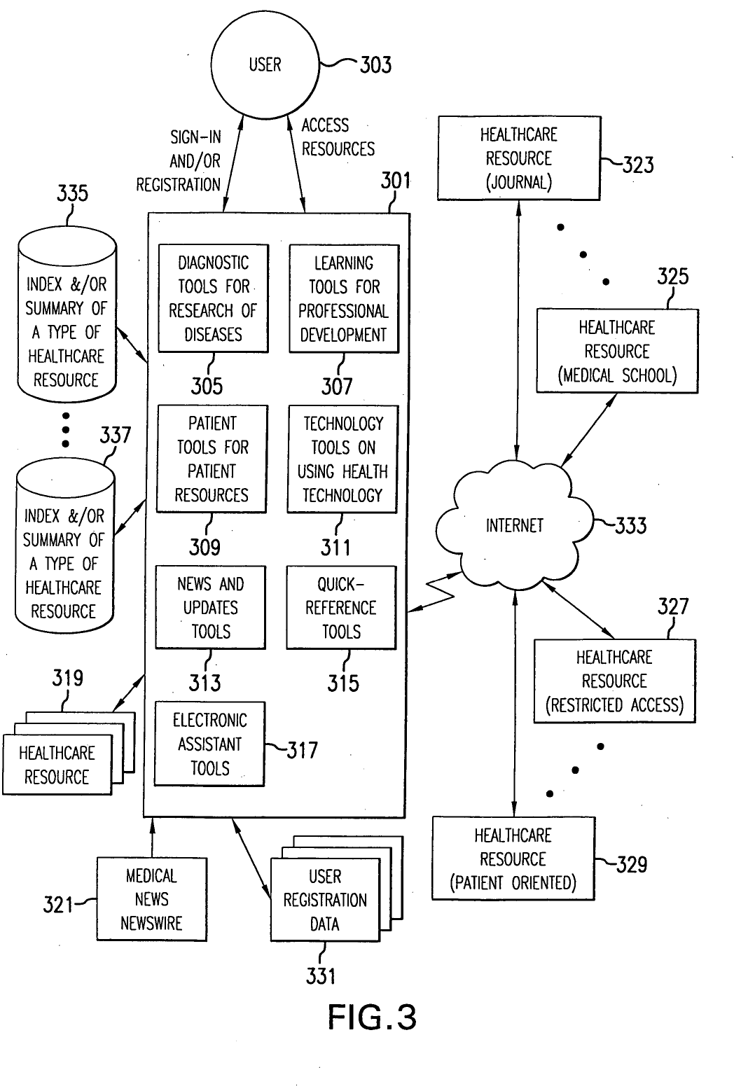

FIG. 3 provides a block diagram of one or more embodiments of the medical information portal, according to the present invention. Preferably, the medical information portal is implemented on a computer system 301, which may be accessed by one or more users 303. The users may communicate, e.g., sign-in, register, and access resources, with the system in any usual manner, such as a portal over the Internet 333.

The system according to the present invention may include one or more of the following sets of tools, in which various resources are organized in a manner which is intuitive for a healthcare professional: diagnostic tools for research of diseases 305, learning tools for professional development 307, patient tools for patient resources 309, technology tools on using health technology 311, news and updates tools 313, quick-reference tools 315, and/or electronic assistant tools 317. One or more resources may be included in more than one set of tools, if appropriate, e.g., a glossary of medical terms. Various indexes, summaries, abstracts, etc., 335, 337 may be provided for resources or collections of resources, e.g., journal articles.

According to one or more aspects of the present invention, local healthcare resources 319 may be included and accessed directly by the system, e.g., a proprietary text. According to an aspect of the present invention, healthcare resources 323, 325, 327, 329 may be accessed via the Internet 333. Resources may include, e.g., a journal 323, a medical school 325, a restricted access resource 327 for which a user must be certain criteria to obtain access, and/or patient-oriented resources 329. Optionally, the system includes user registration data 331 for each user, indicating, e.g., user name and contact info and licensure information. The system may receive news also via one or more medical newswire services 321. The system advantageously provides, utilizing the sets of tools, a unified and organized access to a wide variety of a large number of resources that would otherwise be too confusing and/or unwieldy to access, especially in its entirety.

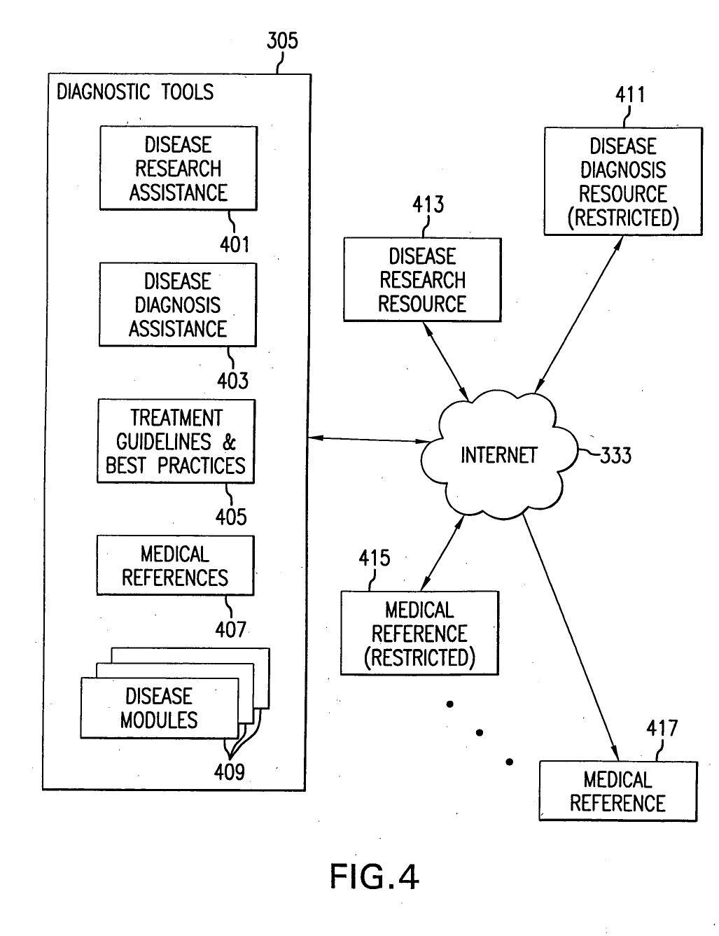

FIGS. 4-10 illustrate examples of sets of tools for use in connection with the present invention. One or more embodiments of the invention may include all, or a portion of, these sets of tools. Further, examples are provided of resources included with the tools, for illustration purposes. Hence, one or more embodiments of the present invention may include, omit, augment, and/or combine various resources. If appropriate, a resource may be included in more than one set of tools. Moreover, resources may be proprietary to the operator of the system, or may be obtained from other parties, and may be located anywhere that is electronically accessible.

Reference is now made to FIG. 4, illustrating an example of diagnostic tools 305 for one or more embodiments of the medical information portal of the present invention. The diagnostic tools 305 include, for example, disease research assistance 401, disease diagnosis assistance 403, treatment guidelines and “best practices” 405, medical references 407, and/or several disease modules 409 with professional explanations of diseases. In this example, the disease modules are optionally stored locally in the system. The system provides access to one or more disease research resources 413, one or more disease diagnosis resources (which is optionally restricted) 411, and/or one or more medical references (optionally restricted) 415, 417. Access may be provided locally and/or via a network, e.g., the Internet 333. In this way, resources directed to medical diagnosis that are accessed over the Internet may be made available to the user in a convenient grouping in a set of diagnostic tools, further meeting the healthcare professionals' intuitive categorization of certain resources as directed to diagnosis.

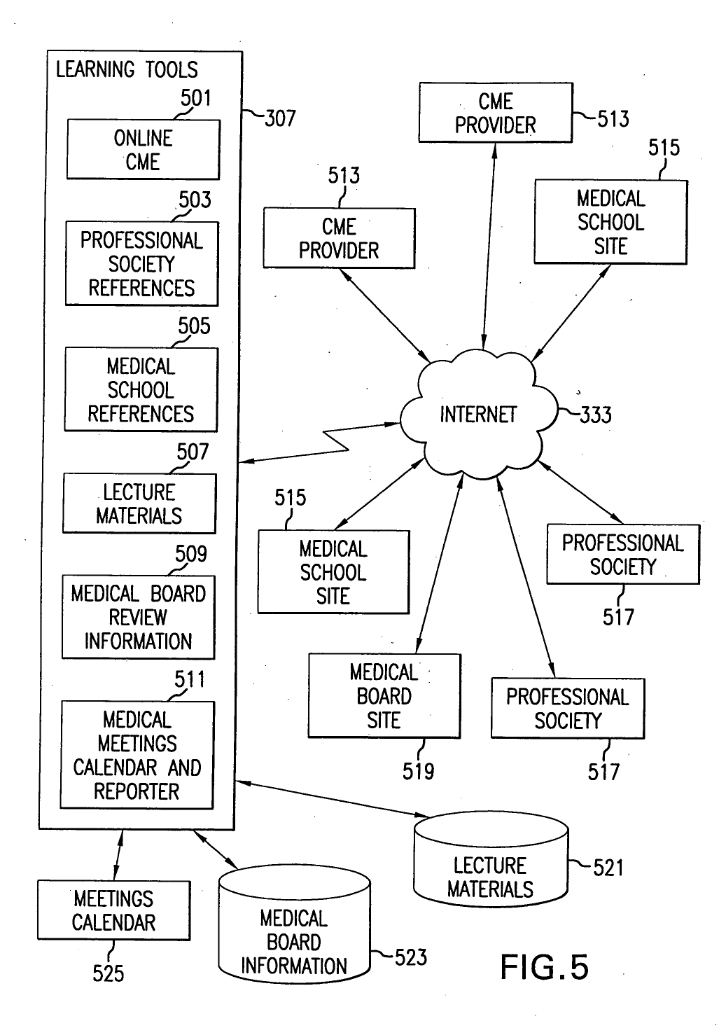

Reference is now made to FIG. 5, illustrating an example of learning tools 307 for one or more embodiments of the medical information portal of the present invention. The learning tools 307 include, for example, online continuing medical education (CME) 501 (information and/or providers); references (e.g., links, lists) to professional societies 503; references to medical schools 505; lecture materials 507 and portions thereof, e.g., libraries of slides, presentations, lecture outlines, etc.; medical board review information 509, e.g., board review materials, information on boards, etc.; and/or medical meetings calendar and medical meetings reporter 511. Some of these resources may be conveniently local to the system, for example, the meetings calendar 525, medical board information 523, and/or lecture materials 521. Other resources may be accessed via the Internet 333. Resources appropriate to learning tools include, e.g., CME providers 513, medical school sites 515, professional societies 517, and/or medical board sites 519. Access to resources may be provided locally and/or via a network, e.g., the Internet 333. In this way, resources directed to medical learning that are accessed over the Internet may be made available to the user in a convenient grouping in a set of learning tools, further meeting the healthcare professionals' intuitive categorization of certain resources as directed to learning.

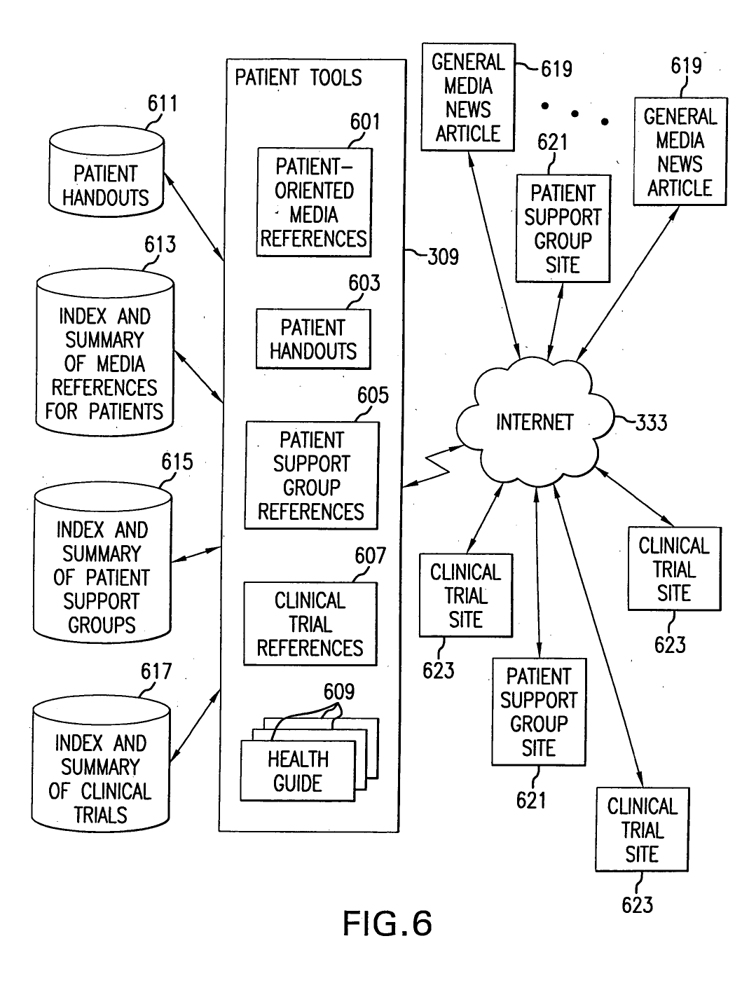

Reference is now made to FIG. 6, illustrating an example of patient tools 309 for one or more embodiments of the medical information portal of the present invention. The patient tools 309 include, for example, one or more of: patient-oriented media references 601, patient handouts 603, patient support groups 605, clinical trials 607, and/or health guides. The system may include, as in this example, a database of patient handouts 611, and/or index and summaries to provide better access to, e.g., media references for patients 613, patient support groups 615, and/or clinical trials 617. Other resources may include articles appearing in the lay media 619, patient support group sites 621, and/or clinical trial sites 623. Access may be provided locally and/or via a network, e.g., the Internet 333. In this way, resources directed to patients that are accessed over the Internet may be made available to the user in a convenient grouping in a set of patient tools, further meeting the healthcare professionals' intuitive categorization of certain resources as directed to patients.

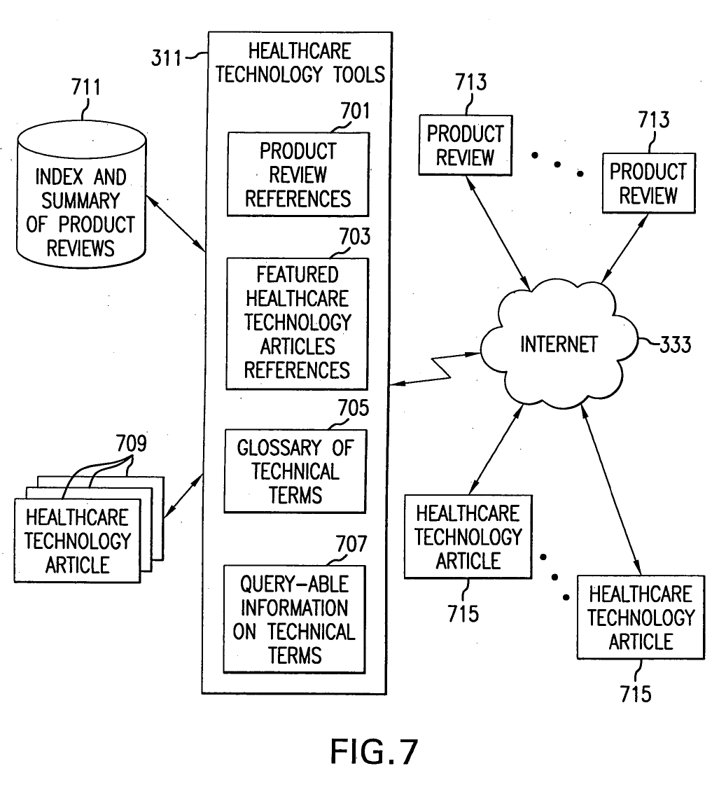

Reference is now made to FIG. 7, illustrating an example of healthcare technology tools for one or more embodiments of the medical information portal of the present invention. The healthcare technology tools 311 include, for example, product reviews 701, features healthcare technology articles 703, glossary of technical terms 705, and/or query-able information on technical terms or technology products. Some of these resources may be stored locally, e.g., healthcare technology articles 709. Access may be provided locally and/or via a network, e.g., the Internet 333. If appropriate or desirable, such as where the resources are sufficiently scattered, the system may include an index and summary of the resources, e.g., for product reviews 711. Resources may include in the illustrated embodiment, e.g., product reviews 713, and healthcare technology articles, 715. In this way, resources directed to healthcare technology that are accessed over the Internet may be made available to the user in a convenient grouping in a set of healthcare technology tools, further meeting the healthcare professionals' intuitive categorization of certain resources as directed to healthcare technology.

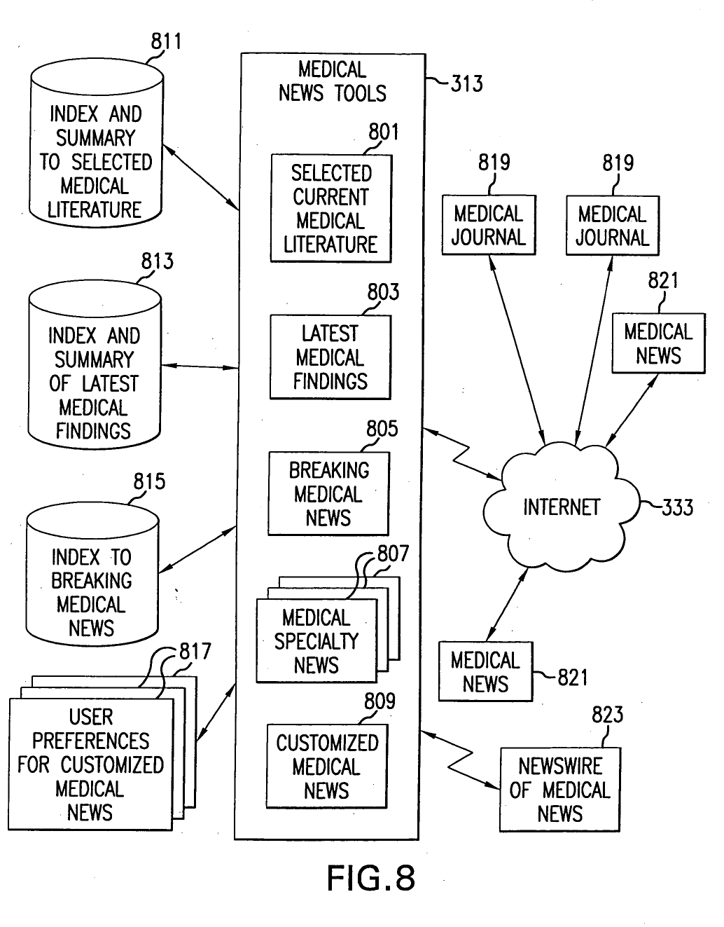

Reference is now made to FIG. 8, illustrating an example of medical news tools 313 for one or more embodiments of the medical information portal of the present invention. The medical news tools 305 include, for example, selected current medical literature 801, latest medical findings 803, breaking medical news 805, medical specialty news 807, and/or customized medical news 809. Medical news resources may include, for example, medical journals 819, medical news 821, and/or one or more newswires of medical news 823. Appropriate and/or desirable indexes to resources may be provided, e.g., an index and summary to selected medical literature 811, to latest medical findings, and to breaking medical news 815. The medical news resources may be “selected” for a resource by any appropriate method, e.g., latest may be determined to be today's articles. Alternatively, the medical news resources may be “selected” and provided by a third party. Each user may, if desired, furnish preferences for customized medical news 817, which may be used to filter news into customized medical news 809. Access may be provided locally and/or via a network, e.g., the Internet 333. In this way, resources directed to medical news that are accessed over the Internet may be made available to the user in a convenient grouping in a set of medical news tools, further meeting the healthcare professionals' intuitive categorization of certain resources as directed to medical news.

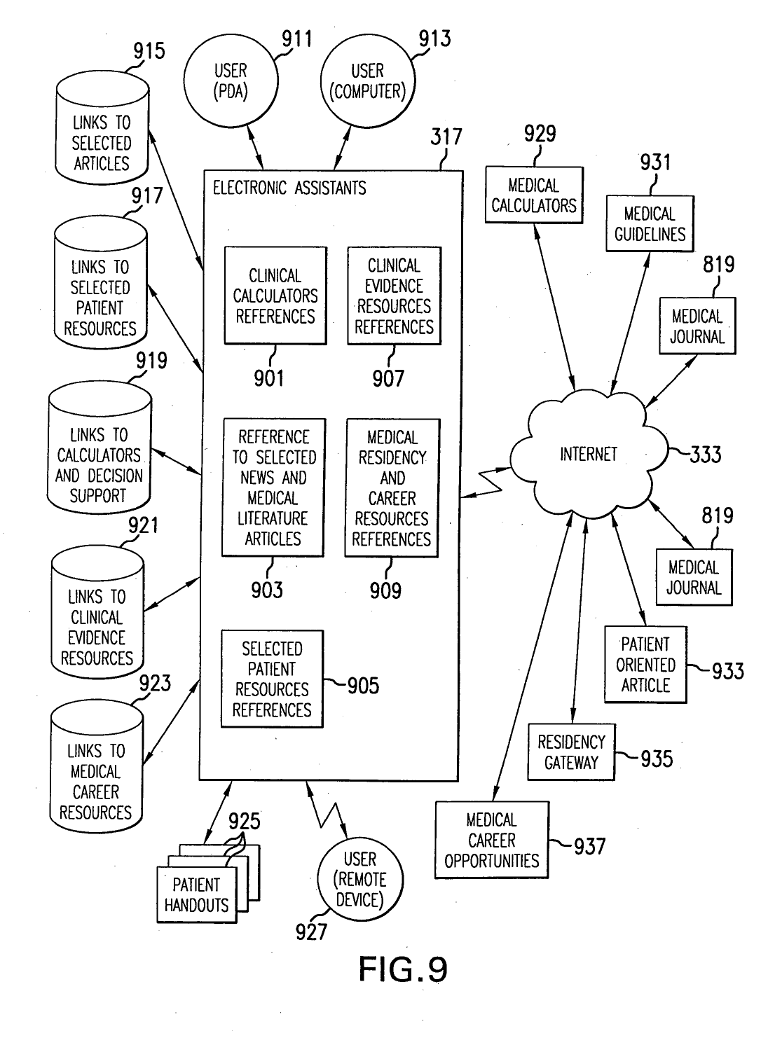

Reference is now made to FIG. 9, illustrating an example of electronic assistants tools 317 for one or more embodiments of the medical information portal of the present invention. The electronic assistants tools 317 include, for example, clinical calculators 901, references to selected news and medical literature articles 903, selected patient resources 905, clinical evidence resources 907, and/or medical residency and career resources 909. Optionally, resources provided by the electronic assistants tool are appropriate for downloading to user's electronic tool, especially where the tool is portable, e.g., a PDA of a user 911, a handheld computer of a user 913, or other remote device 927. The system may provide a variety of patient handouts 925, medical calculators 929, medical guidelines 931, medical journals 819, patient-oriented articles 933, one or more residency gateways 935, and one or more medical career opportunities 937. Where appropriate or desirable, indexes, summaries, or links to selected resources may be provided, e.g., links to selected articles 915, to selected patient resources 917, to calculators and decision support 919, to clinical evidence resources 921, and/or to medical career resources 923. Access may be provided locally and/or via a network, e.g., the Internet 333. In this way, resources appropriate for the electronic assistants tool that are accessed over the Internet may be made available to the user in a convenient grouping in a set of electronic assistants tools, further meeting the healthcare professionals' intuitive categorization of certain resources as appropriate for an electronic assistant.

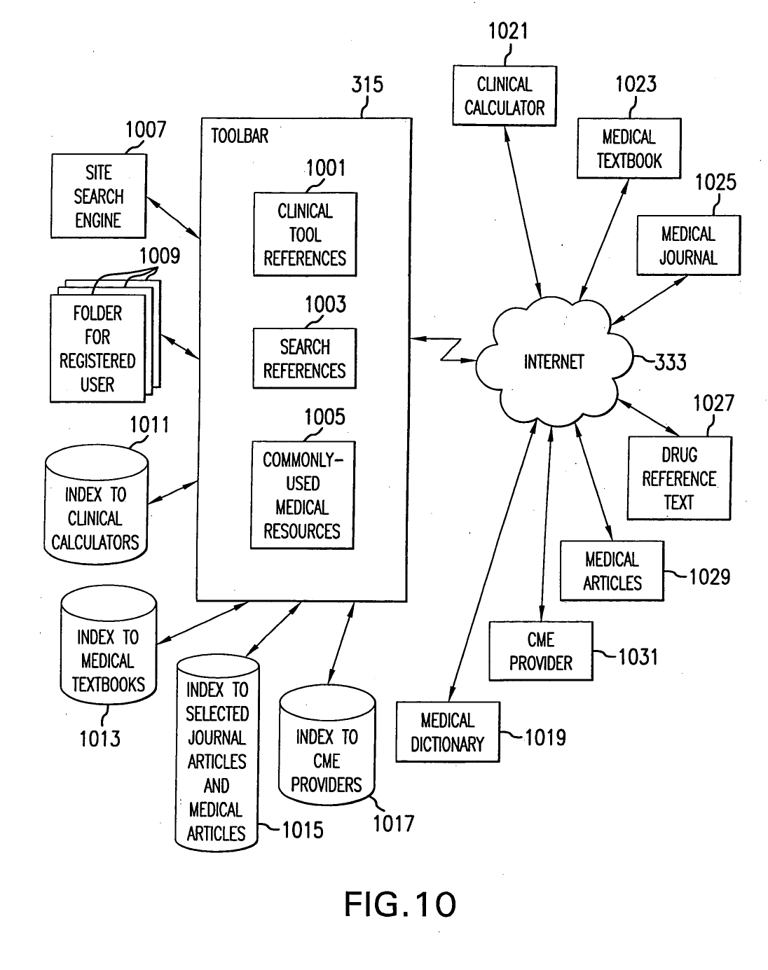

Reference is now made to FIG. 10, illustrating an example of a toolbar 315 for one or more embodiments of the medical information portal of the present invention. The toolbar is intended to persist on the user's interface while accessing the site, in order to provide even easier access to the most commonly used resources. “Most commonly used” may be determined, e.g., by those a physician expects to have immediately at hand in their practice; these may include resources that are (or are not) provided in connection with another set of tools. The toolbar 315 includes, for example, clinical tools 1001, one or more search engines 1003, and/or commonly used medical resources 1005. Resources in the illustrated example include one or more clinical calculators 1021, medical textbooks 1023, medical journals 1025, drug reference texts 1027, medical articles 1029, medical dictionaries 1019, and/or CME providers 1031. Access may be provided locally and/or via a network, e.g., the Internet 333. Indexes may be provided where appropriate and/or desirable, e.g., to various clinical calculators 1011, to medical textbooks 1013, to selected journal articles and medical articles 1015, and/or to CME providers. Some resources may be provided locally, e.g., a site search engine 1007. Optionally, the system may include a folder for each registered user 1009 in which the user may store links and/or user-selected resources. In this way, resources appropriate for a toolbar that are accessed over the Internet may be made available to the user in a convenient grouping in a toolbar, further meeting the healthcare professionals' intuitive categorization of certain resources as those that should be immediately at hand.

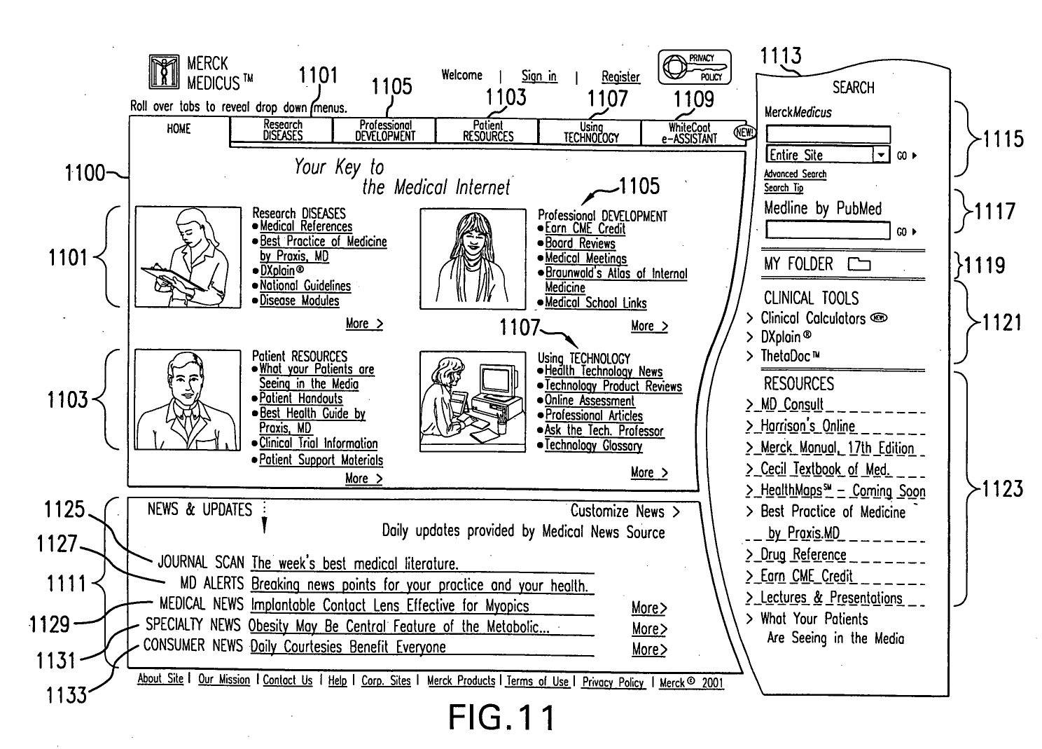

FIG. 11 is an exemplary user interface illustrating a home page 1100, including sets of tools, e.g., optional disease research tools 1101, professional development tools 1105, patient resource tools 1103, healthcare technology tools 1107, electronic assistant tools, medical news tools 1111, and/or toolbar 1113, for one or more embodiments of the medical information portal of the present invention. A user may select a set of tools (or a resource listed therein), or tab to the tools, and be presented with an appropriate user interface.

The toolbar 1113 may include a search; in the illustrated example, the tool bar includes a site search 1115, and a search of a particular resource, e.g., Medline 1117. The toolbar 1113 may optionally include access to the user's folder 1121. The toolbar may include a set of clinical tools 1121; and a set of other resources 1123, a further explained herein. Optionally, the toolbar 1113 is displayed on every page whilst the user is at the portal according to the present invention.

The news and updates tools 1111 may include a variety of sets of resources, logically grouped. In the illustrated example, the news tools 1111 include selected current medical literature 1125 from journals; breaking news 1127; general medical news 1129; specialty news 1131; and/or selected consumer news 1133. News included in any or all of these resources may be provided by a third party provider. This is advantageous particularly where resources require an appropriate license. As an alternative, the site may provide the selection of the news included in one or more resources, e.g., “current medical literature” may be for a specified number of days, e.g., 30 most recent days, from e.g., the ten most prestigious medical journals.

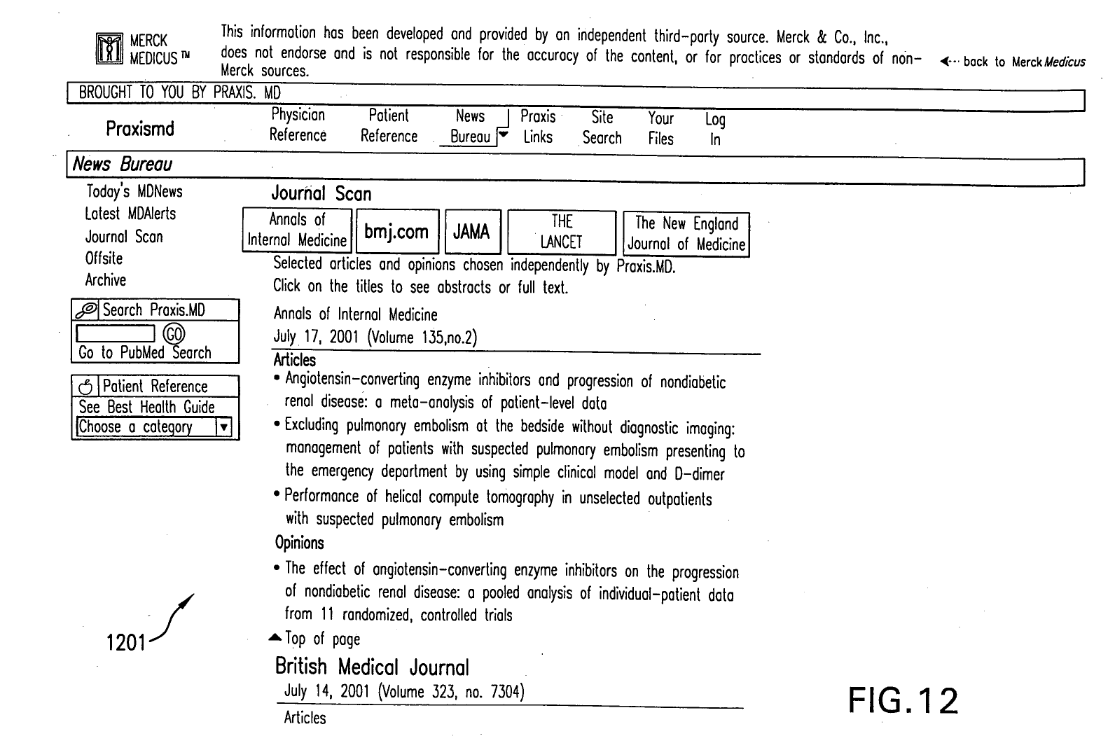

FIG. 12 is an exemplary user interface for current medical periodical literature, for one or more embodiments of the medical news tools. In this example, the resource is provided by an independent third-party source, and a pop-up screen 1201 displays the third-party site. Alternatively, the third-party site could be displayed with a frame. Here, the third party has independently selected the provided articles and opinions.

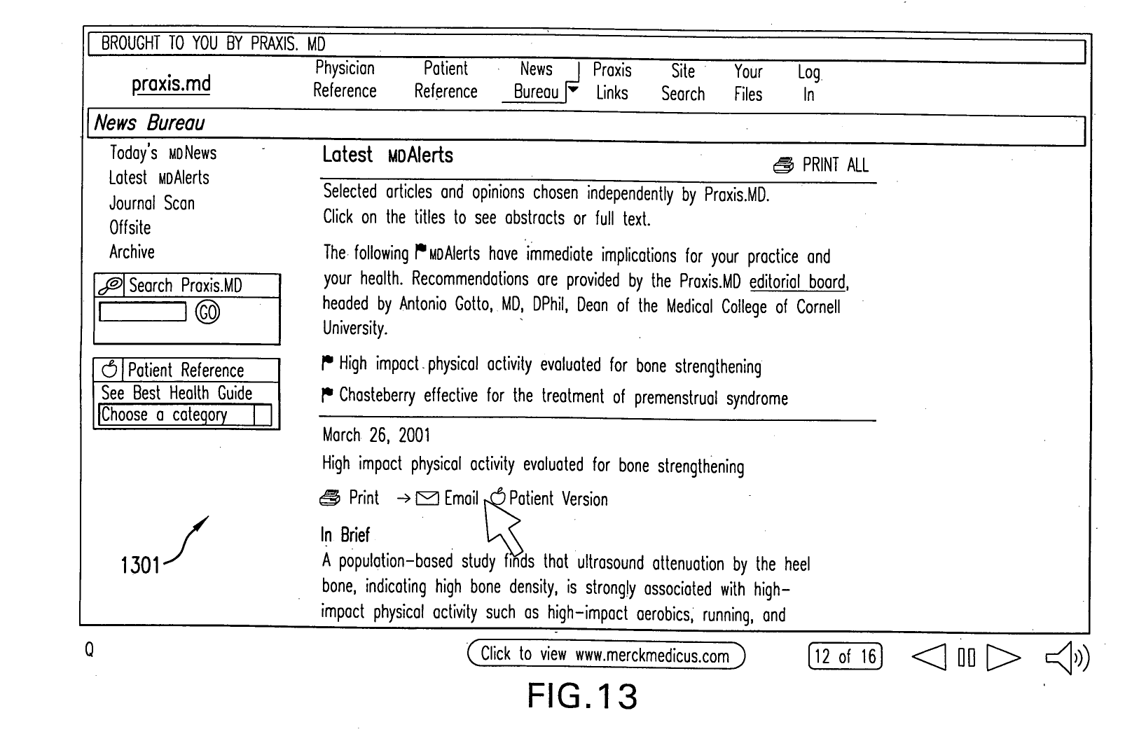

FIG. 13 illustrates an example of a user interface for breaking news, for one or more embodiments of the medical news tools. In this example, the breaking news is provided by a third party, which has selected the articles independently, based on those that are expected to have immediate implications for the professional's practice. The resource is presented in this example in a pop-up screen 1301.

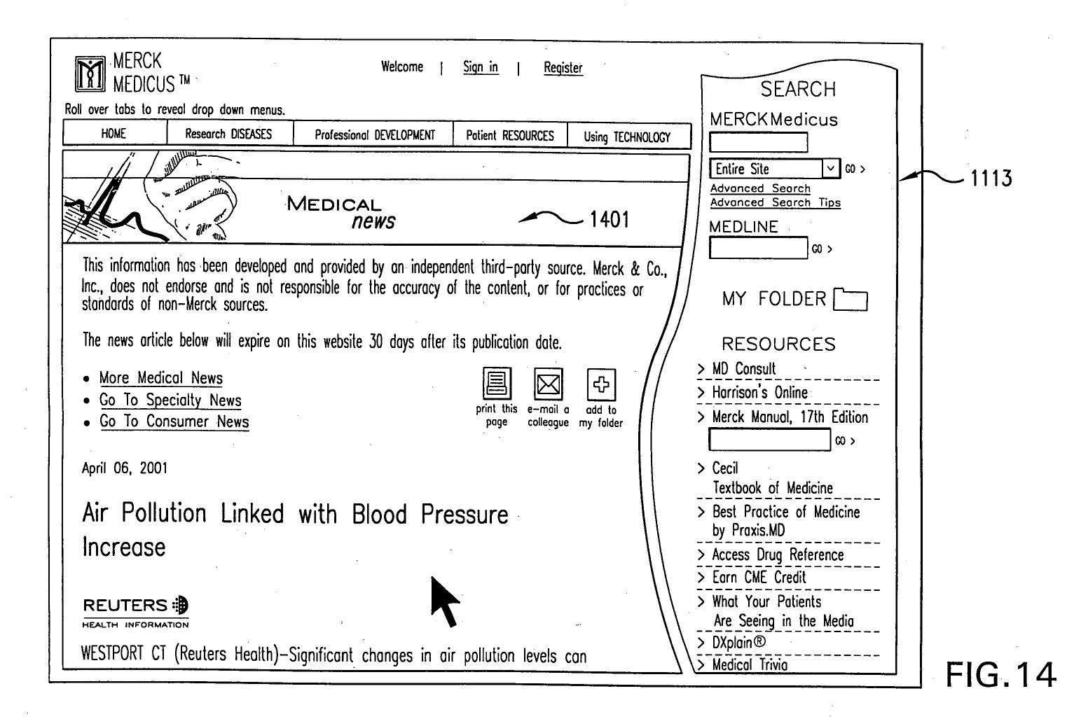

Reference is made to FIG. 14, illustrating an example user interface for general medical news, for one or more embodiments of the medical news tools. In this example, the general medical news is provided by a third party resource. Accessing this resource causes the user interface to display a screen 1401 of medical news. Note that the toolbar 1113 optionally remains on the user interface in this example.

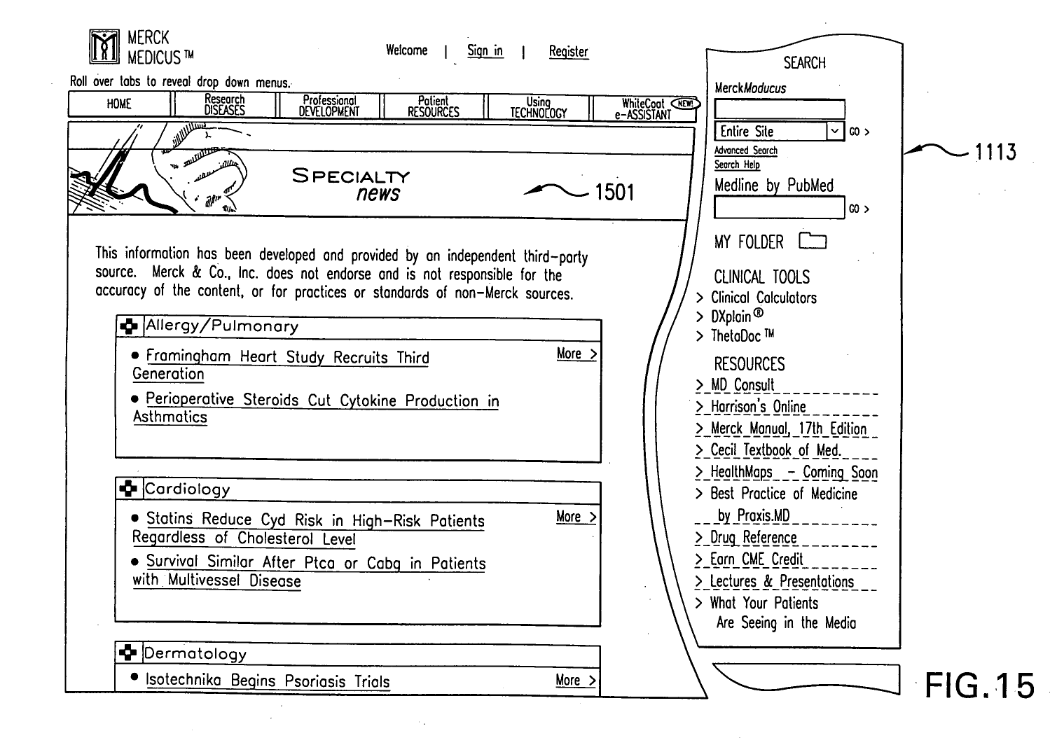

Reference is now made to FIG. 15, illustrating an example user interface for specialized news, for one or more embodiments of the medical news tools. In this example, the specialty medical news is selected and provided by a third party resource. The specialty news corresponds to one or more specialties indicated by the user whilst registering. Accessing this resource causes the user interface to display a screen 1501 of selected specialty medical news. Again, note that the toolbar 1113 optionally remains on the user interface in this example.

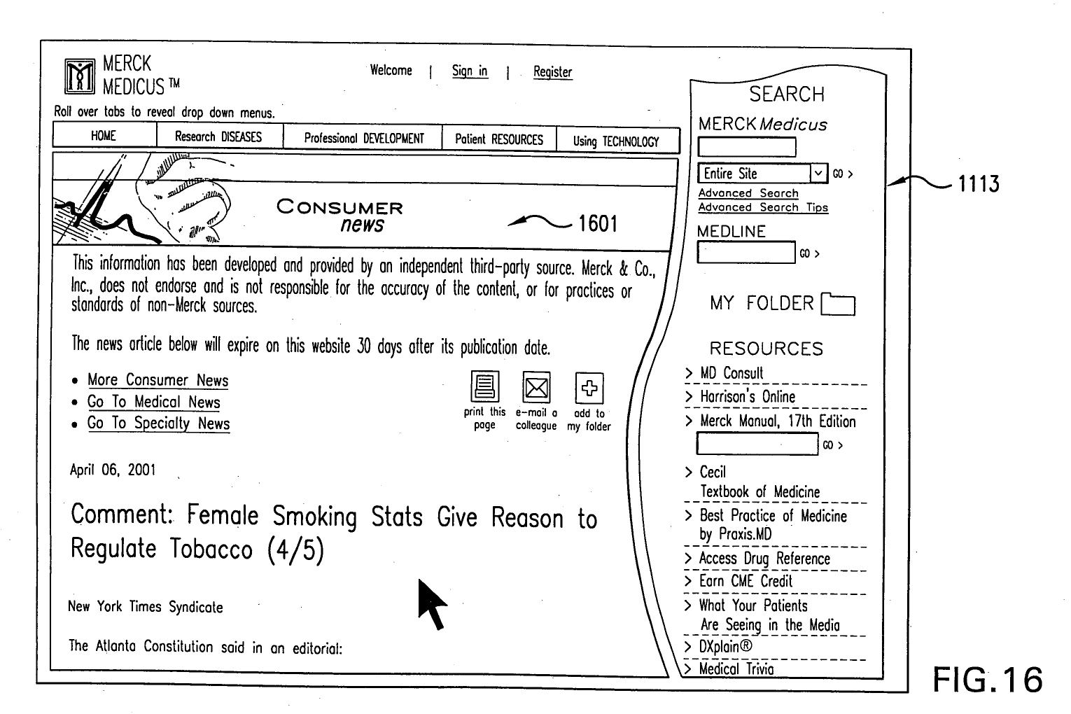

FIG. 16 is an example of a user interface for consumer news, for one or more embodiments of the medical news tools. In this example, the consumer medical news is provided by a third party resource, and advantageously is selected from news resources typically accessed by lay people, e.g., the New York Times. Accessing the consumer news resource in this example causes the user interface to display a screen 1601 of consumer medical news. Again, note that the toolbar 1113 optionally remains on the user interface in this example.

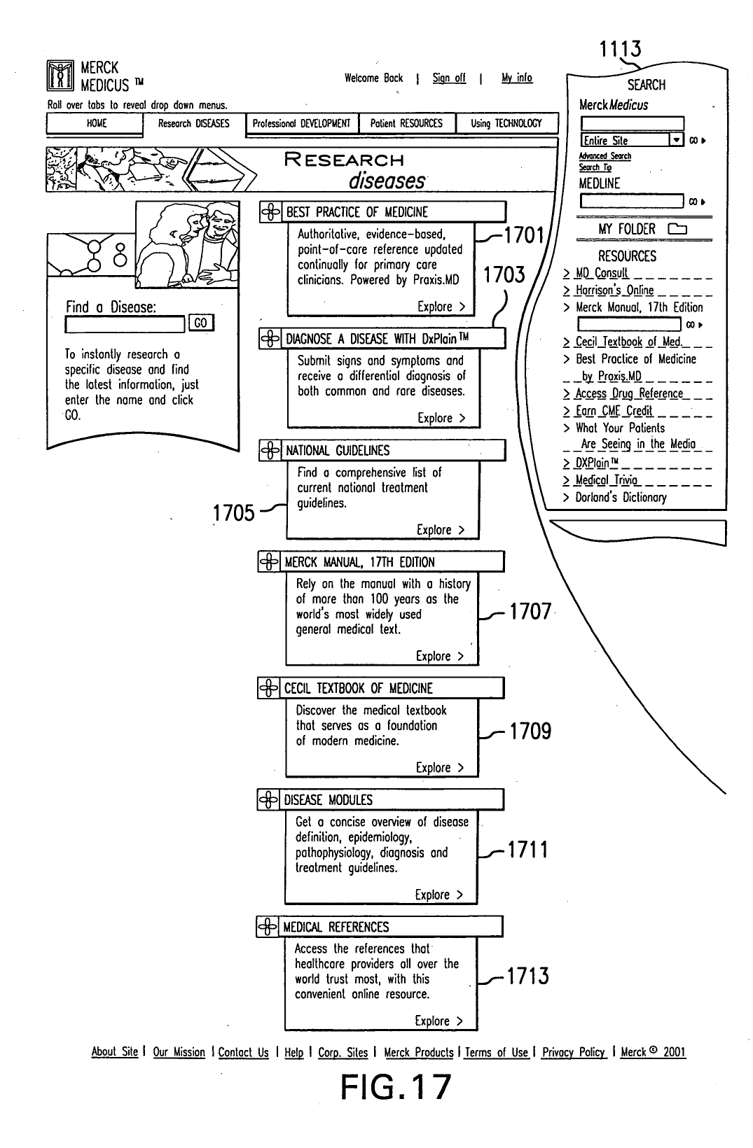

Reference is now made to FIG. 17, illustrating an example of a user interface for diagnostic tools, for one or more embodiments of the medical information portal of the present invention. The diagnostic tools may include a variety of sets of resources. The diagnostic resources themselves may be presented to the user individually and/or may be further logically grouped. In the illustrated example, the diagnostic tools include a one or more medical references, e.g., “Best Practice of Medicine” 1701; one or more diagnosis service, e.g., DxPlain™ 1703; a list of national treatment guidelines 1705; one or more general medical texts, e.g., the Merck Manual 1707; one or more medical textbooks, e.g., Cecil 1709; disease modules containing concise disease information, e.g., disease definition, epidemiology, pathophysiology, diagnosis and/or treatment guidelines; and/or other medical references 1713. In the present example, the toolbar 1113 remains on the user interface.

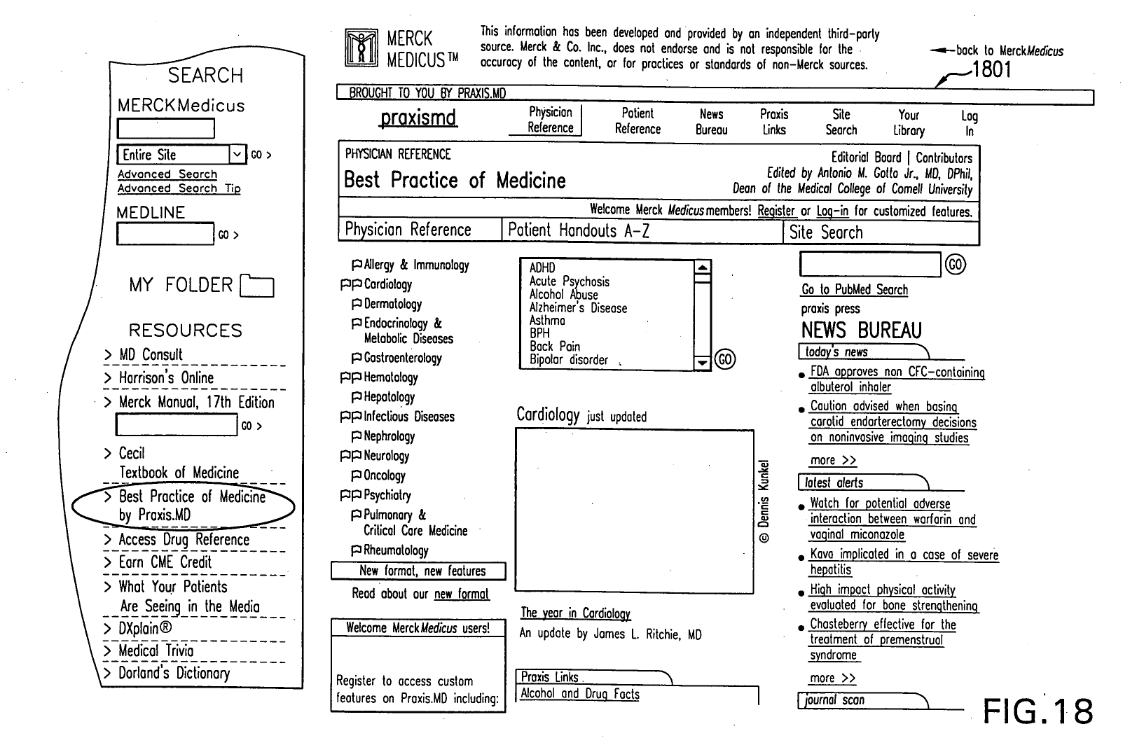

Reference is now made to FIG. 18, illustrating an example user interface for a physician reference resource provided in connection with the diagnostic tools. In this example, the physician reference resource “Best Practice of Medicine” is provided by a third party, as may be typical for a standard reference text. The resource is presented in this example in a pop-up screen 1801.

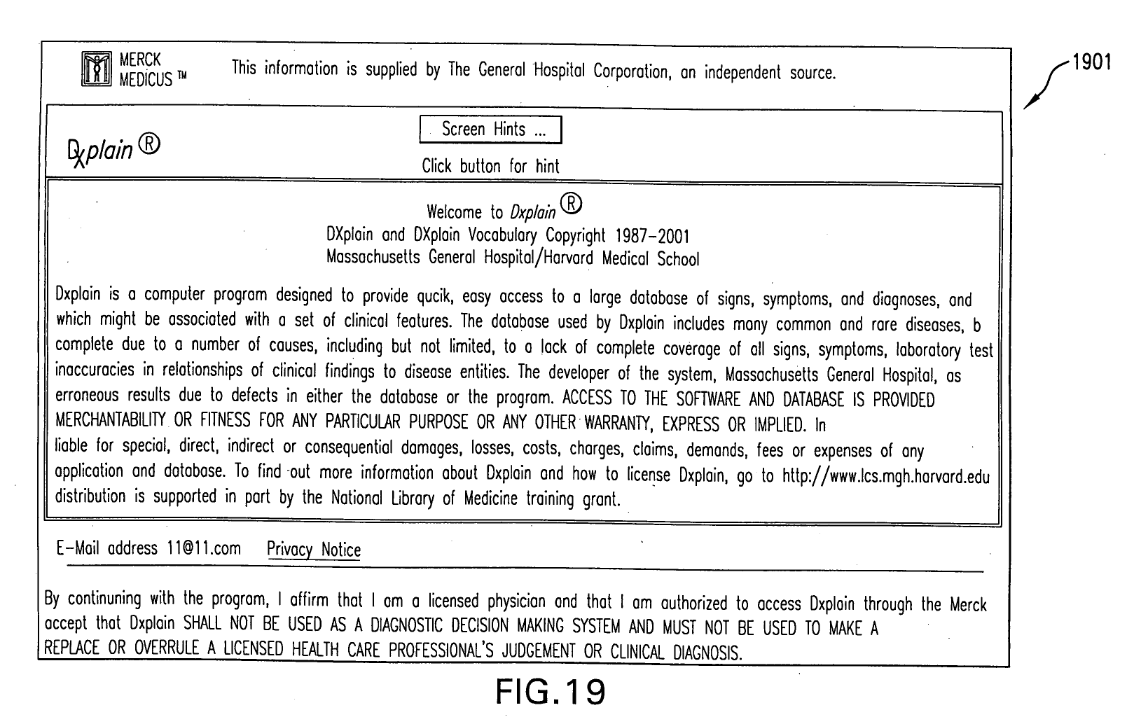

Reference is now made to FIG. 19, illustrating an example user interface for a disease diagnosis service, a resource accessed via the diagnostic tools, according to one or more embodiments of the present invention. In this example, the disease diagnosis resource is a service provided by a third party. The resource is presented in this example in a pop-up screen 1901.

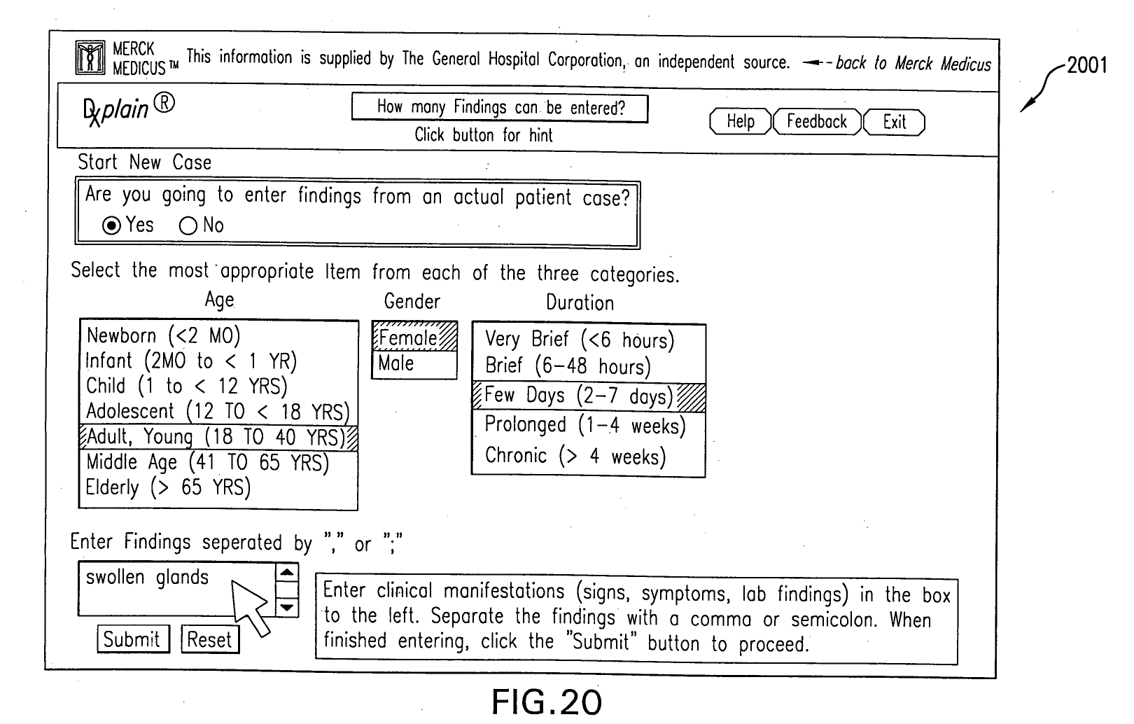

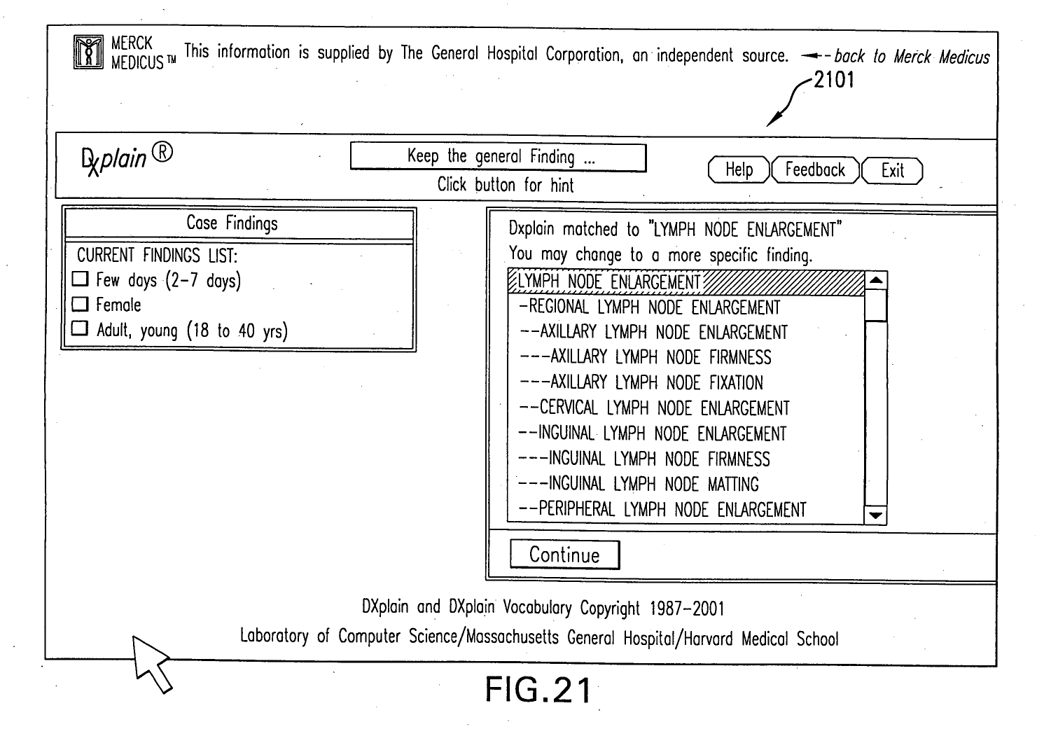

FIG. 20 is another page 2001 of the exemplary user interface for the disease diagnosis service of FIG. 19. The present invention allows for interactive resources to interact with the user. In this case, the user is prompted for inputs to the diagnosis service. FIG. 21 is a further page 2101 of the exemplary user interface for the disease diagnosis service of FIG. 19, showing the case findings returned in response to the user inputs. The user may be interactively prompted for further inputs by a resource, such as shown in this example.

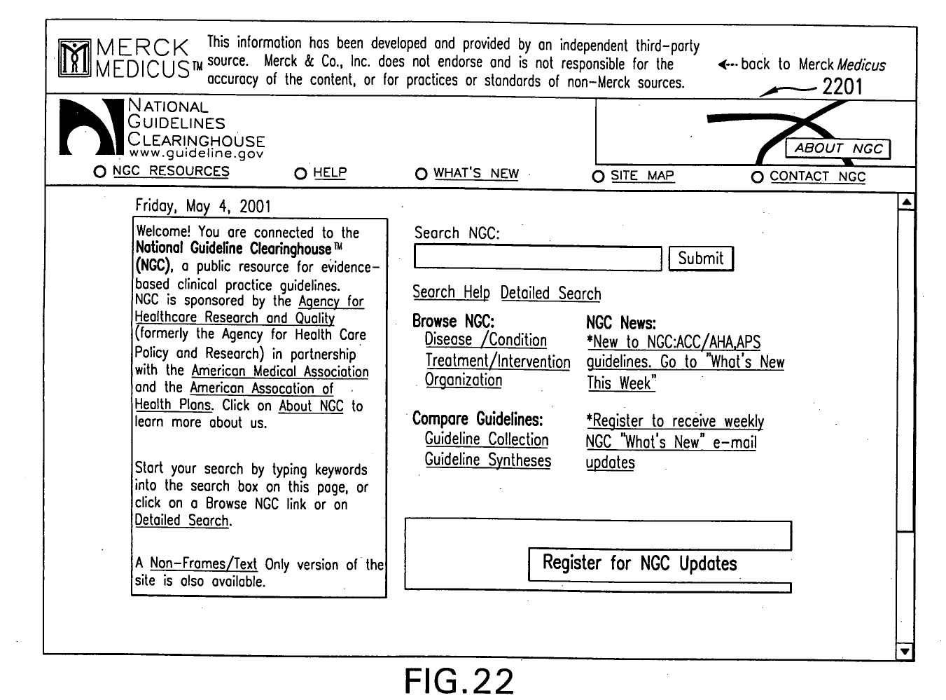

Reference is now made to FIG. 22, illustrating an example user interface for a clinical practice guidelines resource, for use in connection with the diagnostic tools. In this example, the resource “National Guideline Clearinghouse”™ is provided by a third party. The resource is presented in this example in a pop-up screen 2201.

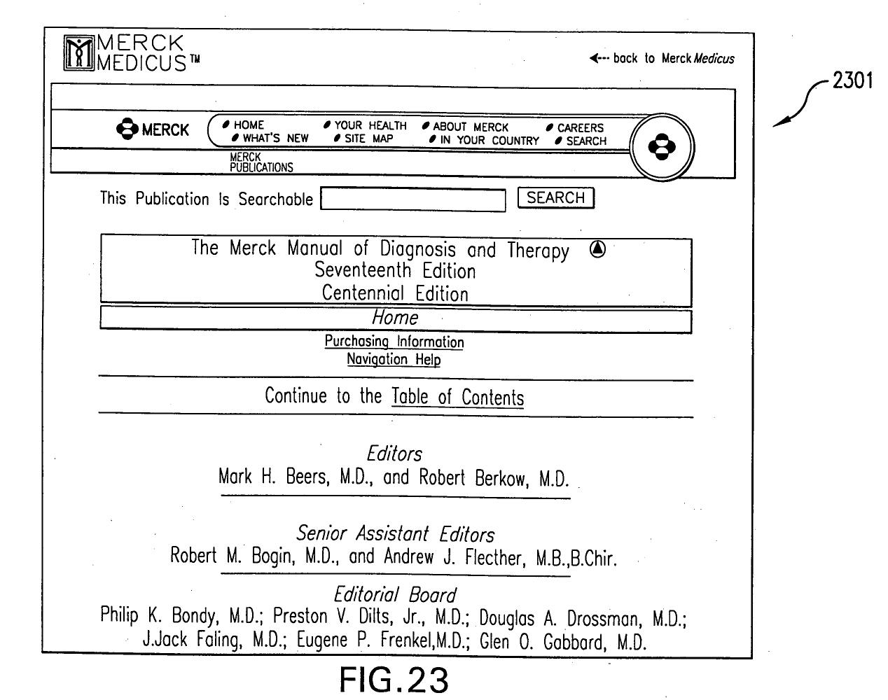

Reference is now made to FIG. 23, illustrating an example user interface for another medical reference, for use in connection with the diagnostic tools of FIG. 17. In this example, the medical reference, “The Merck Manual” is a standard publication that is provided by the site operator by obtaining any necessary permission. The resource is presented in this example in a pop-up screen 2301.

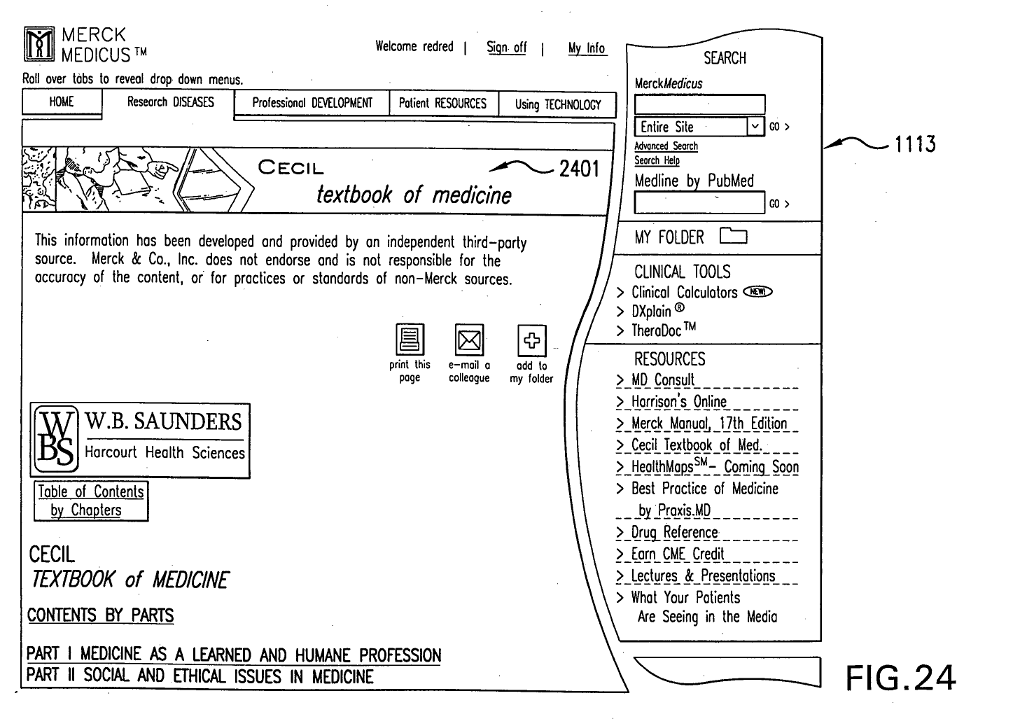

FIG. 24 illustrates a user interface for a medical textbook as an example for use in connection with the diagnostic tools of FIG. 17. In this example, the medical textbook is provided by a third party provider. The resource is presented in this example in a pop-up screen 2401, and the toolbar 1113 optionally remains on the user interface.

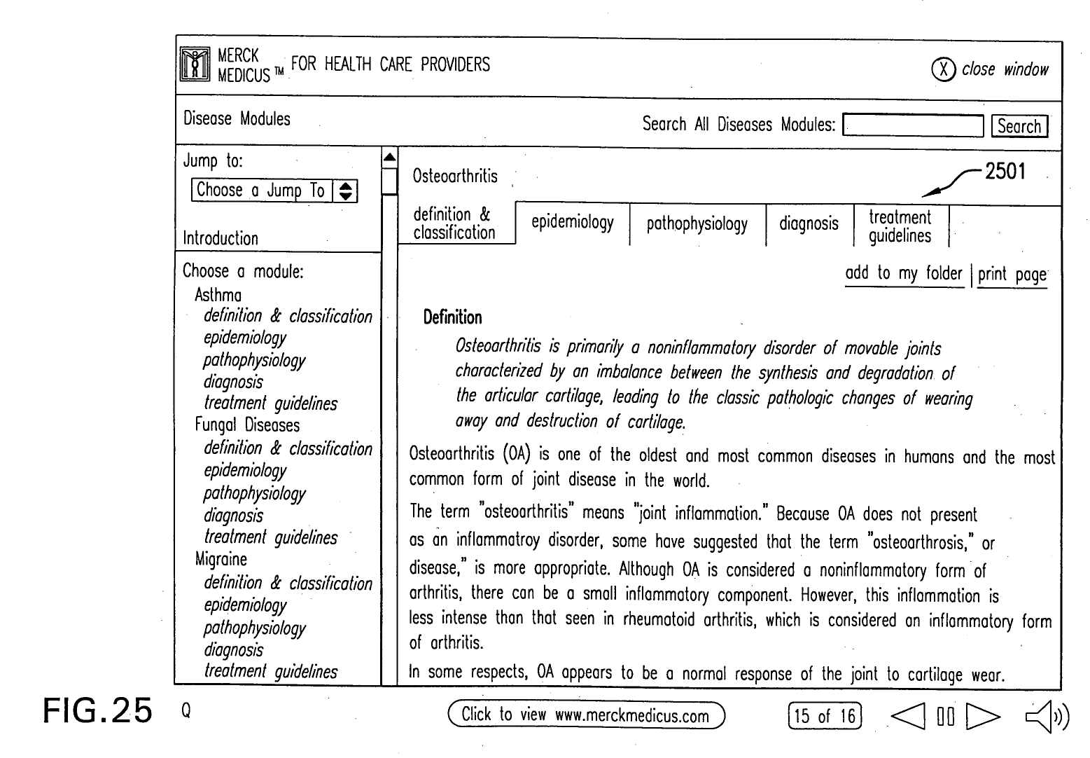

Reference is now made to FIG. 25, an example of a user interface for disease modules, for use in connection with the diagnostic tools. In this example, the disease modules are provided by the system operator. The disease modules are intended to provide a consistent level of information about each of various diseases. Hence, in this example, a disease module includes definition & classification information, epidemiology, pathophysiology, diagnosis information, and treatment guidelines. The resource is presented in this example in a pop-up screen 2501.

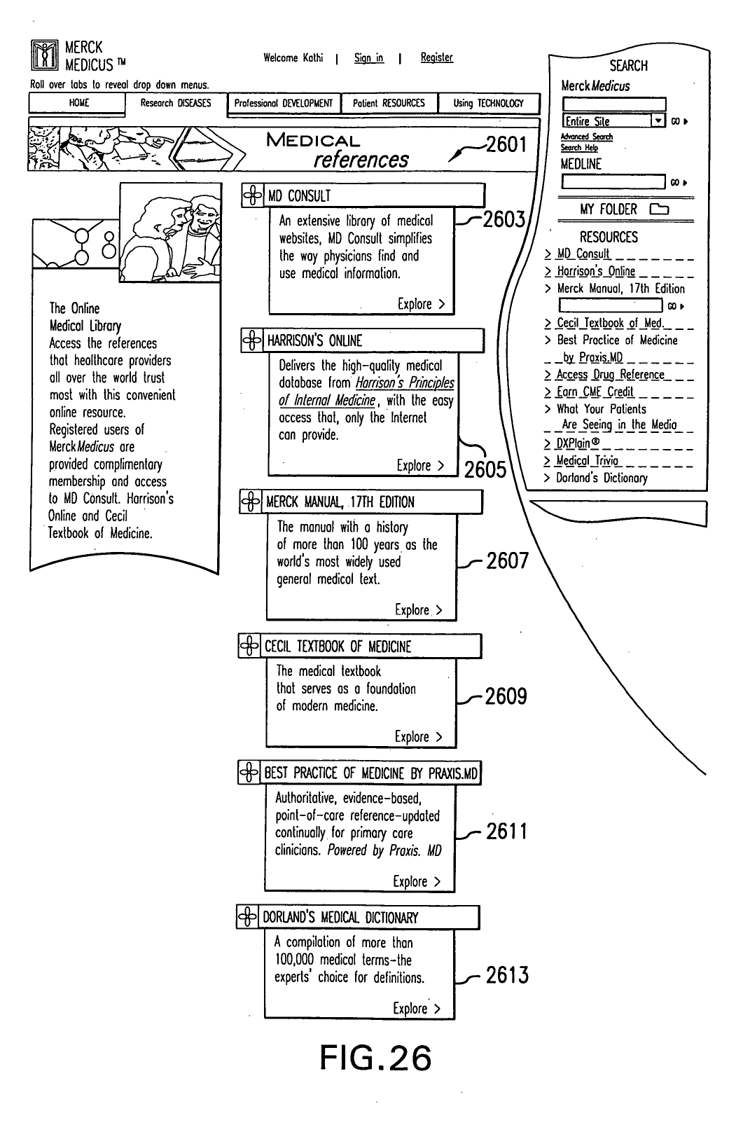

Reference is now made to FIG. 26, an exemplary user interface for a set of medical references, for use in connection with the diagnostic tools of FIG. 17. The medical references “resource” 2601 contains a further set of resources, in this example including a library of consult medical websites 2603, e.g., MD Consult™; a medical database 2605, e.g., Harrison's Online; a standard medical text 2607, e.g., The Merck Manual; a medical textbook 2609, e.g., Cecil Textbook; a point-of-care reference 2611, e.g., Best Practice of Medicine; and/or a medical dictionary 2613, e.g., Dorland's Medical Dictionary.

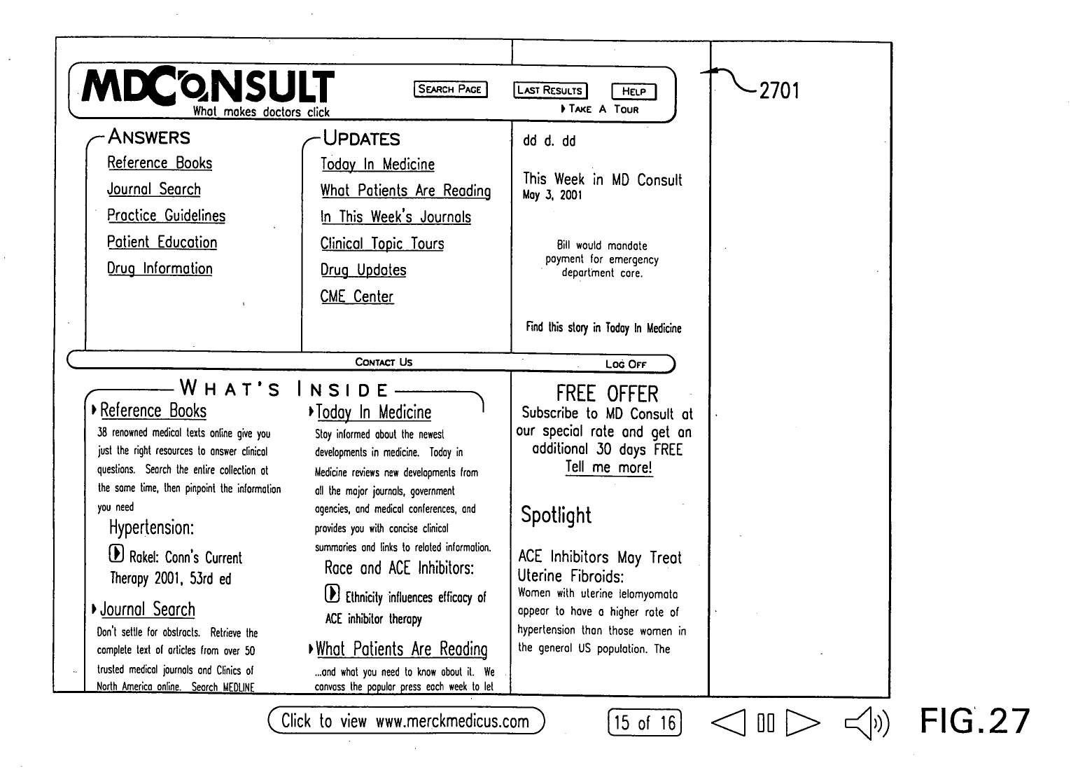

Reference is made to FIG. 27, an example of a user interface for a library of medical websites, for use in connection with the medical references tools. In this example, the reference, MDConsult™ is a collection of other resources, including summaries and abstracts to assist the user. This example illustrates that a resource itself may provide yet another layer of intuitive groupings to the user, and may still be references by the present invention. The resource is presented in this example in a pop-up screen 2701.

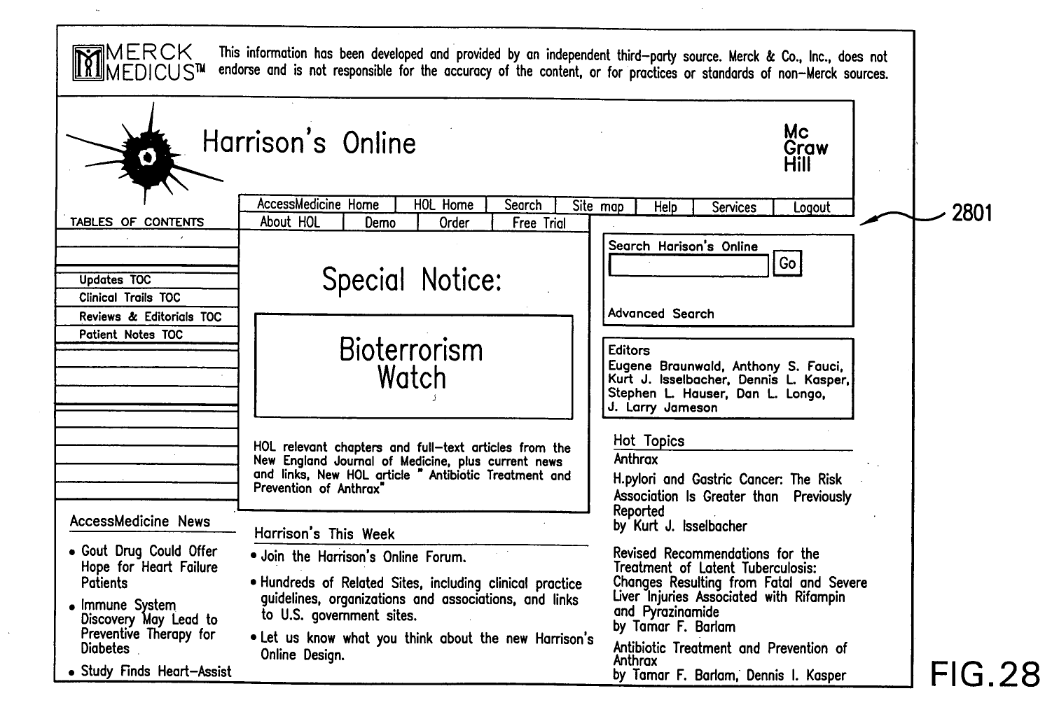

Reference is now made to FIG. 28, illustrating an exemplary user interface for a medical database, for use in connection with the medical reference tools. In this example, the medical database is provided by a third party, and is itself indexed, provides summaries, and is itself searchable. The resource is presented in this example in a pop-up screen 2801.

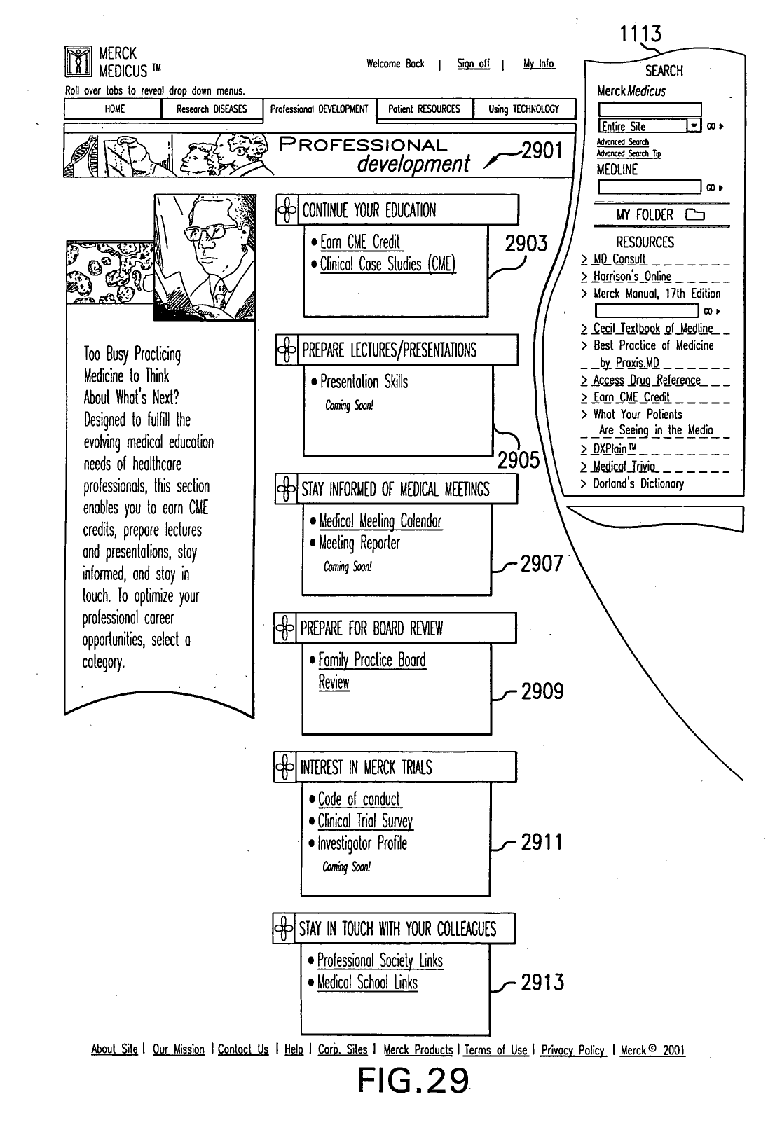

FIG. 29 is an exemplary user interface for learning tools, for one or more embodiments of the medical information portal of the present invention. The learning tools “resource” 2901 contains a further set of resources, in this example including continuing education resources 2903; lecture presentation resources 2905; medical meeting calendar and meeting reporter 2907; board review preparation resources 2909; clinical trial information 2911; and/or professional society links and medical school links 2913. In the present example, the page includes the toolbar 1113.

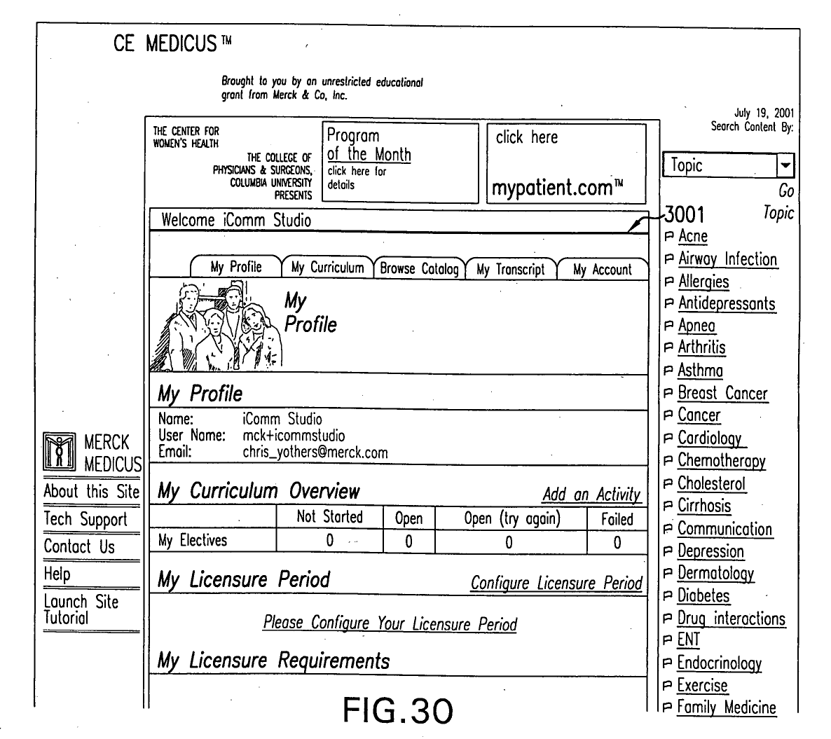

Reference is made to FIG. 30, an exemplary user interface for a user profile, for use in connection with the learning tools. In the present example, the user profile 3001 provides for collection of information relevant to commencing an online CME service.

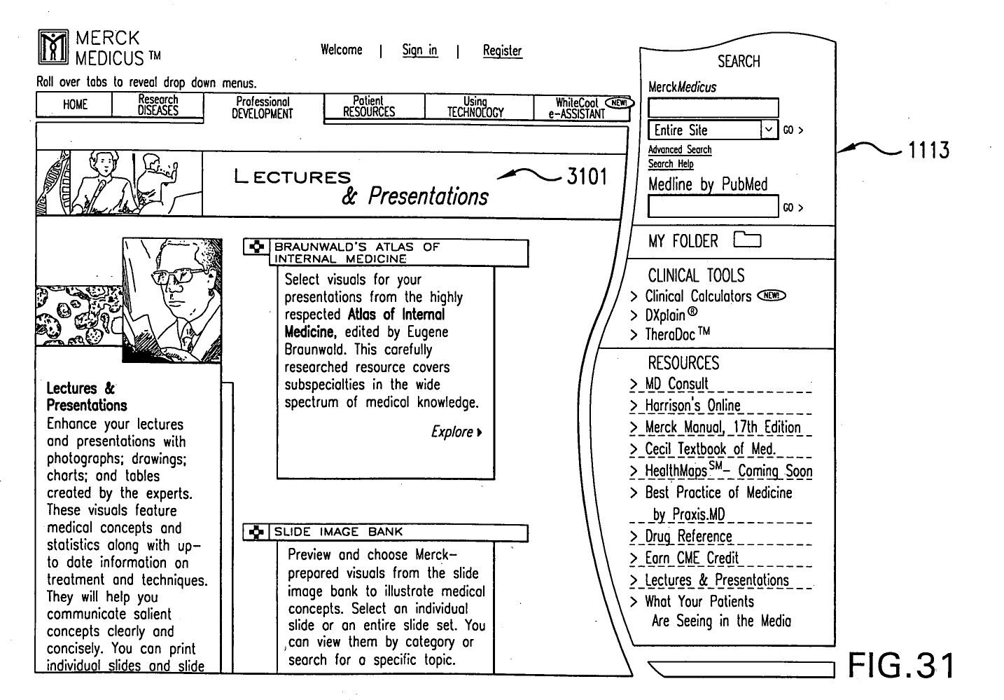

FIG. 31 illustrates an example of a user interface for lecture materials and presentations 3101 for use in connection with the learning tools. The resources collected in this set of tools include, e.g., visuals, such as from an Atlas of Internal Medicine, slides, illustrating medical concepts, and/or text for conveying concepts. The resources may be photographs, drawings, charts, tables, statistics, text, etc. Individual visuals may be printed, or groupings (such as by topic) may be selected. In the present example, the toolbar 1113 is included.

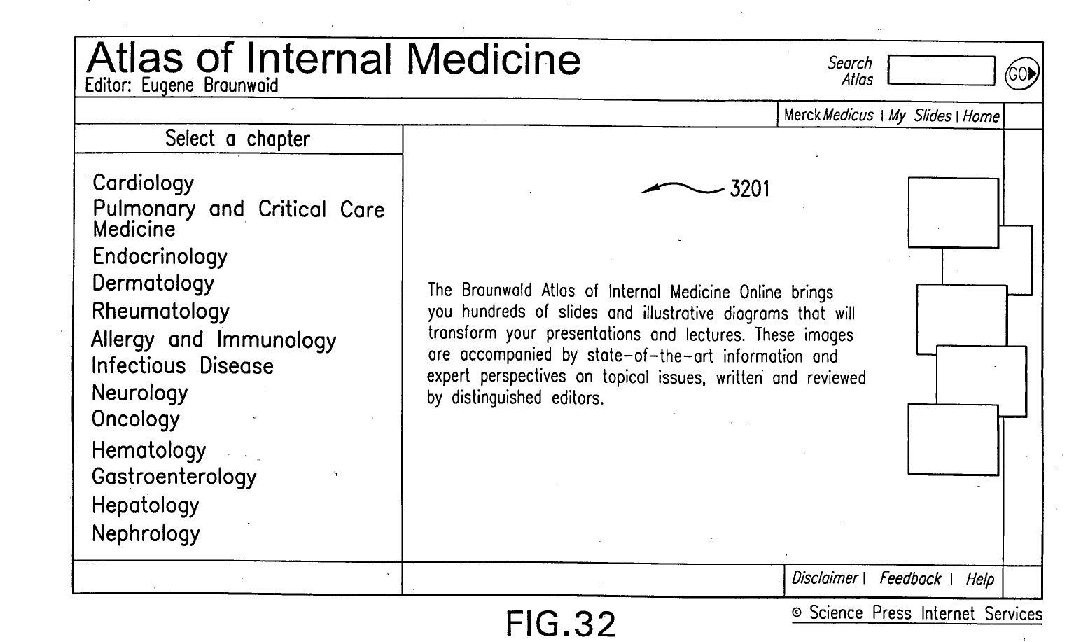

Reference is now made to FIG. 32, illustrating an exemplary user interface 3201 for a standard reference of internal medicine slides and diagrams, for use in connection with the lecture materials and presentations of FIG. 31. In this example, the reference, the Braunwald Atlas of Internal Medicine Online is standard, and may be provided by a third party provider. The resource is presented in this example in a pop-up screen 3201.

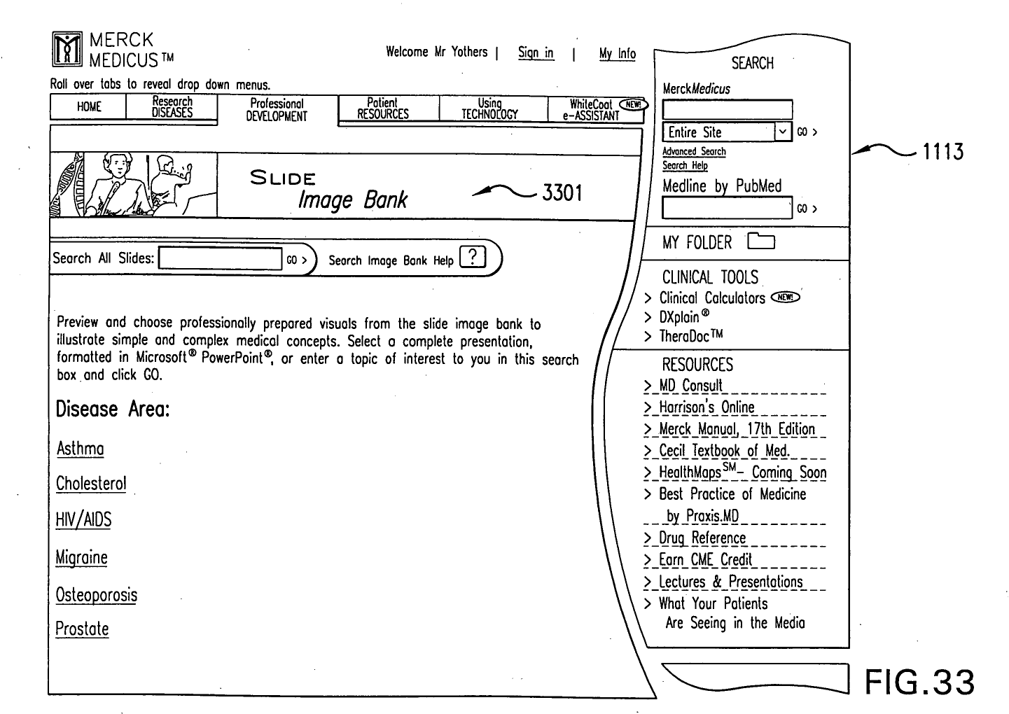

FIG. 33 provides an example of a user interface for a slide image bank, for use in connection with the lecture materials and presentations of FIG. 31. In this example, the slide image bank may be proprietary, or may be provided by a third party provider. The slide image bank lists disease areas for which it provides visuals illustrating medical concepts. In this example, the resource is searchable. The resource is presented in this example in a pop-up screen 3301, and the toolbar 1113 optionally remains on the user interface.

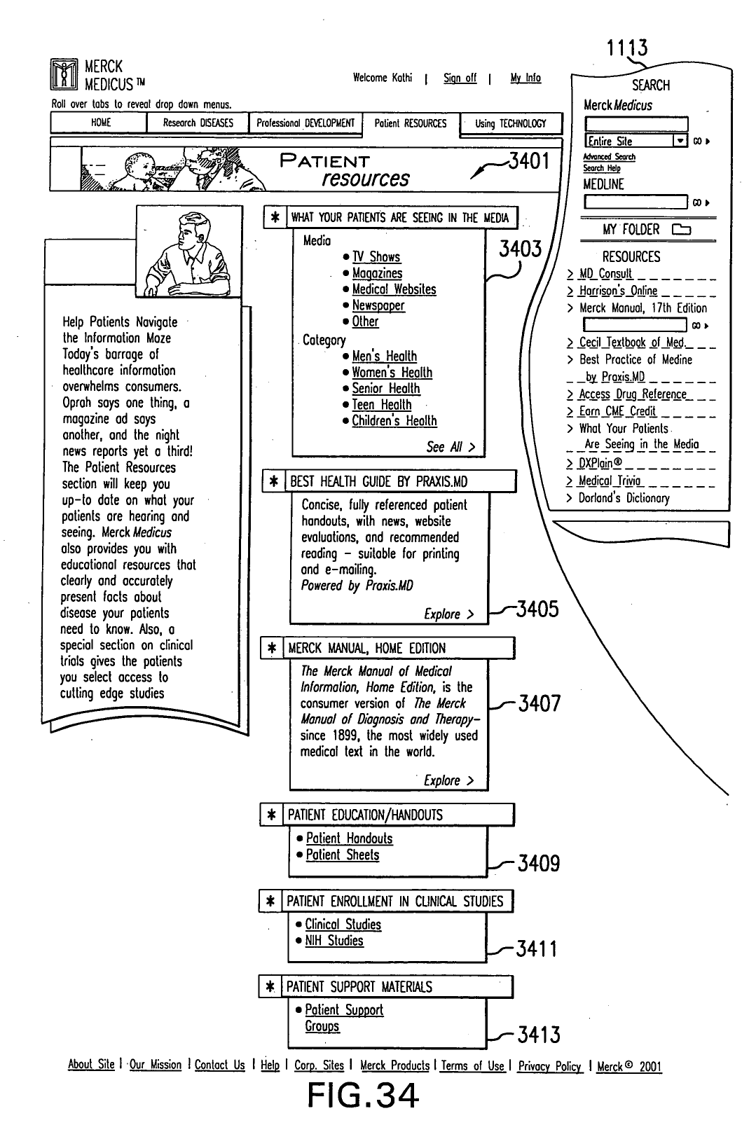

Reference is now made to FIG. 34, providing an example of a user interface for patient tools, for one or more embodiments of the medical information portal of the present invention. The patient tools 3401 may include a variety of sets of resources. The patient resources themselves may be presented to the user individually and/or may be further logically grouped. In the illustrated example, the patient tools 3401 include a one or more resources for what patients are seeing in the media 3403, e.g., TV shows, magazines, medical websites, newspapers, and by category, e.g., men's health, women's health, senior health, teen health, and children's health; a best health guide resource (itself containing further patient resources) 3405; a standard consumer medical text 3407, e.g., The Merck Manual of Medical Information, Home Edition; a collection of patient education handouts and/or sheets 3409; information on clinical studies 3411; and/or references to patient support groups 3413. In the present example, the toolbar 1113 remains on the user interface.

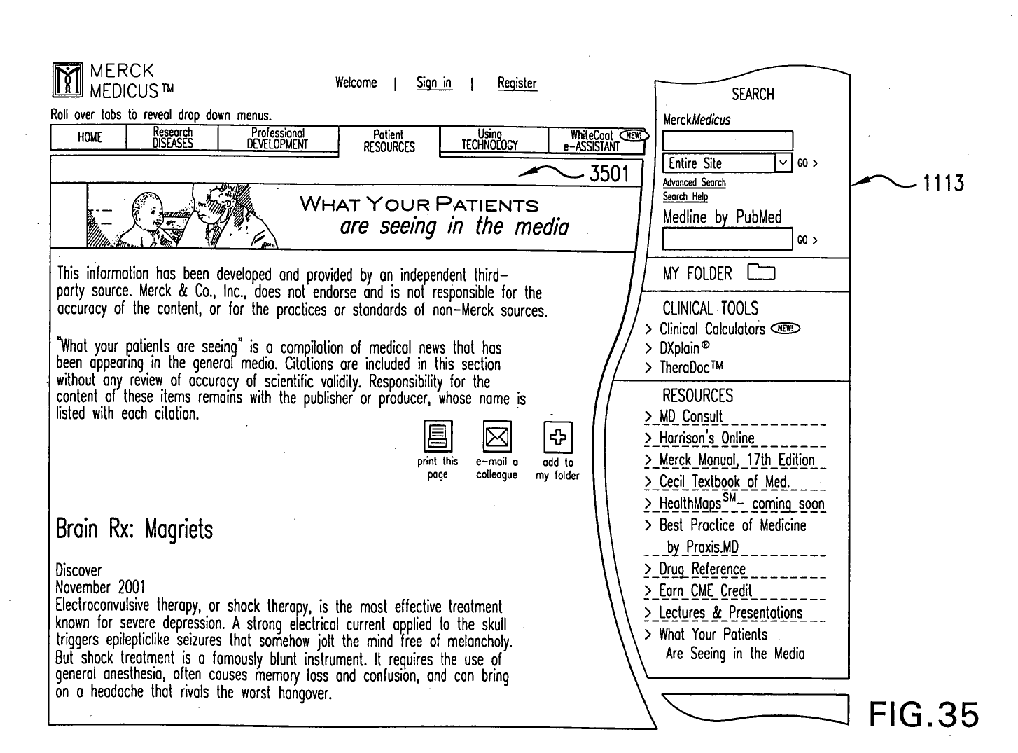

Reference is now made to FIG. 35, an exemplary user interface for information on what patients are seeing in the media, for use in connection with the patient tools. In this example, the reference, the resources on what patients are seeing in the media may be provided by a third party provider, and may be a compilation of medical news appearing in the general media. The resource is presented in this example in a pop-up screen 3501. In this example, the toolbar 1113 is included in the user interface.

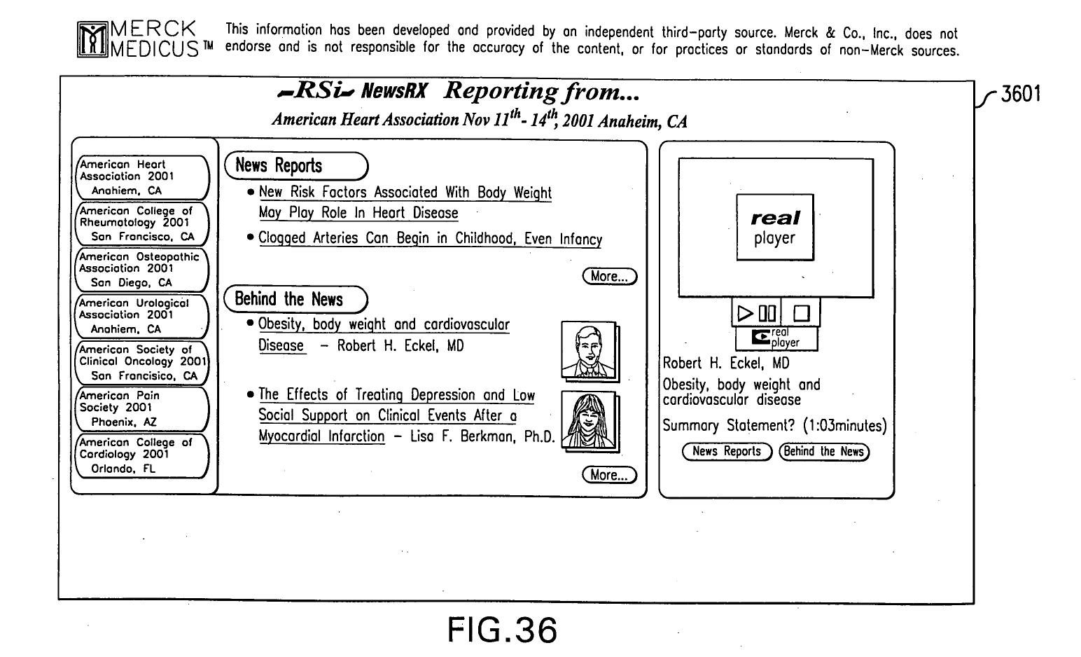

FIG. 36 is an exemplary user interface for another example of information on what patients are seeing in the media. In this example, the reference, the news may be provided by a third party provider, e.g., the American Heart Association. The resource is presented in this example in a pop-up screen 3601.

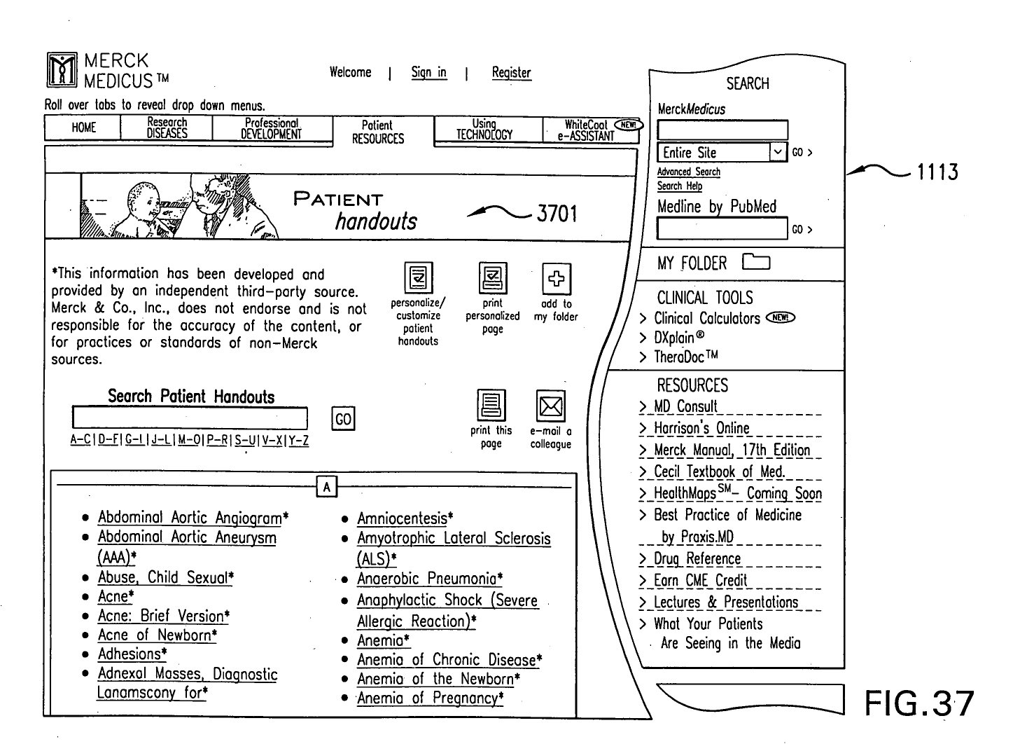

FIG. 37 is an exemplary user interface for patient handouts, for use in connection with the patient tools of FIG. 34. In this example, numerous handouts appropriate for providing to patients are accessible, and may be provided by a third party provider. Advantageously, the patient handouts may be personalized (e.g., by adding physician and/or patient information), printed, and/or e-mailed. The resource is presented in this example in a pop-up screen 3701. In the illustrated example, the toolbar 1113 remains on the user interface.

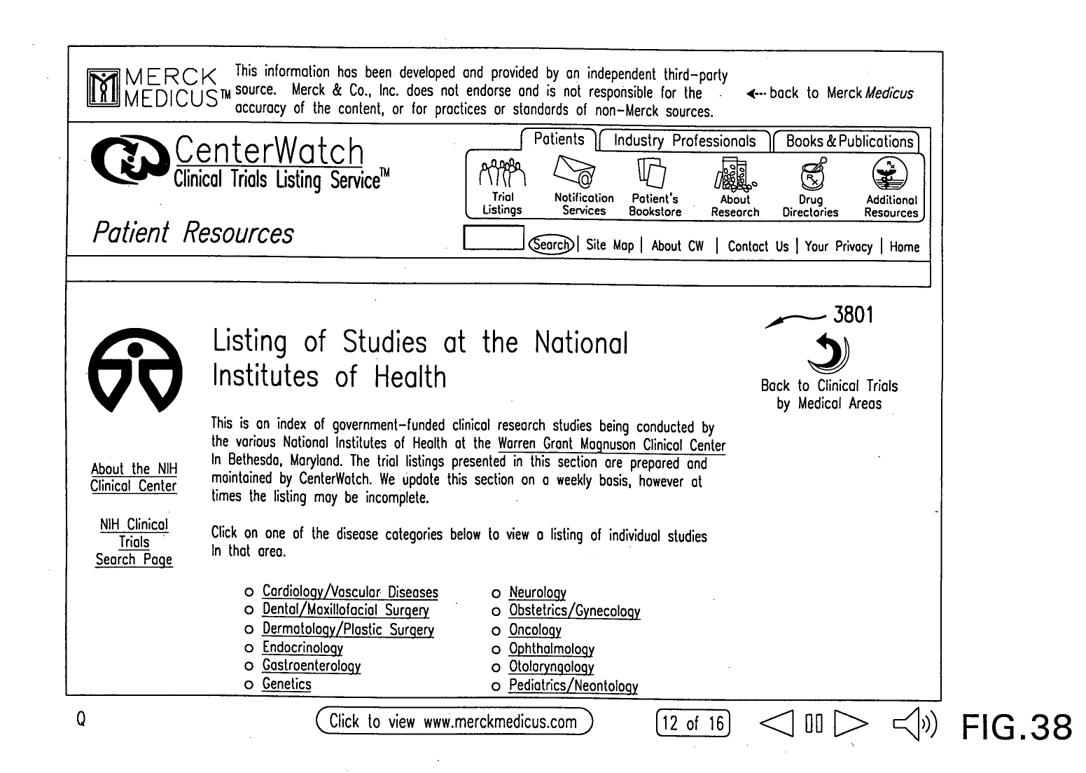

FIG. 38 is an exemplary user interface for clinical trial information, for use in connection with the patient tools. In this example, the reference, the Center Watch, is a clinical trials listing service provided a third party provider. The resource is presented in this example in a pop-up screen 3801.

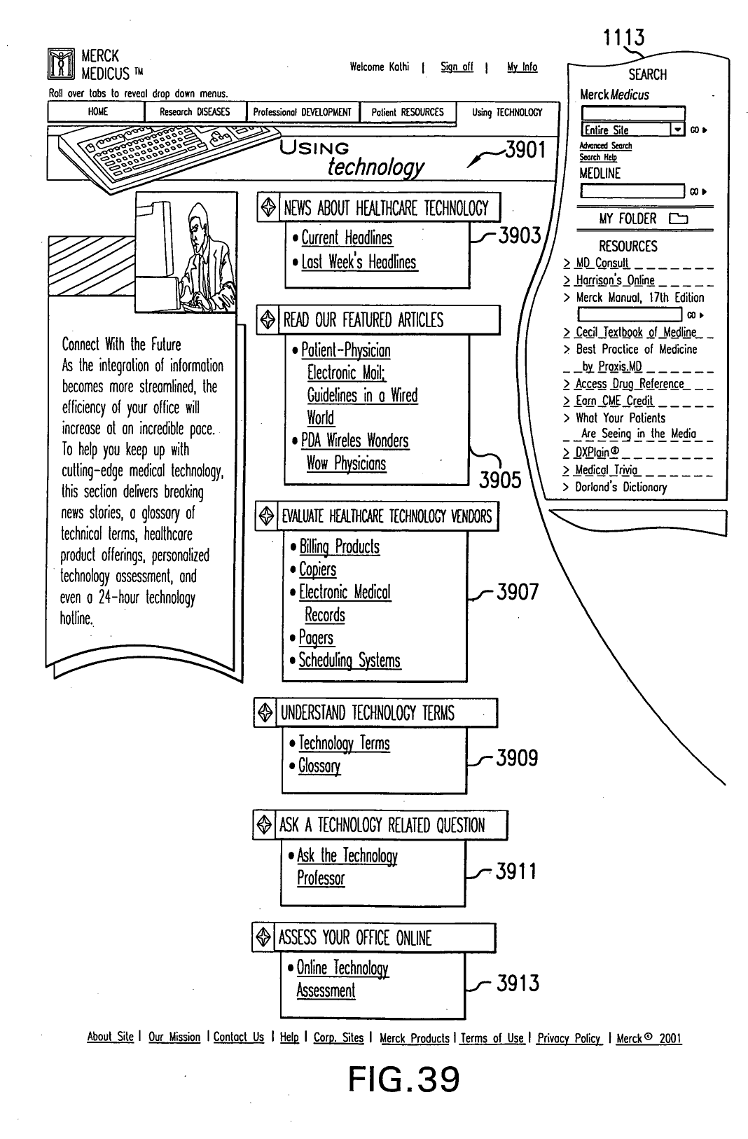

FIG. 39 is an exemplary user interface for healthcare technology tools, for use in one or more embodiments of the medical information portal of the present invention. The healthcare technology tools 3901 may include a variety of sets of resources. The healthcare technology resources themselves may be presented to the user individually and/or may be further logically grouped. In the illustrated example, the healthcare technology tools 3901 include one or more resources for news about healthcare technology 3903; featured technology articles 3905; evaluations of healthcare technology vendors 3907; a glossary/dictionary of technology terms 3909; a service for answering technology related questions 3911; and/or an online technology assessment of the user's office. In the present example, the toolbar 1113 remains on the user interface.

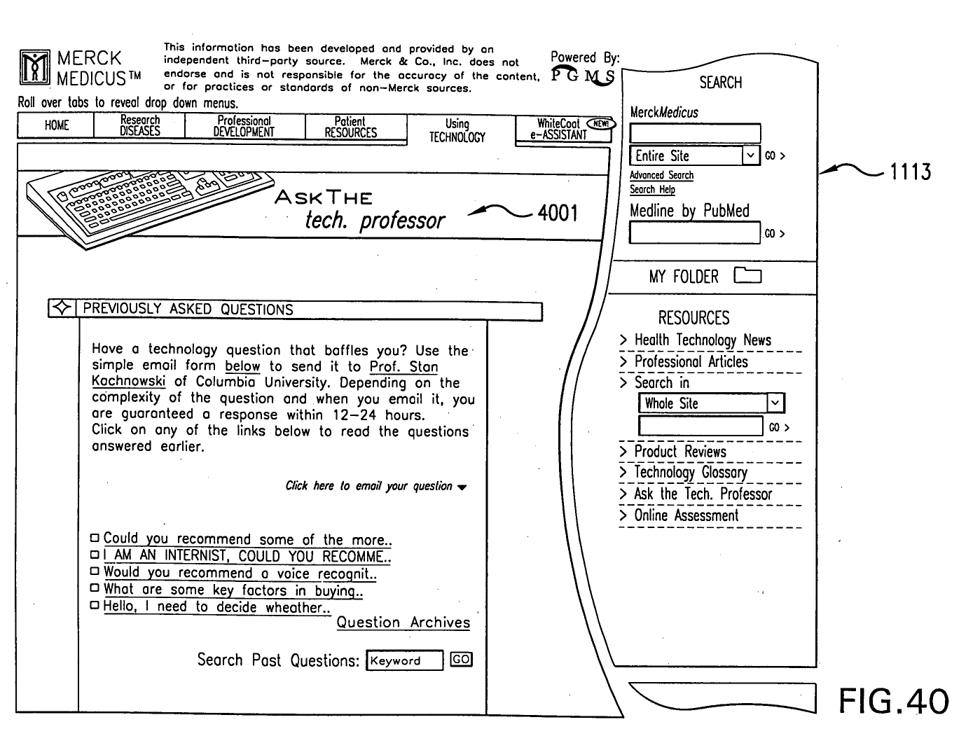

Reference is now made to FIG. 40, illustrating an exemplary user interface for a healthcare technology query service, for use in connection with the technology tools. In this example, the technology query service, e.g., “Ask the Tech Professor”, may be provided by a third party provider. The resource is presented in this example in a pop-up screen 3201; also in this example, the toolbar 1113 remains on the site.

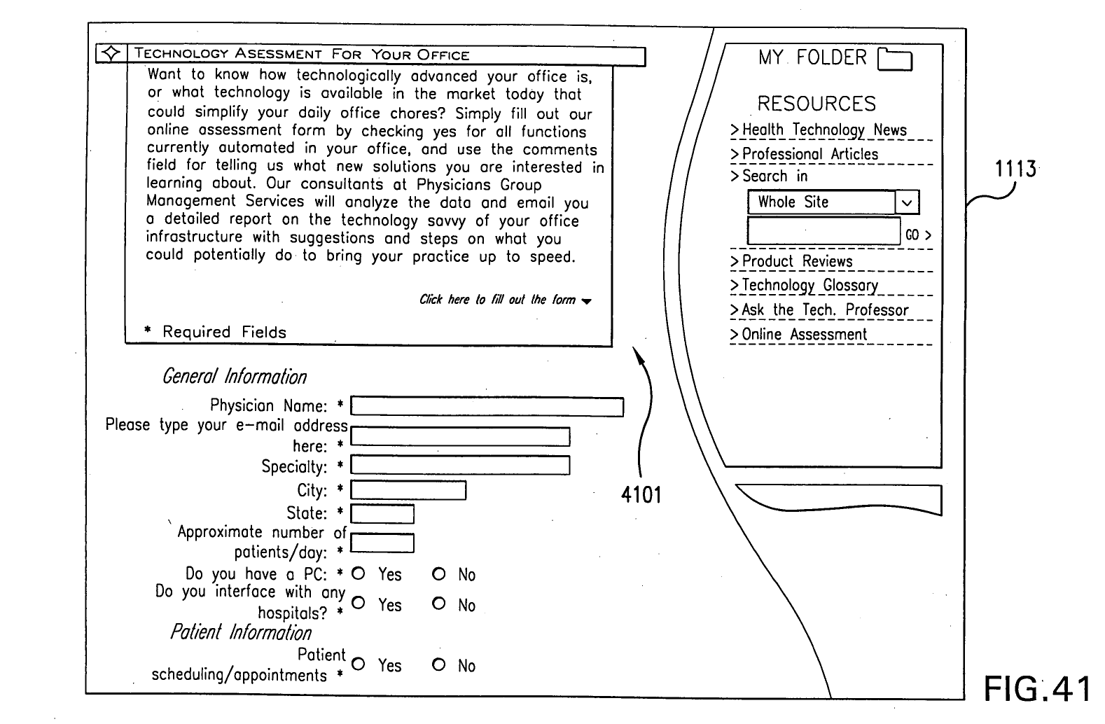

Reference is now made to FIG. 41, illustrating an exemplary user interface for a healthcare technology assessment service, for use in connection with the technology tools. In this example, the user is queried to obtain appropriate information characterizing the technology in the user's office. This resource may be provided by a third party provider. The resource in this example interacts with the user via a pop-up screen 4101. This example illustrates a portion of the toolbar 1113.

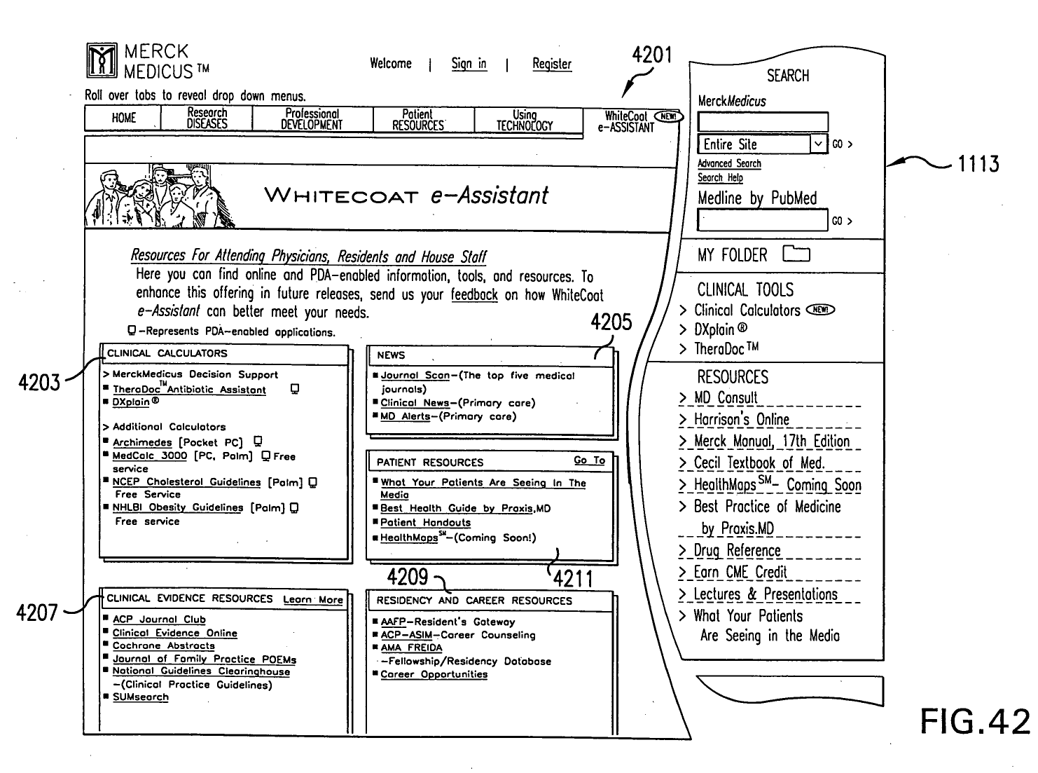

Reference is made FIG. 42, illustrating one example of a user interface for electronic assistant tools, for use in connection with one or more embodiments of the medical information portal. The electronic assistant tools 4201 may include a variety of sets of resources. The electronic assistant resources themselves may be presented to the user individually and/or may be further logically grouped. In the illustrated example, the electronic assistant tools 4201 include a one or more clinical calculators 4203; a selection of news 4205; a collection of clinical evidence resources 4207; a collection of residency and career resources 4209; and/or a collection of patient resources. In the present example, the toolbar 1113 remains on the user interface.

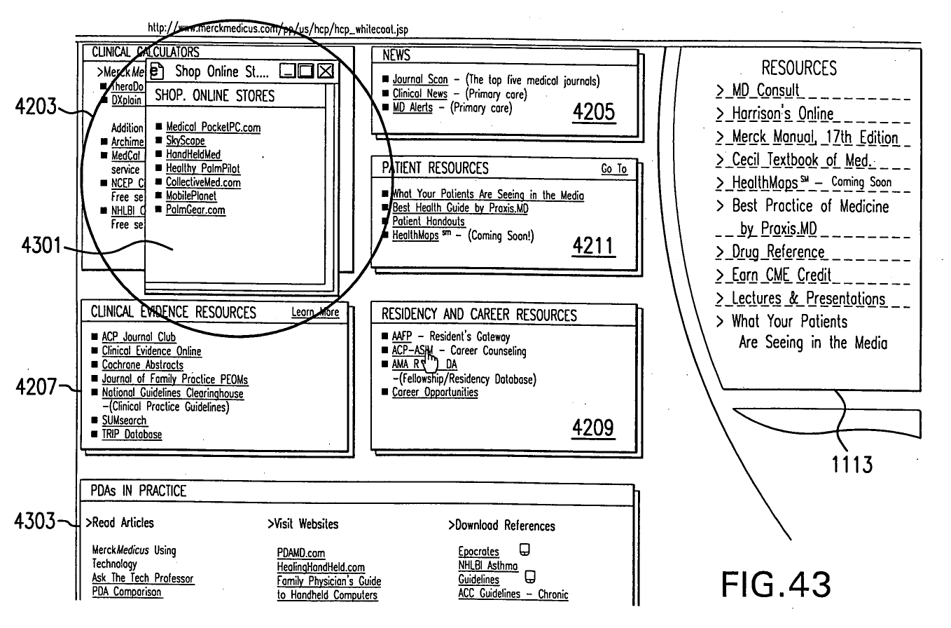

FIG. 43 is an exemplary user interface for access to online shopping for medical technology, for use in connection with the electronic assistant tools. Optionally, the invention may include a menu 4301 providing the ability to shop a selection of online stores for healthcare technology. This example also illustrates another medical technology resource, concerning PDAs used in medical practice 4303.

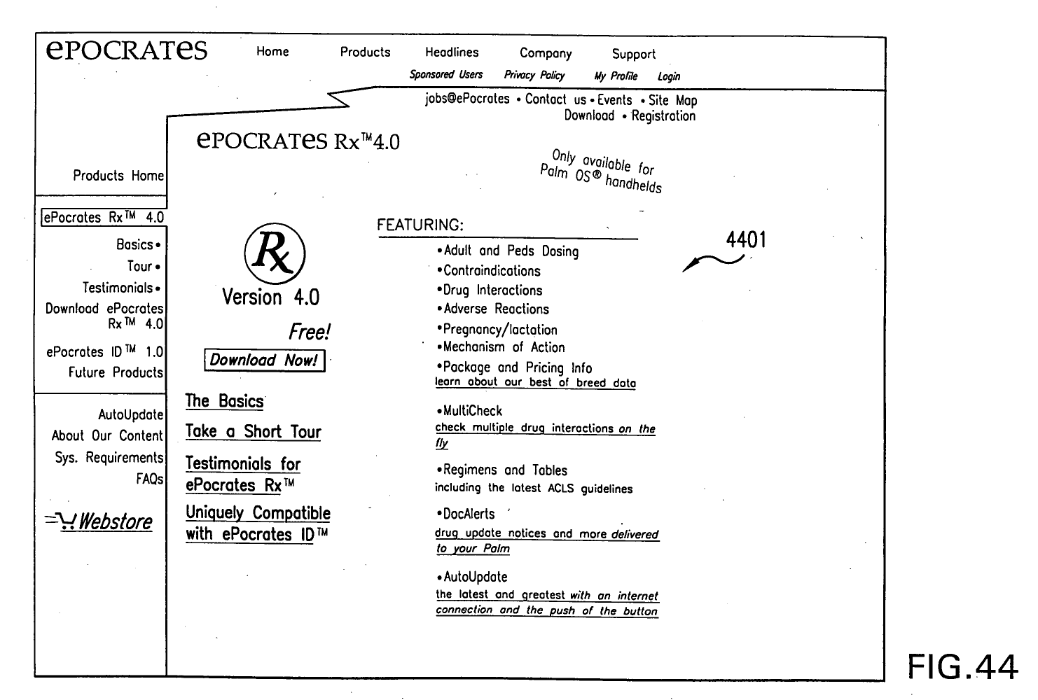

FIG. 44 is an exemplary user interface for access to an online and/or PDA-enabled resource, for use in connection with the electronic assistant tools. In this example, the reference, the ePocrates Rx™, is a program exclusively for handheld PDAs. Such reference may be proprietary or it may be provided by a third party provider. The resource is presented in this example in a pop-up screen 4401.

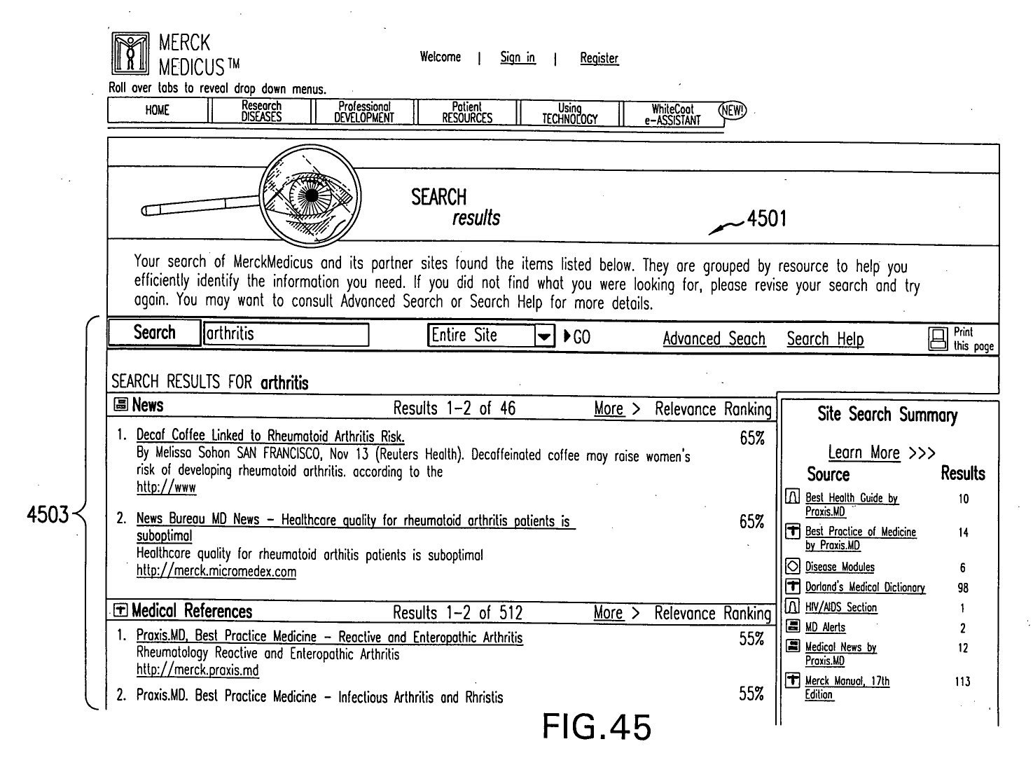

Reference is now made to FIG. 45, illustrating an example user interface 4501 for illustrative search results for a predetermined site search for use in connection with, e.g., the toolbar, of one or more embodiments of the present invention. In this example, the search searched both the system's site and any sites of third party providers specified by the user. A predetermined search term may be selected by the user, or the user may input their selected search term. The resource is presented in this example in a pop-up screen 4501. The display presents the search results 4503. In the present example, the search results 4503 are grouped by resource type, to assist the user in efficiently identifying the information they need.

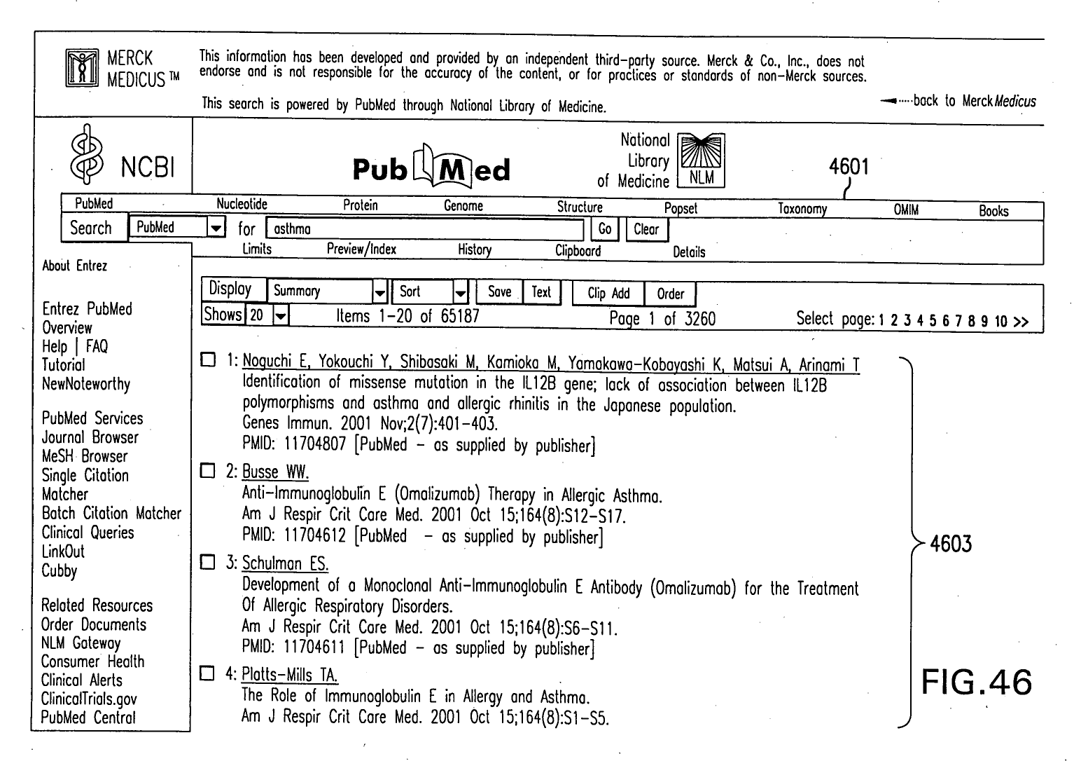

FIG. 46 is an exemplary user interface for illustrative search results for another user-defined search for use in connection with, e.g., a toolbar, of one or more embodiments of the present invention. In this example, the search is of a standard reference, e.g., PubMed provided by the National Library of Medicine, and may be provided a third party provider. The resource is presented in this example in a pop-up screen 4601. The search results 4603 are presented as provided by the search engine.

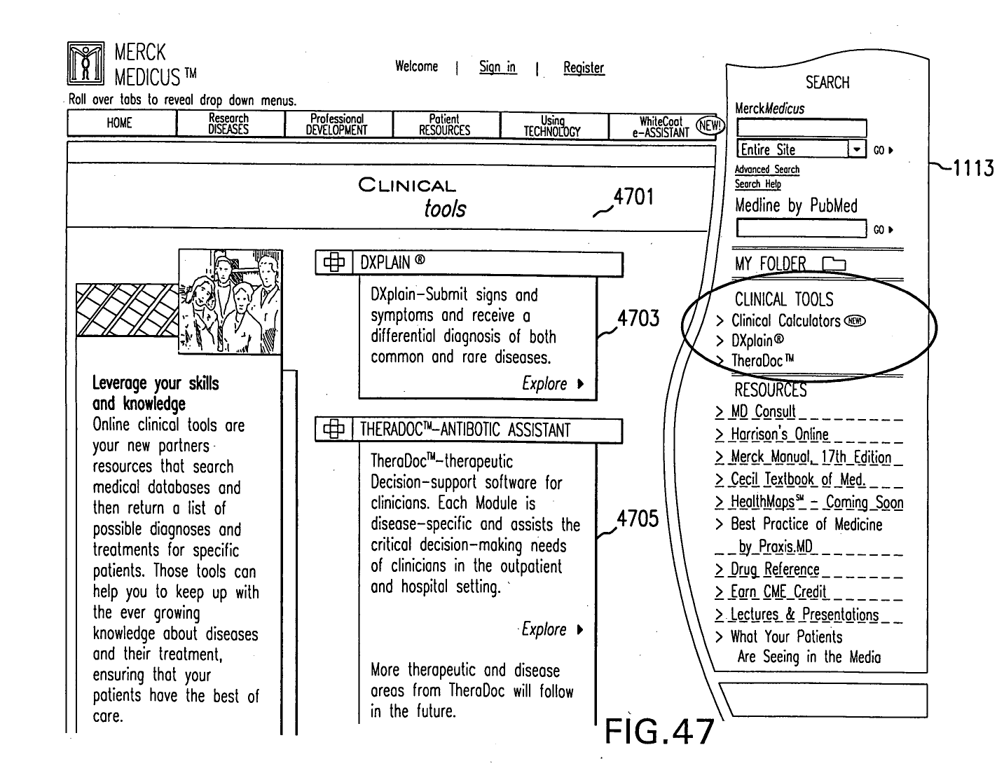

Reference is made to FIG. 47, providing an exemplary user interface for clinical tools, for use in connection with, e.g., the toolbar for the medical information portal. In this example, the clinical tools provides additional resources, e.g., a resource service to which signs and symptoms may be submitted to receive a differential diagnosis 4703; and a therapeutic decision support software for clinicians 4705. The resource is presented in this example in a pop-up screen 3801. In the present example, the toolbar 1113 is included in the user interface.

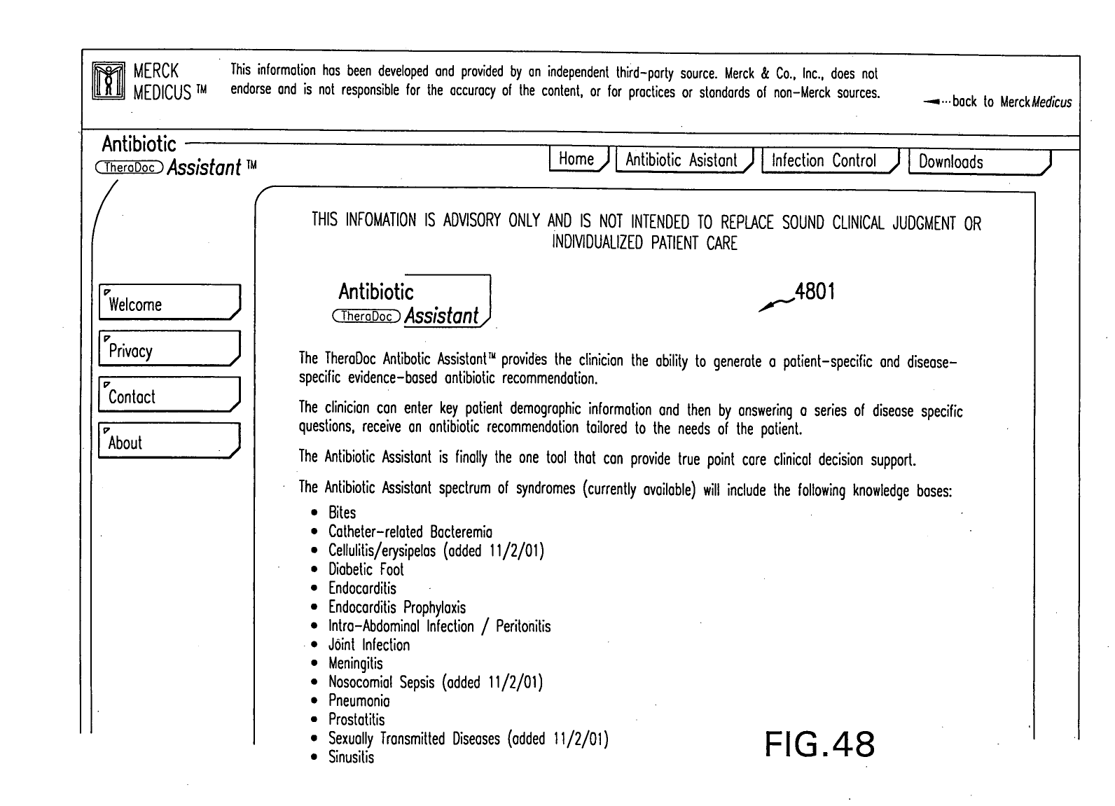

Reference is now made to FIG. 48, an exemplary user interface for a decision support software clinical tool, for use in connection with the clinical tools. In this example, the reference, Antibiotic Assistant, is an example of an interactive program for obtaining relevant information about a patient, and providing an antibiotic recommendation tailored to the needs of the patient. It may be provided a third party provider. The resource is presented in this example in a pop-up screen 4801.

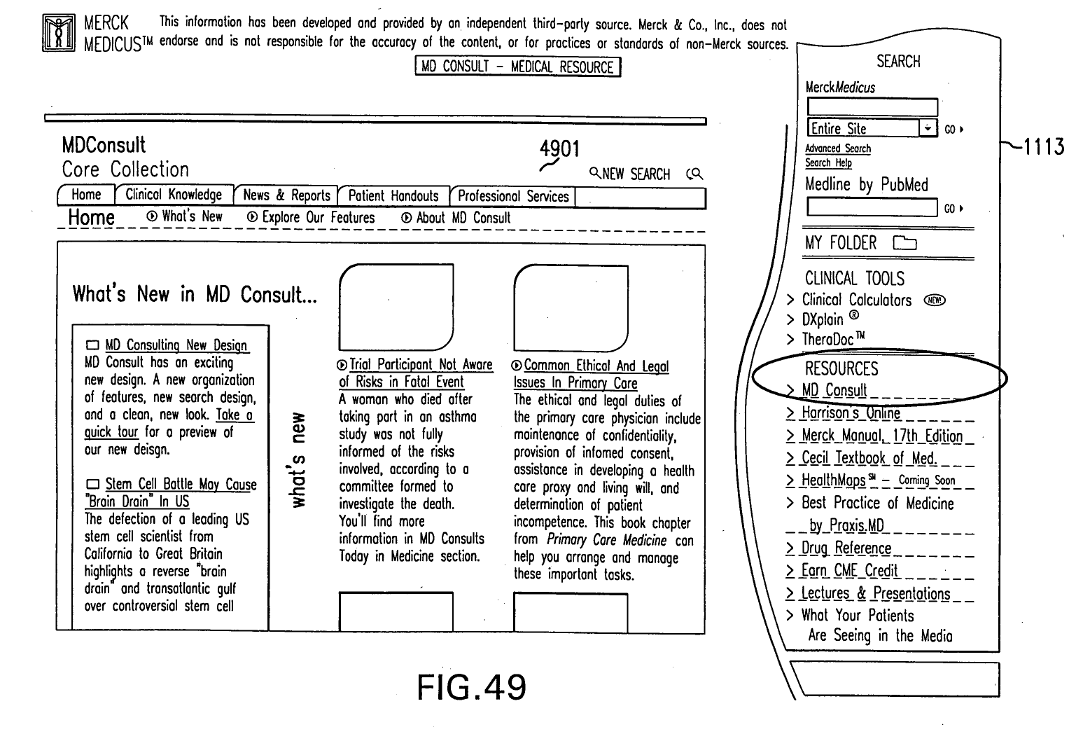

FIG. 49 is an exemplary user interface for an electronic consult service, for use in connection with the clinical tools of FIG. 47. In this example, the resource, MD Consult, provides an electronic “consult” for the physician, and is provided by a third party provider. The resource is presented in this example in a pop-up screen 4901. Also in this example, the toolbar 1113 remains displayed.

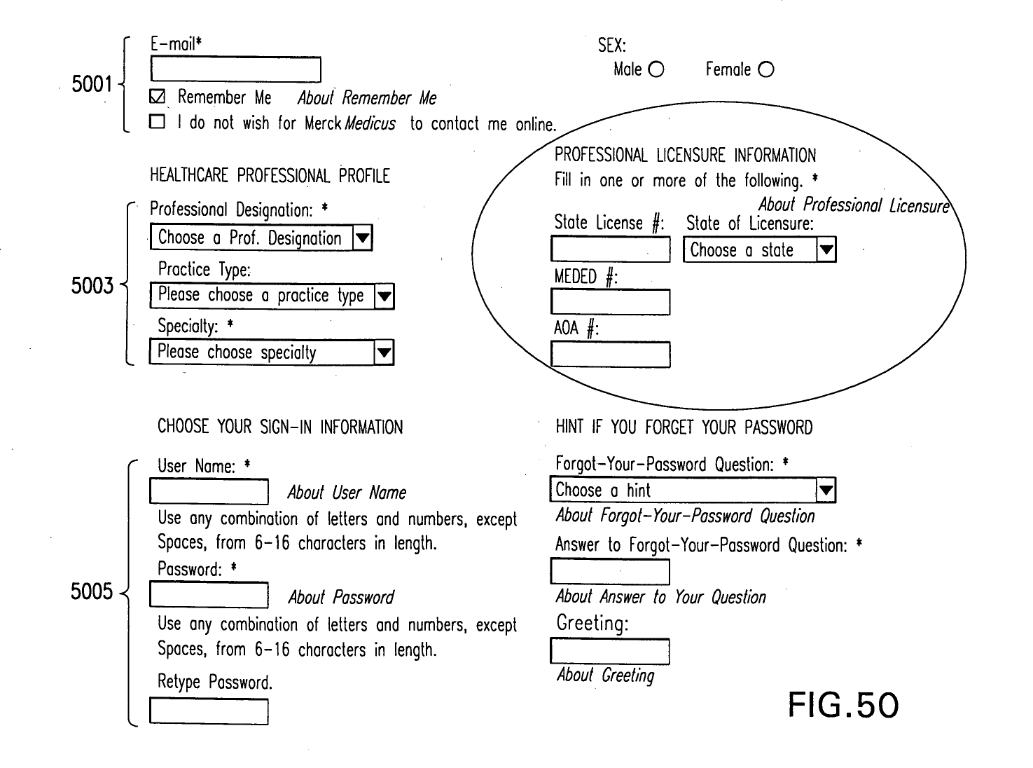

Reference is now made to FIG. 50, illustrating an exemplary user interface for use in connection with collecting user registration and/or personal preference information, for use in connection with an optional registration according to one or more embodiments of the present invention. In this example, the registration process collects various contact information 5001; professional information 5003 for the user, e.g., professional designation, practice type, specialty, and licensure jurisdiction and license number; and establishes sign-in information 5005, e.g., user name, password, hint, and/or greeting. The professional information, or a portion thereof, may be used as the user's personal preferences.

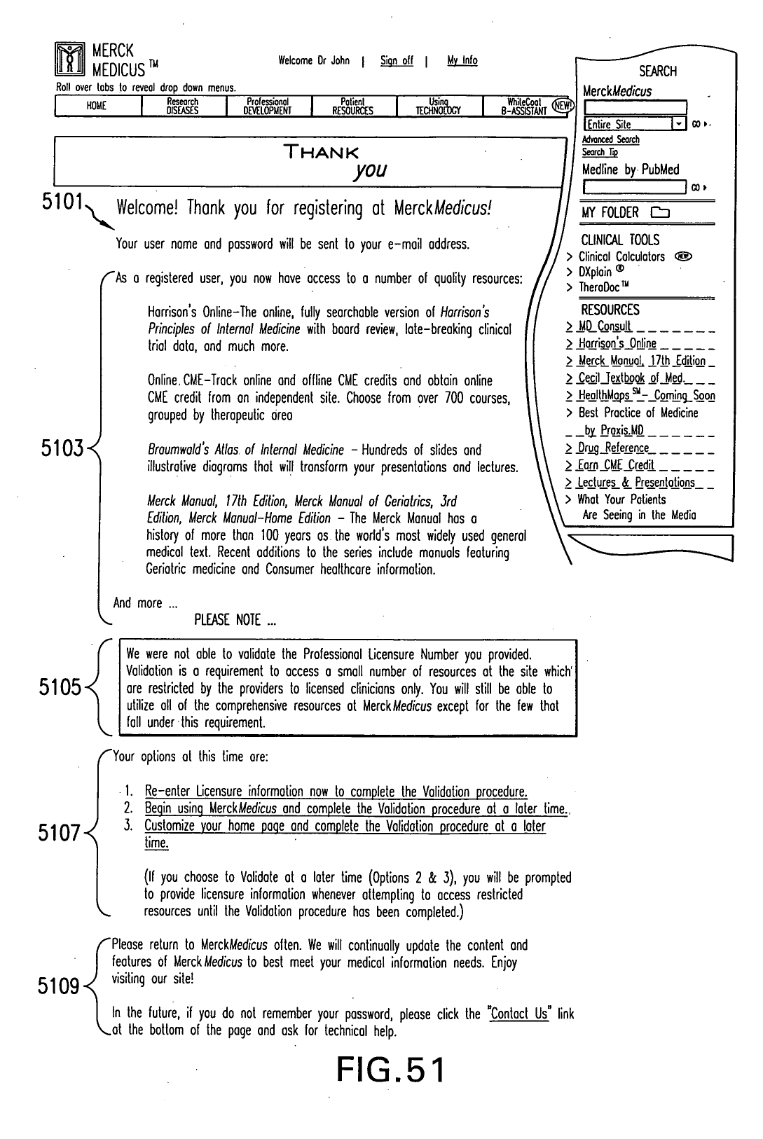

Reference is made to FIG. 51, illustrating an exemplary user interface 5101 for use in connection with completing the user registration of FIG. 50. Various user interfaces with a variety of appropriate messages may be provided, to convey successful registration and/or validation to the user. Here, the user interface indicates that the user successfully registered 5103, that the user failed validation 5105, options for re-trying validation 5107, and/or any other messages from the system to the user 5109.

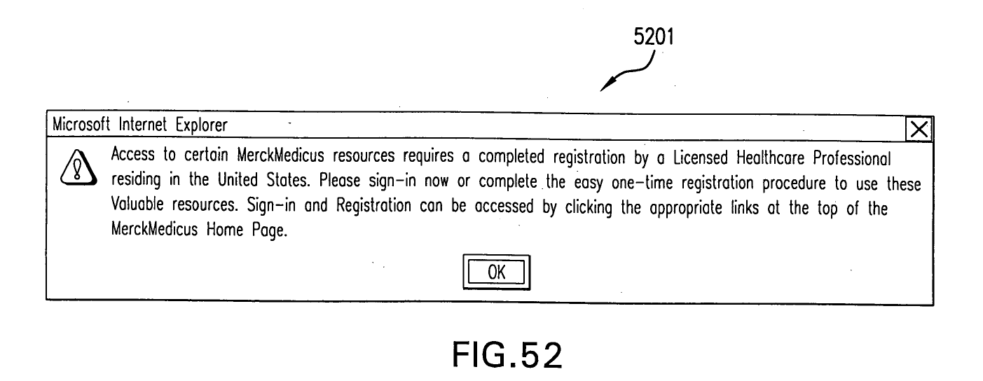

FIG. 52 illustrates one example of a user interface for use in connection with unregistered users, according to one or more embodiments of the medical information portal of the present invention. This user interface includes a message 5201 regarding registration and restriction, which may be required for particular resources. As illustrated, some resources may be restricted, for example by license requirements from the third party provider. The restrictions may reflect the third party provider requirements, and the system may be flexible to accommodate various types of restrictions, e.g., residency and/or licensure requirements.

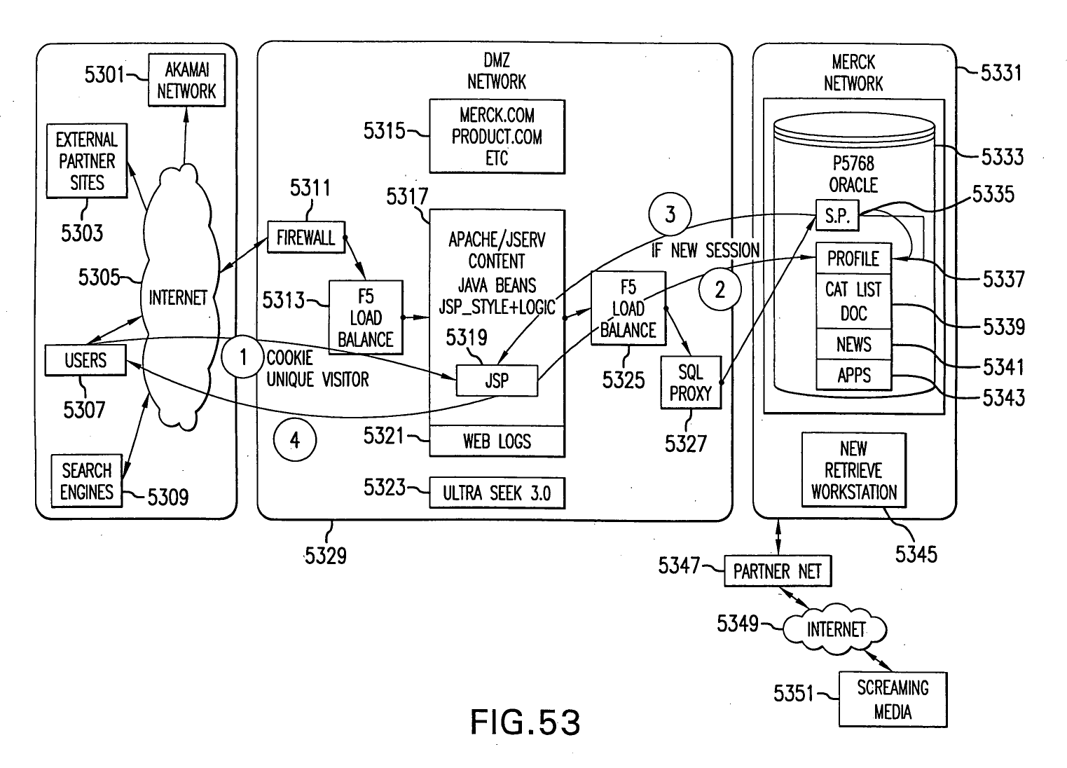

FIG. 53 is an exemplary block diagram of a network architecture for use in connection with one or more embodiments of the medical information portal of the present invention. This example illustrates one embodiment for providing news, such as from external partner sites 5303 and an Akamai network 5301, via the internet 5305, to users 5307, and providing optional search engines 5309. The computer system according to the illustrated example embodiment of the invention includes a DMZ network 5329, one or more .com healthcare internet pages 5315, a server 5317, a News JSP 5319, a search engine 5323, optional web logs 5321, an optional firewall 5311, optional load balance 5313, 5325, and/or optional SQL proxy. A distributed database is provided via a network 5331, including an oracle database 5333, another optional SQL Proxy 5335, a user profile 5337, a catalog listing of doctors 5337, news database 5341, and/or applications database 5343.

Here, the user 5307 has accessed the home page of the site according to the present invention. The News JSP 5319 communicates with the Java Beans on the server 5317, which in turn obtain the user's customized preferences from the user's profile 5337. If customizations exist, an appropriate header, e.g., “News Links” and associated “See More” links are displayed, otherwise, the defaults “News Links” and associated “See More” links are displayed. When the user 5307 clicks on the “News Links”, the JSP 5319 retrieves the appropriate news from the news database 5341. When the user clicks on the “See More” link, the JSP 5319 communicates with the Java Bean, which uses URL parameters to retrieve the “News Links” from the database.

According to one or more embodiments, the example architecture obtains news by a News Retrieval Workstation 5345 contacting a partner network 5347 to poll a screaming media 5351 server over the Internet 5349 for the latest news articles. The news articles are downloaded, such as via the partner network 5347 to the News Retrieval Workstation 5345, where they are loaded into the news database 5341.

In connection with a user making a request, the user's profile is checked. In the example architecture of FIG. 53, the user 5307 makes a request. If this is a new session and the user's station does not include a remember_me cookie identifying the user, a default profile is loaded in, otherwise, the remember_me cookie is utilized to load user customizations. The JSP applications read/store the user information from the profile 5337.

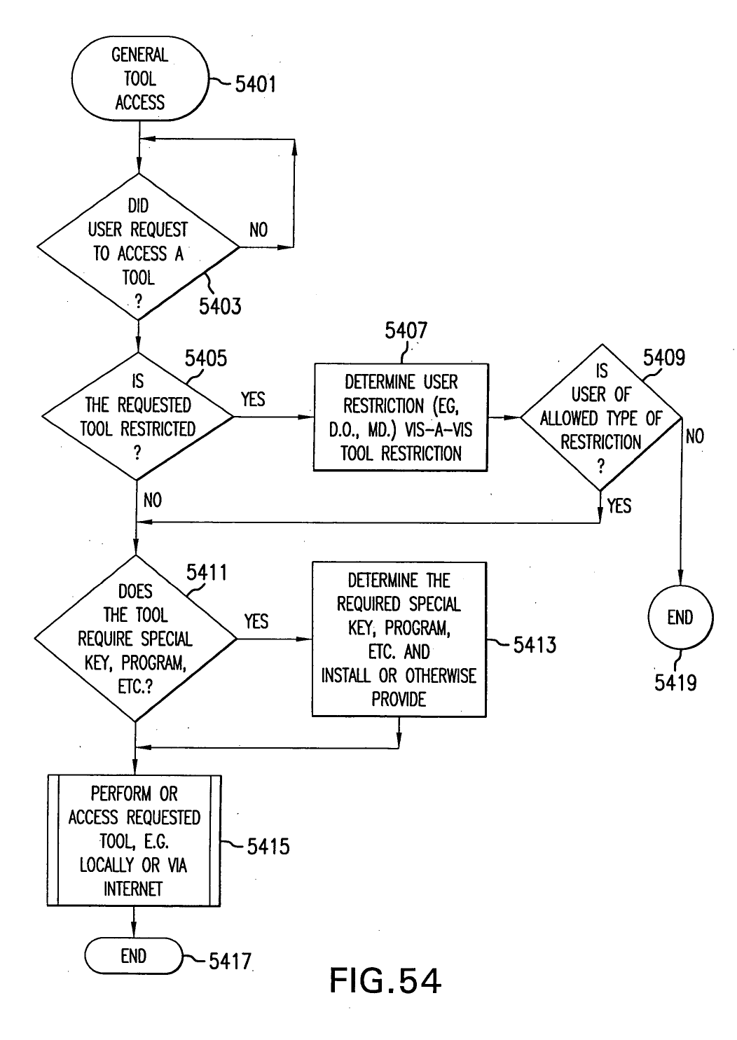

FIG. 54 is a flow chart illustrating an example flow of control generally for tool access, according to one or more embodiments of the medical information portal of the present invention. General tool access 5401 loops until it determines that the user requested to access a tool, block 5403. Then, the system determines whether the requested tool is restricted, block 5405. If so, it determines the type of user restriction, for example, the resource might be restricted to users that are physicians (M.D., D.O.) block 5407. If the user is not of the type allowed access to the selected resource, block 5409, the access ends, block 5419. On the other hand, if the user should be allowed access, the system determines whether the requested tool requires a special key, identifier, an installed program, or other additional resource in order to execute, block 5411. If so, at block 5413, the system automatically determines the required special key, program, etc., and installs or otherwise provides the necessary additional resource. Then, at block 5415, the system performs or accesses the requested tool or resource, for example locally or via the Internet. At block 5417, the general tool access then ends.

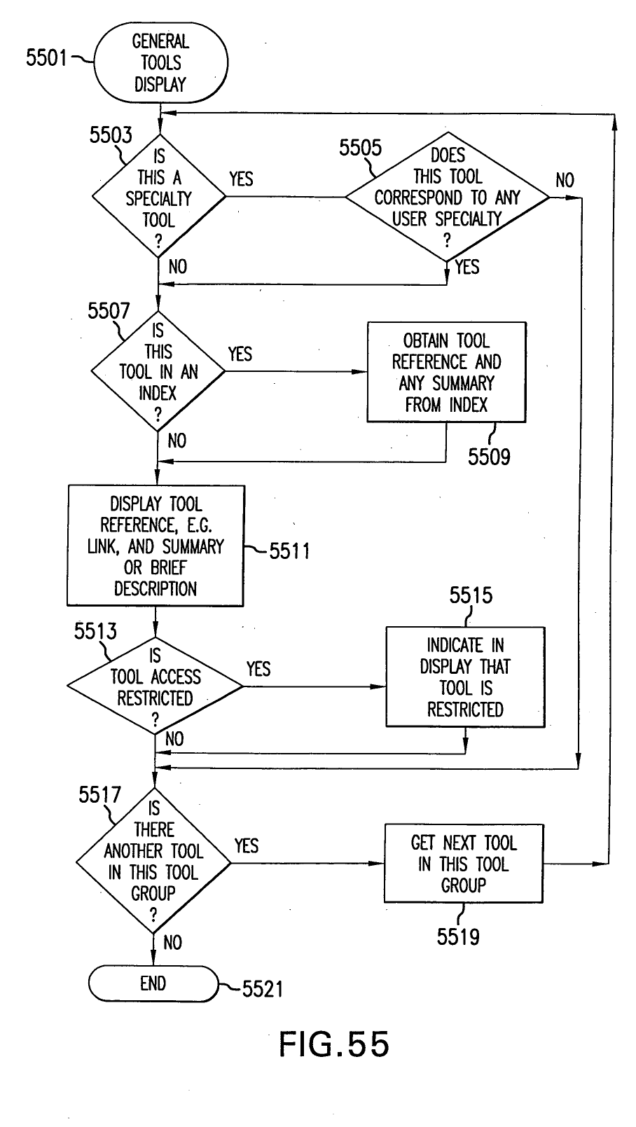

Reference is now made to FIG. 55, showing an example flow chart generally for tools display 5501, according to one or more embodiments of the medical information portal of the present invention. Once a set of tools needs to display its components, at block 5503 the system determines whether the current tool is a specialty tool. If so, then the system determines whether the tool has a specialty and if it corresponds to any user specialty, such as by checking the user profile, at block 5505. If the tool is a specialty tool but does not correspond to any user specialty, then the tool is not displayed and the system proceeds to check whether there is another tool in the set of tools, block 5517, get the next tool in the tool set, block 5519, and loop back to the top. On the other hand, if the tool is to be displayed, the system checks whether the tool is referred to by a system index, block 5507. If so, at block 5509, the system obtains the tool reference (e.g., link) and any summary or abstract for the tool which may be contained or accessible via the index. At block 5511, the system displays the tool reference, such as a link, and any summary or abstract for the tool. At block 5513, the system checks whether access to the tool is restricted. If so, the system displays an indication to the user that access to the tool is restricted, block 5515. Then, the system determines whether there is another tool in the current tool group, block 5517, and if so, gets the next tool in the tool group, block 5519, and loops back to the top. Otherwise, the general tools display ends, block 5521.

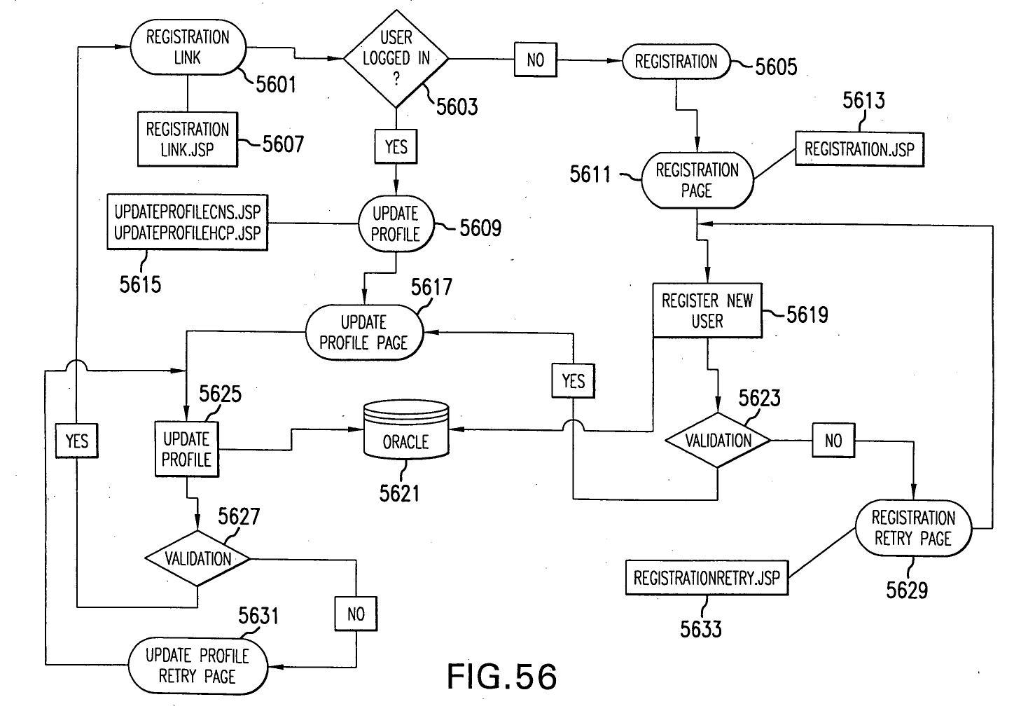

FIG. 56 is a flow chart illustrating an example flow of control for user registration, according to one or more embodiments of the medical information portal of the present invention. When a user selects a registration link 5601, the registration link JSP 5607 is initiated. The system checks whether the user is logged in 5603. If not, the system proceeds to registration 5605, displays a registration page 5611, and initiates a registration JSP 5613. If the user is not a new registered new user 5619, the system checks whether the user registration is validated 5623. If not, a registration retry page 5629 is displayed, and a registration retry JSP is initiated 5633. If the user is logged in, the system updates the user's profile 5609 and launches the update profile JSPs 5615. If the registered user is validated, or if the user is logged in already, the system displays the update profile page 5617. At block 5625, the system updates the profile and stores the information in a database 5621, e.g., an Oracle database. If the new user profile validates at block 5627, the user is returned to the registration link display 5601, otherwise, the update profile and retry page 5631 is displayed and the user may again attempt to update the profile 5625.

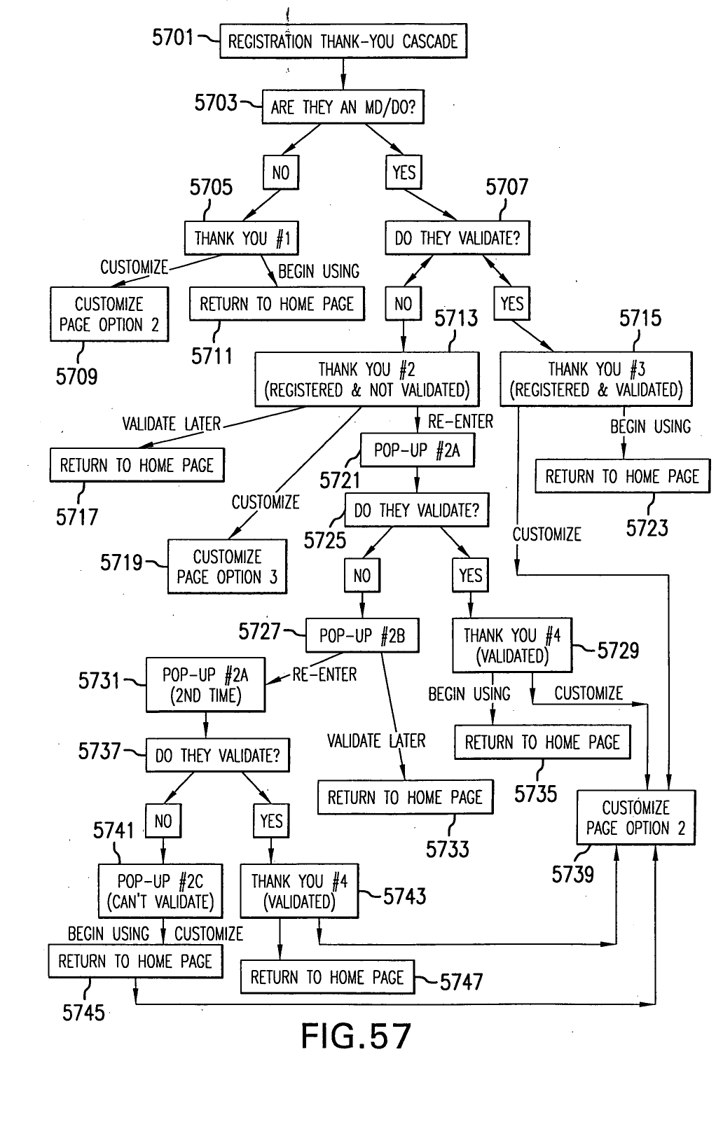

FIG. 57 is a flow chart illustrating an example flow cascade 5701 for validating a registered user, according to one or more embodiments of the medical information portal of the present invention. In order to register and validate, the system checks the user profile as to whether the user is an MD/DO, 5703. If not, at block 5705, the system displays an appropriate “Thank You” (#1), and the user may begin using and return to the home page, block 5711, or may further customize their profile, block 5709. If the user is an MD or a DO, the system checks whether the user validates 5707. If so, the system displays an appropriate “Thank You”, e.g., noting that the user is registered and validated, block 5715. The user may then begin using the system and return to the home page, block 5723; alternatively, the user may further customize their profile, block 5739. If the MD/DO user does not validate, then the system displays an appropriate “Thank You”, e.g., noting that the user is registered but not validated, block 5713. The user may validate later and return to the home page, block 5757, further customize their profile, block 5719, or re-enter the information and further attempt validation, block 5721. If the re-entered information validates the user, an appropriate “Thank You” is displayed block 5729, and the user may either begin using the system and return to the home page, block 5735, or further customize their profile, block 5739. If the re-entered information still does not validate the user after a second try, the user is informed, block 5727, and may validate later and return to the home page 5733, or re-enter and validate a third time, block 5731. If the user validates the third time, block 5737, an appropriate “Thank You” noting that the user is validated is displayed, block 5743, and the user may customize (block 5739) or return to the home page (5747). If the user fails to validate the third time, block 5741, the user is informed that the system cannot validate them, and the user may either begin using the system block 5745, or customize their profile 5739.

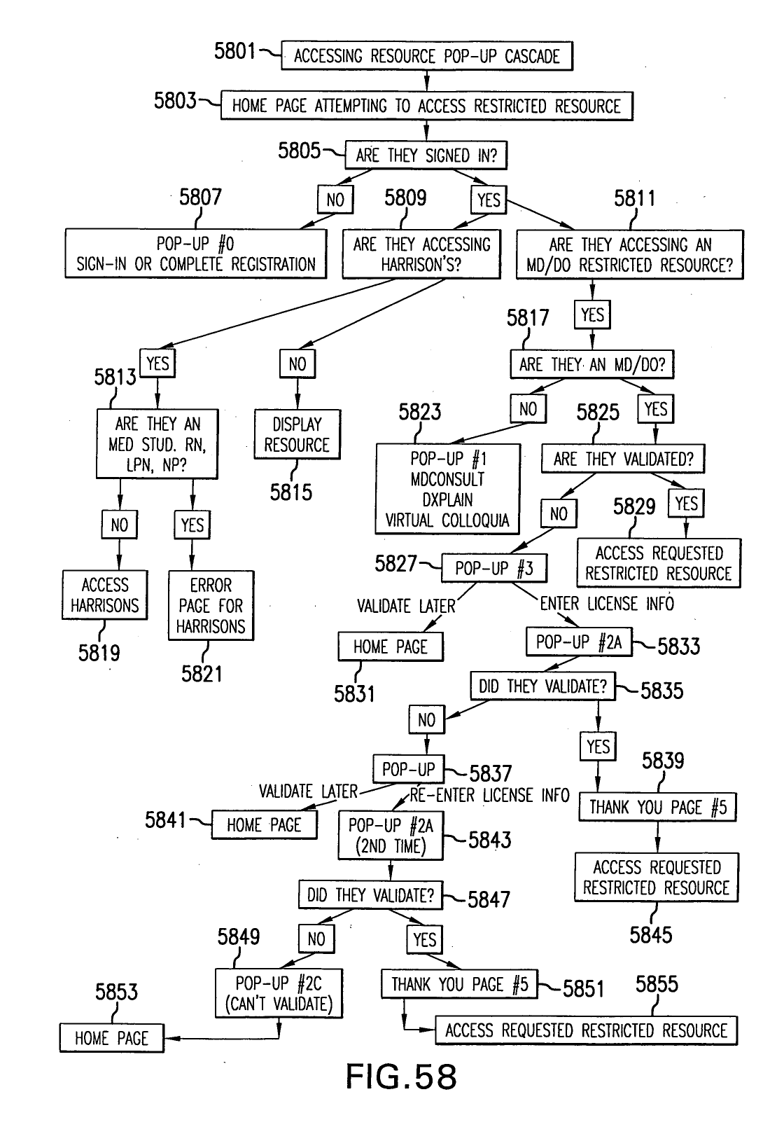

FIG. 58 is a flow chart illustrating an example flow cascade 5801 for a user attempting to access a restricted resource, according to one or more embodiments of the medical information portal of the present invention. At block 5803, if the user attempts to access a restricted resource, they system checks whether the user is signed in, block 5805. If not, the user is instructed to sign in or complete registration. If they are signed in, the system checks whether the user is accessing a resource at a first restriction level, e.g., Harrison's, block 5809. If so, the system checks whether the user's information meets the requirements of the first restriction level, e.g., medical student, RN, LPN, Nurse Practitioner, block 5813. If they do meet the restriction, they are provided access to the resource, block 5819, otherwise, an error page is displayed 5821.

The system checks whether the user is accessing a resource at a second restriction level, e.g., physician level resources, block 5811. If the user is not a physician (MD or DO), block 5817, then the unrestricted resources are listed 5823. If the user is a physician, the system checks whether they are validated, block 5825. If the user is not a physician, block 5817, then an appropriate message is displayed block 5823. If the user attempting to access a physician restricted resource is not validated, the system provides an appropriate display 5827, and the user may either validate later and return to the home page 5831, or enter licensure information, block 5833.

According to the illustrated embodiment, up to two attempts are made to enter (or re-enter), blocks 5833, 5843 and validate 5835, 5847 the licensure information. If the user does not validate, an appropriate message is displayed 5849 and the user is returned to the home page 5853. If the user validates, an appropriate “Thank You” display 5839, 5851 is displayed, and access is provided to the requested restricted resource 5845, 5855. If the user is not accessing, e.g., Harrisons nor a physician restricted resource, the resource is displayed, block 5815.

It should be understood that the invention is described in connection with logical groupings of functions or resources. One or more of these logical groupings may be omitted from one or more embodiments, and still remain within the scope of the present invention. Likewise, functions may be grouped differently, combined, or augmented without parting from the scope of the invention. Similarly the present description may describe various databases or collections of data and information. One or more groupings of the data or information may be omitted, distributed, combined, or augmented, or provided locally and/or remotely without departing from the scope of the invention.

The user may be a physician or other healthcare professional or student of in the medical field. Some of these users may be licensed for a specific practice, and the licensure may be verifiable. The system may provide the user with expanded online access to high quality healthcare resources. The system may respond to the shifting needs of healthcare professionals, who are constrained to find practical ways to access information and services relevant to their practices, despite their business schedules and geographic constraints. Further, the present invention is intended to provide seamless access to such information.

As mentioned above, for example, with reference to FIG. 53, at least some embodiments of the present invention include a search engine or search technique feature. For example, the computer system of FIG. 53, according to some embodiments of the invention, includes a search engine 5323 capable of searching the portal and/or website of the present invention and/or other linked resources, including, for example other websites and the like.

As known to those of ordinary skill in the art, search engines include processes or programs that search documents or data records for specified keywords, terms, phrases, and/or other items, after which they return a list of the data records or documents (including e.g., hypertext links to the records) where the keywords were found. Specific examples of commercial search engines include those systems provided by Google, Alta Vista, and Excite that enable users to search for documents on the World Wide Web and USENET newsgroups. Similarly, search engines and similar search techniques may be implemented to conduct searches within a single website, portal or distributed network comprised of a number of linked sites and resources. An example of a specific commercial search engine implementable with the present invention includes, for example, those search tools provided by Intomi of Foster City, Calif. or Verity of Sunnyvale, Calif. (e.g., the Ultraseek family of applications).

Typically, a search engine operates by dispatching or sending out a spider (i.e., a computer program) to fetch as many data records or documents as possible. Another program, called an indexer, then reads these documents and creates an index based on the words contained in each document. Each search engine uses an indexing algorithm to create its indices such that, ideally, only meaningful or relevant results are returned for each query.

In typical cases, a search is initiated by entering or transmitting a key word or item to be located (i.e., to be located within a particular data record, set of data records, resource or set of resources) to the search engine. In at least some examples of the present invention, the item or key word to be located may be typed directly into a user interface by a user (e.g., a physician or other healthcare professional). For instance, referring to the examples of FIGS. 45 and 46, a search item may be typed into the toolbar of interface 4501 or 4601, with the search results displayed below (4503 or 4603).

In accordance with the concepts of the present invention, instead of having to type or key a search item into an interface, in at least some embodiments, a search may be automatically conducted by executing a search query event that identifies an item displayed on a user interface. Specifically, the search query event may be used to identify, for searching, any items displayed or listed on a screen, display, interface, or the like. Advantageously, by requiring only this search query event to be executed by a user, instead of requiring items to be typed or keyed into an interface, the present invention requires fewer interactions or keystrokes to execute a search.

In one example, the search event may include clicking a mouse button (e.g., either a single, double or any other number of clicks on any mouse button) with a cursor positioned over an item to be searched. Nevertheless, various other events or actions may be used to initiate a search. For example, a user may speak a voice command, a keyboard key may be depressed, a button on a television remote control device may be activated, or selection using any pointing device or touch screen device may be utilized. Once the search query event is recognized, a search may be conducted to identify any data records relevant to the item identified by the search query event.

In one example, the search technique may be implemented using any suitable programming language such as, for instance, javascript and the like. For example, a first javascript may be implemented to monitor for search events, and a second javascript may be implemented to redirect control for displaying results. In these embodiments, these javascripts may be placed universally throughout for example a web site and the like.

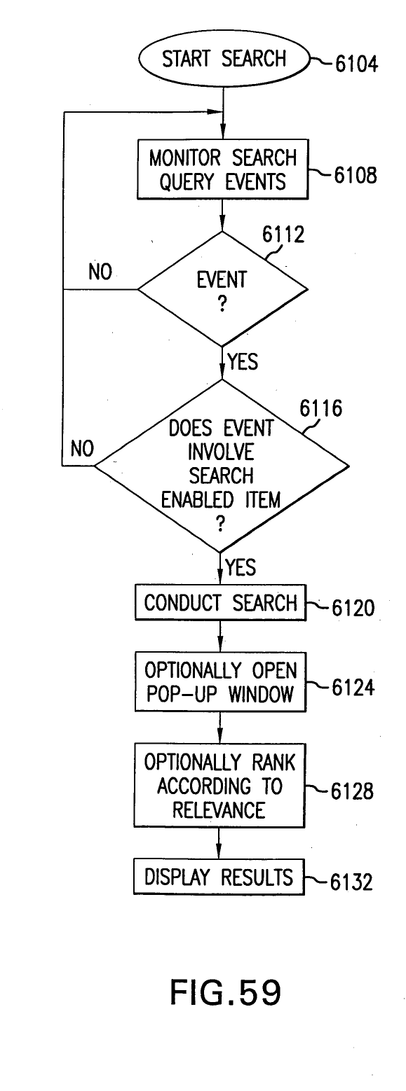

Referring to FIG. 59, one example of a process utilizable for implementing an embodiment of the search technique of the present invention is depicted. Initially, the technique commences processing (STEP 6104) by monitoring for occurrences of a search query event (STEP 6108). For instance, the process may monitor a user interface and/or mouse button for button activations. Thus, the process optionally maintains a constant loop or continuous monitoring (STEP 6112) for the detection of a search query event.

If a search query event is detected, processing continues with a determination of whether the item identified is a search-enabled item or term (STEP 6116). In at least some embodiments of the present invention, searches may be performed on search-enabled items or terms listed on a page. Thus, in these embodiments, the page contents that are not search-enabled may not be searched. Using this feature, items that are not relevant to the main theme or topic of a particular portal or website may be filtered from being searched. As an example, on a medical or healthcare website, non-medical terms are optionally not search-enabled. In addition, common terms or words, such as “the,” “and,” “it,” “can,” and the like may also be filtered from the searches.

If the term is not a search-enabled term, the process continues waiting for a search query event (STEP 6108). If on the other hand the search query event identifies a search-enabled item (STEP 6116), a search is conducted to identify data records that are relevant to the identified item (STEP 6120). For example, any of the above-listed commercial search engines or searching techniques may be utilized to search for data records relevant to the identified item. In at least some embodiments, the search is limited to the instant website or portal. In other embodiments, the search may be expanded to include other resources or sites linked to a central site (including documents contained or stored therein). Similarly, the search may cover all of the data records of a World Wide Web search engine such as Google, Yahoo!, and the like.

For example, an exemplary medical resources site may allow searches to be conducted in the following:
1. News
   News
   MD Alerts (Micromedex)
      Journal Scan (Micromedex)
      Medical News by Micromedex
      Patient News by Micromedex
2. Medical
   Merck Manual, 17^{th} edition
   Cecil Textbook of Medicine
   Best Practice of Medicine—Professional Reference
   Dorlands Illustrated Medical Dictionary
   Mosby's GenRx
      Using Technology
      Harrison's Online
      Hurst's The Heart (alt tag: Cardiology Medical Textbook)
      Raj: Practical Management of Pain (alt tag: Pain Management Medical Textbook)
      Aminoff: Neurology and General Medicine (alt tag: Neurology Medical Textbook
      Braunwald's Atlas of Internal Medicine (alt tag: Disease Specific Slides)
      Meeting Reporter (alt tag: Medical Meetings)
      White: Diseases of the Skin (alt tag: Infectious Disease Medical Textbook)
      Schlossberg: Current Therapy of Infectious Disease (alt tag: Infectious Disease Medical Textbook)
      Medical Meeting Calendar (alt tag: Meeting Calendar)
      Ovid (alt tag: Full Text Journals and Textbooks) on blue header bar
      Ferri's Clinical Advisor (alt tag: Medical Textbook)—Requires sign in
      Refer to the Journals Req. for the set of journals included
         Chest
         Angiology
         Diabetes
         Journal of Bone and Joint Surgery
         Advances in Skin and Wound Care
         American Academy of Dermatology Pamphlets (alt tag: Full Text Journal Dermatology)
         Cutis (alt tag: Full Text Journal on Dermatology)
         Rehabilitation Oncology (alt tag: Full Text Journal on Oncology)
         Pediatrics (alt tag: Full Text Journal on Pediatrics)
         Clinical Pediatrics (alt tag: Full Text Journal on Pediatrics)
         Pediatric News (alt tag: Full Text Journal on Pediatrics)
         Journal of Hand Surgery (alt tag: Full Text Journal on Hand Surgery)
         Journal of Orthopaedic Surgery (alt tag: Full Text Journal on Orthopaedic Surgery)
         The American Surgeon (alt tag: Full Text Journal on Surgery)
         Vascular and Endovascular Surgery (alt tag: Full Text Journal on Vascular and Endovascular Surgery)
         Journal of Infectious Diseases (alt tag: Full Text Journal on Infectious Diseases)
         Annals of Emergency Medicine (alt tag: Full Text Journal on Emergency Medicine
3. Patient Resources
   The Merck Manual-Home Edition
   What Your Patients are Seeing in The Media
   Patient Handouts
   Best Practice of Medicine-Patient Guide
      DrPEN—Doctor's Patient Education Network
      Interactive Surgeries and Procedures Powered by A.D.A.M. Inc. (alt tag: Illustrated surgeries and procedures)
4. Merck Published Educational Material
   Disease Modules
   Slide Image Bank
5. Other
   Merck Science Education
   Merck & Co., Inc. Geriatric Site
   Merck Institute of Aging and Health
   Merck Product Sites
   MD Consult
   PubMed
   NLM Gateway
   PDR
   CE Medicus
      Healthstream
      IC Axon
   TheraDoc (Antibiotic Assistant)
   Dxplain
   National Treatment Guidelines
   Merck Manual, Geriatrics Edition
   Medical Meetings—TSNN
   Family Practice Board Review—RSI
   Investigator Profile
   CDC—Center for Disease Control
   Clinical Trial Information—CenterWatch
   NIH Studies—CenterWatch
   Alternative Medicine
   Using Technology section
   Links
      Professional Society links
      Medical School links
      Residency and Fellowship links
      Patient Support Groups
      Presentation Skills

Once the search has been completed, in at least some embodiments, the results may be ordered or listed in relevance order (STEP 6128). In particular, the most relevant results may be listed first, with less relevant results being displayed last. Once ordered according to relevance, the items are displayed (STEP 6132). In some embodiments, the results may be displayed on the original user interface or display screen. In other embodiments, the results may be displayed on a newly instantiated display or pop-up window.

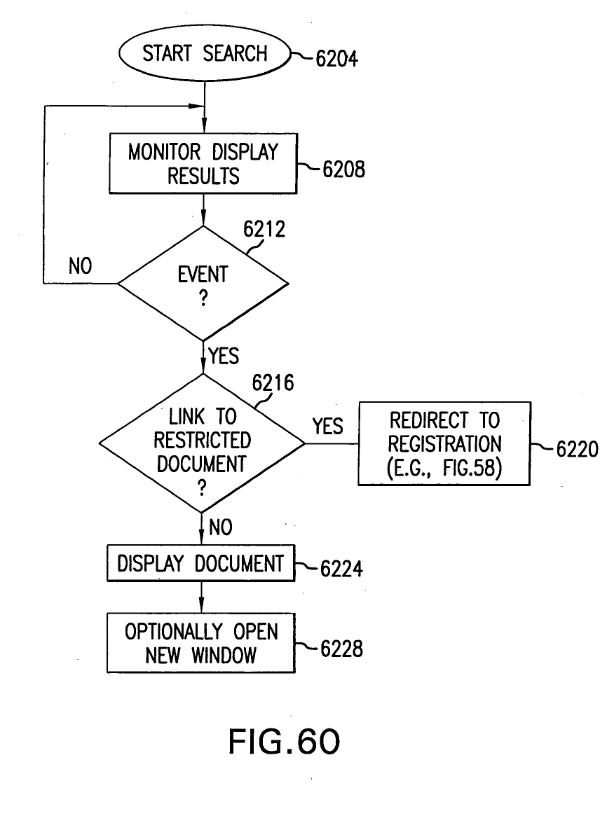

Referring now to FIG. 60, one example of a process utilizable for displaying or linking to a search result data record is depicted. Initially, as described above, the results of a search may be displayed in an interface or pop-up window. Thus, the linking process commences (STEP 6204) by monitoring this interface or window for instances of a request to link to a data record (STEP 6208). In at least some embodiments, the results may be listed as hyperlinks to relevant documents or other resources. In these cases, the link request may include clicking on the hyperlink within a user interface. Thus, the process continues active monitoring for these requests, in a continual loop or continuously, until a link request event is detected (STEP 6212). Once an event is detected (STEP 6212), the process next determines whether the hyperlink links to a document or resource that has restricted access (STEP 6216). For example, documents with restricted access may include those that require a subscription fee and the like.

If the document has restricted access (STEP 6216), instead of displaying the result, the process executes a log-on screen, password procedure, or the like (STEP 6220). Similarly, the process may execute a registration process, such as the one described with reference to FIG. 58 (STEP 6220).

On the other hand, if the data record is not restricted in terms of access (STEP 6216), it may be displayed (STEP 6224). In some embodiments, the data record may be displayed in the original user interface or display screen. In other embodiments, the results may be displayed in a newly instantiated display or pop-up window (STEP 6228).

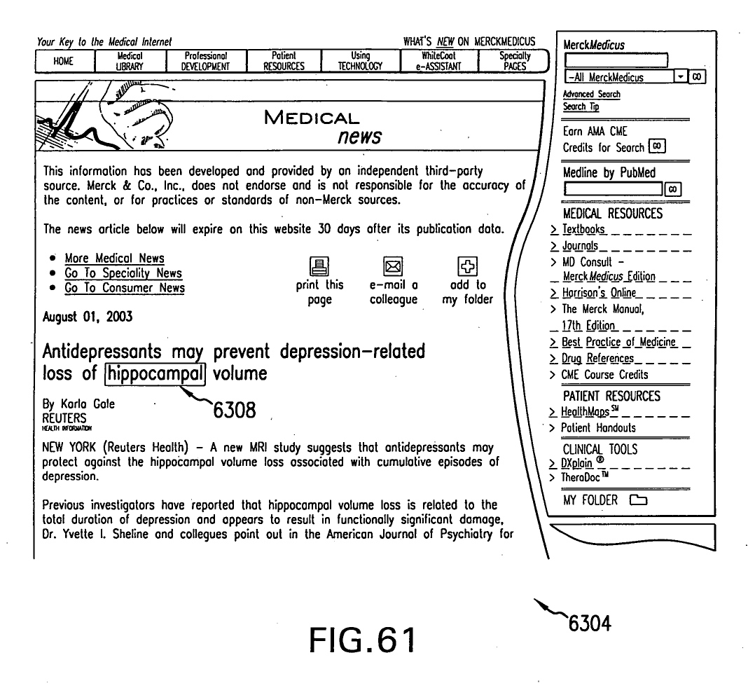

Reference is now made to FIG. 61 illustrating an example of a user interface 6304 implementable for accepting the search query event of the present invention. In this example, a news page is displayed in interface 6304. As depicted, the page contents include, for example, the text of the news story. In accordance with the concepts of the present invention, the page may also include any number of search-enabled terms. For instance, with a medical or healthcare website, each of the medical terms on each of the pages of the site may be search-enabled.

In accordance with the concepts of the present invention, any search-enabled items displayed in interface 6304 may be identified, for example, by highlighting with a cursor, and selected. This action causes a search to be executed for data records relevant to the identified item. In the example depicted in FIG. 61, the item “hippocampal” is identified in the search query event. For example, in this embodiment, “hippocampal” is highlighted with a cursor followed by double clicking a mouse button. In this manner, a search may be conducted for data records relevant to “hippocampal,” directly from the web page it is displayed on and without having to open or transfer to another search page or web page.

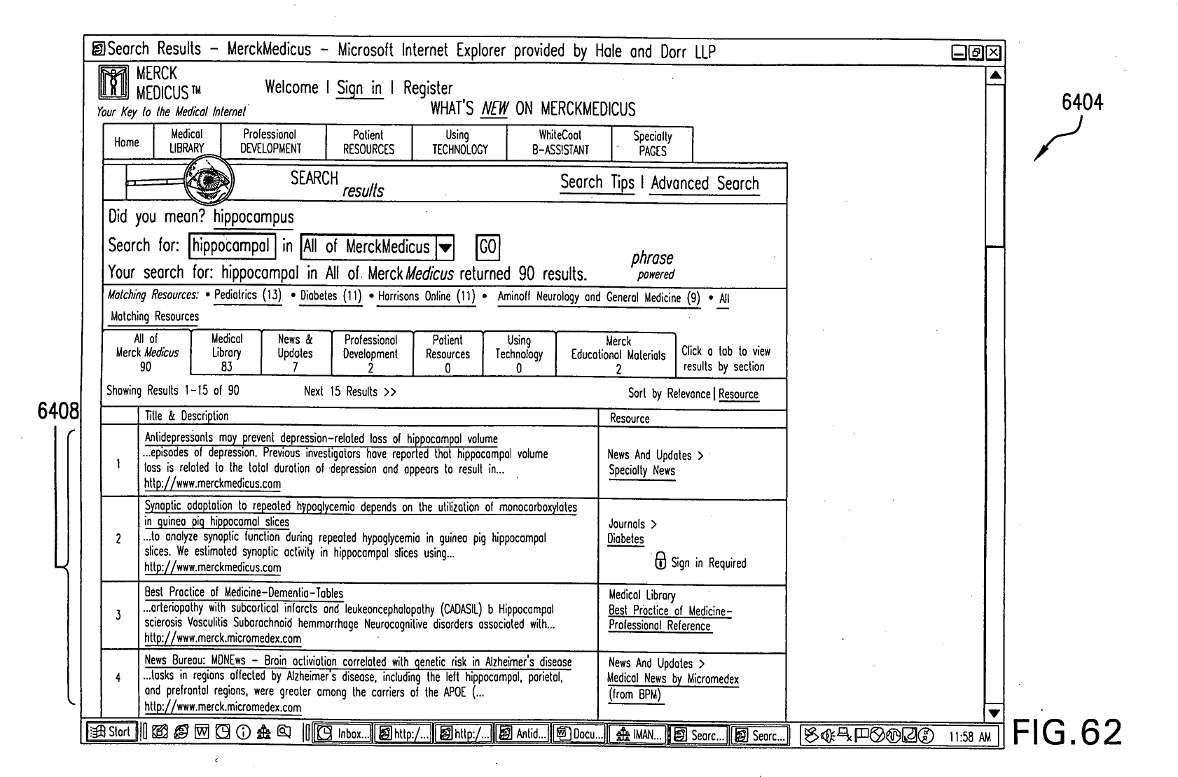

Referring now to FIG. 62, one example of a user interface 6404 implementable for displaying search results to a search query is depicted. As discussed above, links to the data records relevant to a search query event may be displayed in relevance order in, e.g., a pop-up window. In this embodiment, the results of the search conducted in the example of FIG. 61 are displayed. Specifically, hyperlinks 6408 to a number of data records relevant to “hippocampal” are displayed.

Thus all documents in a site may include the search feature of the present invention embedded therein.
If a user double clicks on any word within the document that is search enabled, a search on the entire site may appear on a separate browser window with that word as the search term.
The search results may appear as it would if a regular search on that search is conducted.
Each double-click may be considered a new search and a new browser window will appear.
Cascading multiple windows are possible.
The result window should be scrollable for the user to view all the results.
When no results are found, the window will display “No Results Found” as in a regular search.
If the text selected is too long, the status bar may state that the selected search is too long and there will be no search window.

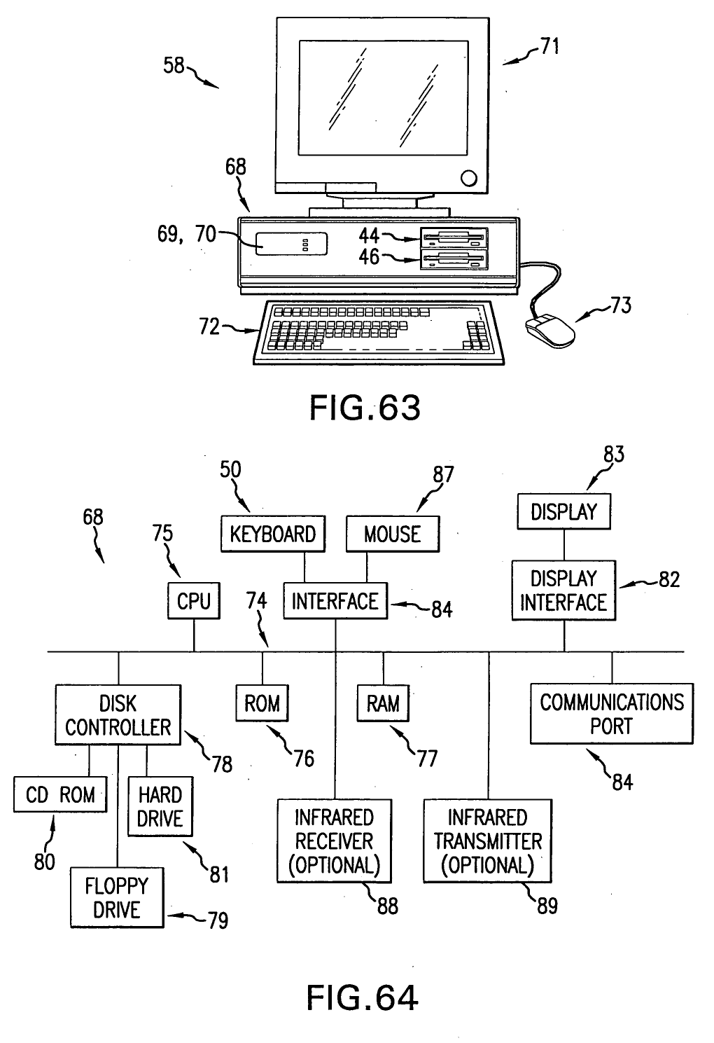

FIG. 63 is an illustration of a computer 58 used for implementing the computer processing in accordance with a computer-implemented embodiment of the present invention. The procedures described above may be presented in terms of program procedures executed on, for example, a computer or network of computers.

Viewed externally in FIG. 63, computer 58 has a central processing unit (CPU) 68 having disk drives 69, 70. Disk drives 69, 70 are merely symbolic of a number of disk drives that might be accommodated by computer 58. Typically, these might be one or more of the following: a floppy disk drive 69, a hard disk drive (not shown), and a CD ROM or digital video disk, as indicated by the slot at 70. The number and type of drives varies, typically with different computer configurations. Disk drives 69, 70 are, in fact, options, and for space considerations, may be omitted from the computer system used in conjunction with the processes described herein.

Computer 58 also has a display 71 upon which information may be displayed. The display is optional for the computer used in conjunction with the system described herein. A keyboard 72 and/or a pointing device 73, such as a mouse 73, may be provided as input devices to interface with central processing unit 68. To increase input efficiency, keyboard 72 may be supplemented or replaced with a scanner, card reader, or other data input device. The pointing device 73 may be a mouse, touch pad control device, track ball device, or any other type of pointing device.

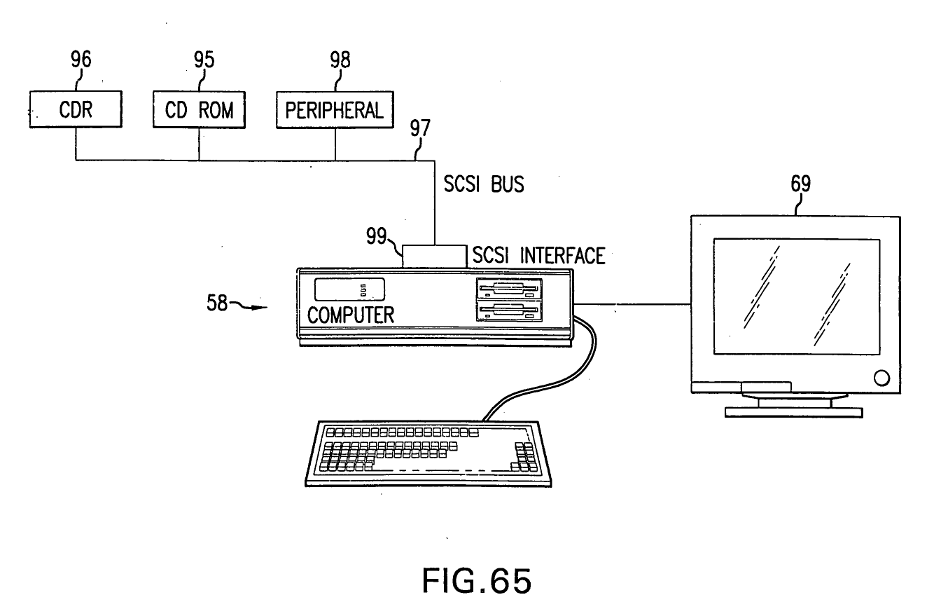

Alternatively, referring to FIG. 65, computer 58 may also include a CD ROM reader 95 and CD recorder 96, which are interconnected by a bus 97 along with other peripheral devices 98 supported by the bus structure and protocol. Bus 97 serves as the main information highway interconnecting other components of the computer. It is connected via an interface 99 to the computer 58.

FIG. 64 illustrates a block diagram of the internal hardware of the computer of FIG. 63. CPU 75 is the central processing unit of the system, performing calculations and logic operations required to execute a program. Read only memory (ROM) 76 and random access memory (RAM) 77 constitute the main memory of the computer. Disk controller 78 interfaces one or more disk drives to the system bus 74. These disk drives may be floppy disk drives such as 79, or CD ROM or DVD (digital video/versatile disk) drives, as at 80, or internal or external hard drives 81. As previously indicated these various disk drives and disk controllers are optional devices.

A display interface 82 permits information from bus 74 to be displayed on the display 83. Again, as indicated, the display 83 is an optional accessory for a central or remote computer in the communication network, as are infrared receiver 88 and transmitter 89. Communication with external devices occurs using communications port 84.

In addition to the standard components of the computer, the computer may also include an interface 85, which allows for data input through the keyboard 86 or pointing device, such as a mouse 87.

The foregoing detailed description includes many specific details. The inclusion of such detail is for the purpose of illustration only and should not be understood to limit the invention. In addition, features in one embodiment may be combined with features in other embodiments of the invention. Various changes may be made without departing from the scope of the invention as defined in the following claims.

As one example, the medical information portal system may include a general purpose computer, or a specially programmed special purpose computer. The user may interact with the medical information portal system via e.g., a personal computer or over PDA, e.g., the Internet an Intranet, etc. Either of these may be implemented as a distributed computer system rather than a single computer. Similarly, the communications link may be a dedicated link, a modem over a POTS line, and/or any other method of communicating between computers and/or users. Moreover, the processing could be controlled by a software program on one or more computer systems or processors, or could even be partially or wholly implemented in hardware.

The user interfaces may be developed in connection with an HTML display format. Although HTML is utilized in the illustrated examples, it is possible to utilize alternative technology for displaying information, obtaining user instructions and for providing user interfaces. The invention has been discussed in connection with particular examples. However, the principles apply equally to other examples and/or realizations. Naturally, the relevant data may differ, as appropriate.

Further, this invention has been discussed in certain examples as if it is made available to a single user. The invention may be used by numerous users, if preferred. The medical information portal system used in connection with the invention may rely on the integration of various components including, as appropriate and/or if desired, hardware and software servers, database engines, and/or CE content providers. The configuration may be, preferably, network-based and uses the Internet as a primary interface with the user.

The medical information portal system may store collected information and/or indexes to information in a database. An appropriate database may be on a standard server, for example, a small Sun™ Sparc™ or other remote location. The information may, for example, optionally be stored on a platform that may, for example, be UNIX-based. The various databases maybe in, for example, a UNIX format, but other standard data formats may be used.

Although the computer system in FIG. 3 is illustrated as having a single computer, the medical information portal system is optionally suitably equipped with a multitude or combination of processors or storage devices. For example, the computer may be replaced by, or combined with, any suitable processing system operative in accordance with the principles of embodiments of the present invention, including sophisticated calculators, hand held, laptop/notebook, mini, mainframe and super computers, as well as processing system network combinations of the same. Further, portions of the system may be provided in any appropriate electronic format, including, for example, provided over a communication line as electronic signals, provided on floppy disk, provided on CD Rom, provided on optical disk memory, etc.

Any presently available or future developed computer software language and/or hardware components can be employed in such embodiments of the present invention. For example, at least some of the functionality mentioned above could be implemented using Visual Basic, C, C++ or any assembly language appropriate in view of the processor being used. It could also be written in an interpretive environment such as Java and transported to multiple destinations to various users.

The many features and advantages of the embodiments of the present invention are apparent from the detail specification, and thus, it is intended by the appended claims to cover all such features and advantages of the invention that fall within the true spirit and scope of the invention. Further, since numerous modifications and variations were readily occurred to those skilled in the art, it is not desired to limit the invention to the exact construction and operation illustrated and described, and accordingly, all suitable modifications and equivalents maybe resorted to, falling within the scope of the invention.

1. A computer-based method of conducting a search, comprising the steps of:
displaying in an interface a page comprising contents which may include one or more searchable items;
monitoring for a search query event which identifies at least one item from said page and initiates said search for said at least one item;
searching, in response to said search query event, a collection of data records for data records relevant to said search query; and
displaying a link to each of said data records that are relevant to said search query.

2. The computer-based method of claim 1, wherein said search query event comprises activating a button.

3. The computer-based method of claim 1, wherein said search query event comprises double-clicking a mouse button.

4. The computer-based method of claim 1, wherein said at least one item comprises a term or a phrase and said search query event comprises double-clicking a mouse button when a cursor is positioned over said term or phrase.

5. The computer-based method of claim 1, wherein said interface comprises a browser.

6. The computer-based method of claim 1, wherein said page and said data records comprise mark-up language documents.

7. The computer-based method of claim 1, wherein only predetermined search-enabled items listed in said page may be subject to a search.

8. A computer-based system for conducting a search, comprising:
an interface for displaying a page comprising contents which may include one or more searchable items;
an input unit for monitoring for a search query event which identifies at least one item from said page and initiates said search for said at least one item; and
a searching module for searching, in response to said search query event, a collection of data records for data records relevant to said search query, wherein said interface displays a link to each of said data records that are relevant to said search query after said searching module has completed said search.

9. The computer-based system of claim 8, wherein said search query event comprises activating a button.

10. The computer-based system of claim 8, wherein said search query event comprises double-clicking a mouse button.

11. The computer-based system of claim 8, wherein said at least one item comprises a term or a phrase and said search query event comprises double-clicking a mouse button when a cursor is positioned over said term or phrase.

12. The computer-based system of claim 8, wherein said interface comprises a browser.

13. The computer-based system of claim 8, wherein said page and said data records comprise mark-up language documents.

14. The computer-based system of claim 8, wherein only predetermined search-enabled items listed in said page may be subject to a search.

15. A system for conducting a search, comprising:
means for displaying in an interface a page comprising contents which may include one or more searchable items;
means for monitoring for a search query event which identifies at least one item from said page and initiates said search for said at least one item;
means for searching, in response to said search query event, a collection of data records for data records relevant to said search query; and
means for displaying a link to each of said data records that are relevant to said search query.

16. The system of claim 15, wherein said search query event comprises activating a button.

17. The system of claim 15, wherein said search query event comprises double-clicking a mouse button.

18. The system of claim 15, wherein said at least one item comprises a term or a phrase and said search query event comprises double-clicking a mouse button when a cursor is positioned over said term or phrase.

19. The system of claim 15, wherein said interface comprises a browser.

20. The system of claim 15, wherein said page and said data records comprise mark-up language documents.

21. The system of claim 15, wherein only predetermined search-enabled items listed in said page may be subject to a search.

22. In a computer-based system for providing healthcare resources such as information and services, to users, a medical information portal searching system for users including physicians and healthcare providers, implemented by a computer system, said medical information portal searching system comprising:
a diagnostic tool, managing at least one of disease diagnosis and research resources, including at least one of: a disease research assistance resource, a disease diagnosis assistance resource, treatment guidelines, medical references, and a plurality of disease modules each having disease information regarding a disease;
a learning tool, managing professional development resources, including at least one of: online continuing medical education (CME) resources, links to connect the users to professional societies, links to connect users to medical school computer sites, downloadable lecture materials and slide kits, review information concerning preparing for board review, a calendar of medical meetings, and a meeting reporter;
a patient tool, managing patient resources, including media information on what patients are seeing in the media, a plurality of patient handouts having information for patients, a plurality of links to connect the users to patient support groups, clinical trial information, and at least one health guide; and
a search module for searching for at least one item located in at least one of said disease diagnosis resources, research resources, professional development resources, and patient resources, in response to a search query event which identifies said at least one item to be searched and which initiates the search.

23. The medical information portal searching system of claim 22, wherein said search query event comprises activating a button.

24. The medical information portal searching system of claim 22, wherein said search query event comprises double-clicking a mouse button.

25. The medical information portal searching system of claim 22, wherein said at least one item comprises a term or a phrase and said search query event comprises double-clicking a mouse button when a cursor is positioned over said term or phrase.

26. A computer-based method for providing healthcare resources such as information and services, to users, in a medical information portal searching method for users including physicians and healthcare providers, implemented by a computer system, said medical information portal searching method comprising the steps of:
(A) managing, in a diagnostic tool, at least one or disease diagnosis and research resources, including at least one of: a disease research assistance resource, a disease diagnosis assistance resource, treatment guidelines, medical references, and a plurality of disease modules each having disease information regarding a disease;
(B) managing, in a learning tool, professional development resources, including at least one of: online continuing medical education (CME) resources, links to connect the users to professional societies, links to connect users to medical school computer sites, downloadable lecture materials and slide kits, review information concerning preparing for board review, a calendar of medical meetings, and a meeting reporter;
(C) managing, in a patient tool, patient resources, including media information on what patients are seeing in the media, a plurality of patient handouts having information for patients, a plurality of links to connect the users to patient support groups, clinical trial information, and at least one health guide; and
(D) searching for at least one item located in at least one of said disease diagnosis resources, research resources, professional development resources, and patient resources, in response to a search query event which identifies said at least one item to be searched and which initiates the search.

27. The medical information portal searching method of claim 26, wherein said search query event comprises activating a button.

28. The medical information portal searching method of claim 26, wherein said search query event comprises double-clicking a mouse button.

29. The medical information portal searching method of claim 26, wherein said at least one item comprises a term or a phrase and said search query event comprises double-clicking a mouse button when a cursor is positioned over said term or phrase.

30. In a computer-based system for providing healthcare resources such as information and services, to users, a medical information portal searching system for users including physicians and healthcare providers, implemented by a computer system, said medical information portal system comprising:
(A) a diagnostic tool means for managing at least one or disease diagnosis and research resources, including at least one of: a disease research assistance resource, a disease diagnosis assistance resource, treatment guidelines, medical references, and a plurality of disease modules each having disease information regarding a disease;
(B) a learning tool means for managing professional development resources, including at least one of: means for online continuing medical education (CME) resources, means for connecting the users to professional societies, means for connecting users to medical school computer sites, downloadable lecture materials and slide kits, review information concerning preparing for board review, a calendar means for medical meetings, and a meeting reporter means;
(C) a patient tool means for managing patient resources, including media information on what patients are seeing in the media, a plurality of patient handouts having information for patients, means for connecting the users to patient support groups, clinical trial information, and at least one health guide; and
(D) a searching module for searching for at least one item located in at least one of said disease diagnosis resources, research resources, professional development resources, and patient resources, in response to a search query event which identifies said at least one item to be searched and which initiates the search.

31. The medical information portal searching system of claim 30, wherein said search query event comprises activating a button.

32. The medical information portal searching system of claim 30, wherein said search query event comprises double-clicking a mouse button.

33. The medical information portal searching system of claim 30, wherein said at least one item comprises a term or a phrase and said search query event comprises double-clicking a mouse button when a cursor is positioned over said term or phrase.
